(19) United States
(12) Patent Application Publication
(10) Pub. No.: US 2023/0164089 A1
(43) Pub. Date: May 25, 2023

(54) SYSTEM AND METHOD OF PROVIDING ACCESS TO COMPUTE RESOURCES DISTRIBUTED ACROSS A GROUP OF SATELLITES

(71) Applicant: Space Exploration Technologies Corp., Hawthorne, CA (US)

(72) Inventors: Jared Michael Greene, Seattle, WA (US); Mohammed Faraz Admani, Redmond, WA (US); Jacob Nelson Glueck, Redmond, WA (US); Sergii Ziuzin, Redmond, WA (US); Francesco De Paolis, Palo Alto, CA (US); Dhruv Dawar, Aliso Viejo, CA (US); Christopher Yu, Redmond, WA (US)

(21) Appl. No.: 17/955,401

(22) Filed: Sep. 28, 2022

Related U.S. Application Data
(60) Provisional application No. 63/251,001, filed on Sep. 30, 2021.

(51) Int. Cl. H04L 47/70; G06F 9/48; H04B 7/185

(52) U.S. Cl. CPC H04L 47/70; G06F 9/4881; H04B 7/18521; H04B 7/18513

(57) ABSTRACT

A satellite includes a satellite control system, an antenna connected to the satellite control system, a memory device, a computing environment configured on the satellite. The satellite can be part of a cluster of satellites that are dynamically organized from a larger group of satellites based on one or more of scheduled workload, a movement of the larger group of satellites, thermal issues, reset or reboot issues, energy issues and capabilities of individual satellites to provide access to compute resources on the cluster of satellites such as cloud-services or data. Requests for compute resources can be routed to the proper satellite in the dynamically-changing cluster of satellites to provide data associated with the compute resources or access to functions associated with the compute resources such as stock, bond, or cryptocurrency trading functions. The cluster of satellites can be periodically updated to provide continued service or availability of the compute resources.

### CROSS-REFERENCE TO RELATED APPLICATION

The present application claims priority to U.S. Provisional Patent Application No. 63/251,001, filed Sep. 30, 2021, entitled “SYSTEM AND METHOD OF PROVIDING ACCESS TO COMPUTE RESOURCES DISTRIBUTED ACROSS A GROUPS OF SATELLITES,” the contents of which is hereby expressly incorporated by reference in its entirety.

### TECHNICAL FIELD

The disclosed technology pertains to providing cloud-services or other applications via one or more satellites to user terminals and more specifically to the various technologies related to managing, via one or more satellites, the access to compute resources such as data, bandwidth, storage, endpoint-to-endpoint communication channels, various types of cloud-services such as applications and/or computer processing power. The disclosure addresses providing access to compute resources via the one or more satellites given the movement of the satellites according to their respective orbits and the unique requirements of the orbiting environment which are not applicable to earth-based computer systems.

### BACKGROUND

Satellite communication systems can provide Internet access to user terminals at user terminal locations, for example at homes or businesses. User terminals may also be used for cellular backhaul where a user terminal is configured on a cell tower and serves a certain area. The satellite in this context can receive from a user terminal a request for data, access to the Internet or cloud-computing services, or access to computer processors, a cloud-based service or application. For example, the user may request a video to watch via a streaming video service or desire to access a trading platform for making a stock or bond trade. The user will typically be at a user device which can be a computing device such as a computer or a mobile device. The user device gains access to the Internet via the user terminal and its wireless connection to the satellite. The satellite in turn will transmit signals to a ground station (called a gateway or terrestrial gateway) on Earth with the request to obtain the data or provide access to the ground-based computer systems that provide the service or application. The ground station is connected to the Internet or another ground-based network that stores the requested data or the software that provides the service or application. The satellite and the ground station transmit and receive signals via a respective satellite antenna and a ground station antenna.

The gateway will access the Internet or other network to obtain the desired data and to upload the data up to the satellite. The satellite then transmits the data down to the user terminal such that the user can utilize the data on a user device. In the case of cloud-services or applications, the ground-based computer systems will perform their programmed functions to provide the service or application and return the output data via the gateway and satellite system to the user terminal.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In general, this disclosure relates to providing access to cloud-services to user terminals in the context of the cloud-services being available to access from one or more satellites. Operating a group of satellites that can provide cloud-services involves a number of different issues that are not contemplated from terrestrial cloud computing environments. In one aspect, the computing environment configured on one or more satellites can be characterized as an edge node.

The computer systems making up various cloud computing environments such as Amazon Web Services or Microsoft Azure do not move and are not subject to a changing environment such as being in the sun for part of the time and in the Earth's shadow for part of the time. Being in the sun heats up the satellite which can impact performance. This disclosure generally relates to new approaches regarding how to manage access to requested compute resources (such as, for example, data, applications, computer processor time, storage, endpoint-to-endpoint low latency communication channels, and so forth) from a dynamically changing group of satellites in which different entities, which typically differ from the satellite operating entity, will have configured on one or more satellites compute environments that offer different compute resources. Parameters such as one or more of an energy status of individual satellites, thermal conditions, a resetting or rebooting of the satellite due to radiation events or software issues, a state of individual satellites, a distance between respective satellites and a user terminal or a distance between respective satellites and other satellites, user permissions, compute resource entity data, can be applicable to determine how to route a request for compute resources to which hardware on which satellite(s). Furthermore, satellites can be clustered dynamically to enable a proper response to a request for compute resources. These various aspects of the underlying issue are developed in this application in different examples.

As used herein, the term compute resources generally means any resource made available through a satellite or a terrestrial computer system. Such compute resources can include computer processors (hardware or virtual processors), storage for data in any type of computer-readable storage medium (RAM, hard-disk and so forth), software applications, platforms, virtual private clusters of a combination of compute resources, bandwidth, endpoint-to-endpoint services, or any combination of these resources.

In accordance with one example of the present disclosure, a general method includes how to receive and respond to requests for compute resources. The method includes receiving, at a satellite control system on a satellite, a request from a user terminal for compute resources, requesting, from a computing environment configured on the satellite, access to the compute resources, receiving, from the computing environment configured on the satellite, access to the compute resources and transmitting data associated with the use of the compute resources to the user terminal.

The compute resources can be data such as a media presentation or can relate to any type of application or platform operating on the satellite or a group of satellites. For example, the data can relate to output from use of compute resources made available on one or more satellites, or the data can be output from a stock-trading platform or a media platform that provides downloaded video or audio to a user device utilizing the user terminal for access to the one or more satellites. The approach disclosed herein provides low-latency content delivery to a user terminal because rather than serve the content from the ground, through a series of satellites, and then to the user, the content is served directly from one or more satellite. The approach can also provide low latency using a constellation of satellites for data transmission via laser connections to provide, for example, an endpoint-to-endpoint communication channel. The path of data transmission over the constellation of satellites can be an improvement over standard Internet packet flow. For example, one reason for long latency via point-to-point via terrestrial cables (undersea and overland routes) is geography and the existing routes. There is no direct undersea route from South Africa to Sydney. For this and other reasons, an endpoint-to-endpoint communication channel through one or more satellites between two ground stations (user terminals or gateways) can provide a lower latency communication path.

In any of the examples or methods described herein, the computing environment configured on the satellite may include a memory device that stores the data or stores instructions which, when executed by a processor, enables use of the compute resources on the satellite or group of satellites.

In any of the examples or methods described herein, the computing environment configured on the satellite can provide compute resources to the user terminal (and ultimately the user computing device) or a gateway and may further include one or more of hardware available on demand, an application or platform, any cloud-service, data storage and access generally, an access/control module, endpoint-to-endpoint communication channel services and/or a user interface module if a particular user interface is useful in accessing the computing environment. In one example, the access/control module can include the instructions and operations to access or control the data or compute resources of interest. The access/control module can be tailored to enable the access and control of different types of applications such access to compute resources in a similar manner to cloud computing, high performance computing resources, data such as media, certain functionality from a platform, or any other type of application or platform that can be configured on the satellite or the group of satellites. The access/control module can also cover encryption and/or transport layer security aspects for particular applications where security is desired, such as file transfers, video and audio conferencing, email, texting or other applications where security is desired.

An intelligence layer can determine how to load balance or manage the distribution or steering of requests for compute resources and can exist on one or more satellites, at a ground-based service or a service at a terrestrial location, or in a hybrid configuration in which some processing occurs on one or more satellites and other processing occurs on a ground-based service. Depending on the application, a combination of modules and/or data can apply to delivering the capabilities of the respective application.

In any of the examples or methods described herein, when the computing environment configured on the satellite does not have the requested data or the requested compute resources on the satellite, the computing environment and/or access/control module may request the data or the compute resources from one of another computing environment configured on the satellite, a terrestrial computing network, or another satellite via a communication link such as a laser communication link.

In any of the examples or methods described herein, a method may further include identifying the computing environment configured on the satellite as either having the compute resources or being associated with an account of a user. The user may or may not be associated with any particular user terminal as the account data to access the computing environment may be independent of any particular user terminal or gateway.

In any of the examples or methods described herein, receiving, from the computing environment configured on the satellite, the data of the application functionality may further include the computing environment authorizing access to the data or application for a user and/or transmitting a user interface associated with the computing environment to the user terminal. The computing environment may authenticate the user and transmit a user-specific interface to its computing/data resources. In some cases, the special user interface may provide specific graphical objects or capabilities to enable the user to access a particular application. In other cases, the user interface may not be altered or needed from a traditional user interface in that the location of the data or the application on the satellite or group of satellites will be transparent to the user.

Another example relates to taking the physical condition of satellites into account when routing requests for compute resources or for clustering satellites to provide access to compute resources. A method in this regard includes receiving, at a satellite as part of a group of satellites, data associated with the group of satellites, wherein the data includes one or more of an energy balance associated with the group of satellites, transient hardware temperatures associated with the group of satellites, a reboot or reset event associated with the group of satellites, scheduled workload on one or more satellites and orbital data associated with the group of satellites and, based on the data, configuring an availability of compute resources across the group of satellites to yield dynamically available compute resources.

The compute resources mean any resource available such as bandwidth, endpoint-to-endpoint communication channels, memory, computer processors, and storage as well. The method includes receiving a request from a user terminal for compute resources to yield requested compute resources and providing, from the group of satellites and to the user terminal, access to the dynamically available compute resources based on the requested compute resources. In one example, satellites can be rebooted or reset due to radiation exposure or for some other reason in which the electronic components stop behaving in their expected manner. A reboot may also be initiated due to corrupted software or some other factor. The logic of the satellite will cause a reboot to correct for the condition and the delivery of compute resources might be paused in that case or transferred with state information to another satellite to accommodate for the reset or reboot event(s).

In one aspect, there are probabilities of whether a radiation event might happen to a given satellite which can depend on characteristics of different satellites such as their age, design, radiation protection infrastructure, and exposure to the sun. In another aspect, there are backup satellites for serving a user terminal if a radiation event occurs and a reboot or reset is initiated. The workload can be balanced and transferred to one or more designated backup satellites in a dynamic manner based on such an event. The topology schedule and/or workload schedule can be used to establish backup satellites as part of a clustering of satellites or in general.

Thus, the management of access to compute resources can be performed based on a hybrid of predictive or future looking conditions such as the transient hardware temperature which is known in advance and dynamic events like a reboot due to a radiation event or software error.

In another aspect, the satellites are constantly moving in their respective orbits. The intelligence layer can take into account the movement of the satellites when making routing or steering decisions. A method in this regard can include receiving, at a satellite as part of a group of satellites, data associated with the group of satellites, wherein the data is associated with movement of the group of satellites according to a respective orbit of each satellite of the group of satellites and, based on the data, clustering two or more satellites of the group of satellites that can provide cloud-computing operations to user terminals to yield a cluster of satellites. The method can include receiving, at a satellite associated with the cluster of satellites, a request from a user terminal or gateway for compute resource to yield a requested compute resource and providing, from the cluster of satellites and for the user terminal or gateway, access to the compute resources based on the requested compute resources. The clustering can occur before or after the request for compute resources.

In another aspect, a method includes receiving, in connection with a group of satellites, data associated with the group of satellites, wherein the data is associated with movement of the group of satellites according to a respective orbit of each satellite of the group of satellites and, based on the data, linking two or more satellites of the group of satellites into a constellation of satellites that can provide cloud-computing operations to user terminals or gateways. The method can further include receiving, at a satellite associated with the constellation of satellites, a request from a user terminal or gateway for compute resource to yield a requested compute resource, based on the request and the constellation of satellites, routing the request to one or more satellites of the constellation of satellites to provide the compute resources to the user terminal or gateway and providing, from the one or more satellites of the constellation of satellites and to the user terminal or gateway, access to the compute resources.

Examples can include one or more satellites as well as ground-based operational systems. In one aspect, a satellite includes a satellite control system, an antenna connected to the satellite control system, a solar panel, a battery and a power converter configured between the solar panel and the battery to manage a flow of electricity. The satellite control system in this scenario includes the logic or intelligence to manage request for compute resources and to route those requests to the computing environment (edge node) on one or more satellites to enable access to the requested compute resources. The satellite further includes a memory device, a computing environment configured on the satellite and a plurality of compute resources as part of the computing environment. When a user terminal requests a compute resource via the satellite control system to yield requested compute resource, the computing environment retrieves, if available, the requested compute resource from the plurality of compute resources stored in the memory device and provides data associated with the requested compute resource to the satellite control system for transmission via the antenna to the user terminal or makes the requested compute resource available to the user terminal. In some respects, the computing environment operated on the satellite is from a different company or different entity from the satellite company.

A method of managing access to compute resources in this regard can include receiving, at a satellite control system on a satellite, a request from a user terminal for compute resources and requesting, from an entity computing environment configured on the satellite, the compute resources. In a multi-tenant environment, there may be different entities offering different computing environments on a group of satellites. The method can include receiving, from the entity computing environment configured on the satellite, data associated with the compute resources and transmitting the data associated with the compute resources to the user terminal.

In any of the examples or methods described herein, the computing environment configured on the satellite may include one of a virtual computing environment and a hardware computing environment.

In any of the examples or methods described herein, the computing environment configured on the satellite may be one of a plurality of computing environments configured on the satellite. In other words, the satellite(s) can provide a multi-tenant environment with different compute resources being managed and made available by different companies.

In any of the examples or methods described herein, the computing environment configured on the satellite may further include an entity computing environment and the data may include audio or video or any other type of data which can include an output of an application process, an artificial intelligence or machine learning model, or any other application or platform.

In any of the examples or methods described herein, the computing environment may further include a user interface module for providing to the satellite control system a user interface for transmission to the user terminal. In some cases, the access to data or applications on the satellite or group of satellites can require a specialized user interface which can be transmitted to the user terminal for display on a user device that presents the user interface for interaction by the user.

In any of the examples or methods described herein, a satellite may further include a plurality of computing environments configured on the satellite, each respective computing environment of the plurality of computing environments being separate from the satellite control system and other computing environments. In another aspect, the system may include control systems as well as computing environments on a same board.

In any of the examples or methods described herein, when the user terminal requests via the satellite control system the requested data, the satellite control system may determine that the computing environment is a chosen computing environment from a plurality of computing environments configured on the satellite.

In any of the examples or methods described herein, a user account associated with the computing environment may be used to determine that the computing environment is the chosen computing environment from the plurality of computing environments configured on the satellite. In this context, the satellite or group of satellites can be a multi-tenant environment in which individual users can gain access to data or applications made available via the satellite or group of satellites. Access control can also be coordinated with a ground-based system operating by a respective entity that controls access to the compute resources according to a user profile or account of a registered user for access.

In any of the examples or methods described herein, when the requested data is not available on the memory device, then the computing environment may obtain the requested data from one of another computing environment on the satellite, a terrestrial source via a gateway, or any computer system on Earth such as a datacenter or cloud-computing environment, a company on-premises computing environment, a Point of Presence (POP) computer system for defining different communicating entities, or another satellite. Any computing system in one or more satellites or as a terrestrial source of compute resources can apply here.

In any of the examples or methods described herein, the satellite may further include a battery, a solar panel connected to the battery, and a management module that manages power usage amongst components.

In any of the examples or methods described herein, a satellite may further include a workload management module that manages one or more of power usage amongst components and scheduling of workload across the plurality of computing environments. The workload management module can provide for load balancing across the group of satellites and can be configured on one or more satellites and/or can be configured on a ground computing device for managing the load balancing across the group of satellites. Data from the workload management module can also be used to cluster satellites together in connection with a topology schedule to provide access to compute resources.

In any of the examples or methods described herein, the computing environment may be configured in one of a virtual machine, a container or on dedicated hardware on the satellite.

In any of the examples or methods described herein, the computing environment may include an entity computing environment and wherein the requested data can include video or audio.

In accordance with another embodiment of the present disclosure, a method is provided.

The method can include receiving, at a satellite control system on a satellite, a request from a user terminal for compute resources, requesting, from an entity computing environment configured on the satellite, the compute resources, clustering, based on the request, two or more satellites based on one or more of a thermal condition, a reboot or reset event, movement of a group of satellites including the satellite, a proximity of one or more satellites to the user terminal, or a schedule of future positions of the group of satellites to yield a cluster of satellites, receiving, from the computing environment configured on one or more of the cluster of satellites, data associated with the compute resources or access to the compute resources and transmitting the data associated with the compute resources to the user terminal.

In any of the examples or methods described herein, the data associated with the compute resources may include one or more of a media presentation, a file, and data generated from running workload using the compute resources.

In any of the examples or methods described herein, the compute resources may include a service, an endpoint-to-endpoint communication channel, or an application offered in response to the request.

In any of the examples or methods described herein, the service or the application may be operable on the satellite and/or a secondary satellite in communication with the satellite.

In each case described herein where communication with a satellite is described as being via a user terminal, other ground stations are also contemplated. Thus, the communication could occur from a gateway as well or other communication device that is not a user terminal or a gateway.

### BRIEF DESCRIPTION OF THE DRAWINGS

In order to describe the manner in which the above-recited issues can be addressed, a more particular description of the principles briefly described above will be rendered by reference to specific examples thereof that are illustrated in the appended drawings. Understanding that these drawings depict only exemplary examples of the disclosure and are not therefore to be considered to be limiting of its scope, the principles herein are described and explained with additional specificity and detail through the use of the accompanying drawings in which:

FIG. 1A illustrates a simplified schematic of an exemplary satellite communication system in accordance with examples of the present disclosure;

FIG. 1B illustrates a simplified block diagram of a satellite communication system of FIG. 1A in accordance with examples of the present disclosure;

FIG. 2 is a schematic showing planar orbital patterns of a group of satellites, which may be used in the satellite communication system of FIG. 1A, around a rotating Earth in accordance with examples of the present disclosure;

FIG. 3 illustrates a not-to-scale aerial view of an exemplary ground area that may be serviced by the satellite communication system of FIG. 1A, including user terminals grouped into service cells, and gateway terminals;

FIG. 4 illustrates a not-to-scale aerial view of the ground area shown in FIG. 3 being serviced by certain exemplary satellites of the group in communication with the user terminals and the gateway terminals;

FIG. 5 illustrates a not-to-scale schematic view of an example of a satellite communication system in accordance with examples of the present disclosure;

FIG. 6 illustrates an example satellite communication system having different computing environments for different cloud computing application providers in accordance with examples of the present disclosure;

FIG. 7A illustrates an example method in accordance with examples of the present disclosure;

FIG. 7B illustrates an example method focusing on load balancing in accordance with examples of the present disclosure;

FIG. 7C illustrates an example method focusing on dynamic or static clustering of satellites in accordance with examples of the present disclosure;

FIG. 7D illustrates an example method focusing on constellation-specific steering and routing strategies in accordance with examples of the present disclosure;

7E illustrates an example method of using entity compute resource data as well as other satellite data to determine routing strategies in accordance with examples of the present disclosure;

FIG. 7F illustrates another method that relates to the interaction between a load balancing service and compute resource entity according to some examples of the present disclosure;

FIG. 8A illustrates another example method in accordance with examples of the present disclosure;

FIG. 8B illustrates another example method in accordance with examples of the present disclosure;

FIG. 8C illustrates another example method in accordance with examples of the present disclosure;

FIG. 9 illustrates a group of satellites and a distribute set of compute resources across the group of satellites;

FIG. 10 illustrates a method embodiment related to machine-learning or artificial intelligence models;

FIG. 11 illustrates another method embodiment related to distributing compute resources across a group of satellites;

FIG. 12 illustrates a set of satellites that can make up a laser mesh or virtual large compute resource center;

FIGS. 13-19 illustrate various method examples;

FIG. 20 illustrates a set of satellites being clustered based on a scheduled workload;

FIG. 21 illustrates a method of clustering satellites based at least in part on a scheduled workload;

FIG. 22 illustrates a method of clustering satellites based at least in part on a scheduled workload and over a period of time;

FIG. 23 illustrates a method of providing access to a cluster of satellites based on requests for workload in a queue;

FIG. 24 illustrates a method of clustering satellites based at least in part on a scheduled workload and provisioning a compute environment on the cluster of satellites;

FIG. 25 illustrates a method of clustering satellites based at least in part on a prediction of request for workload and based in part on scheduled workload;

FIG. 26 illustrates a method of providing compute resources from one of a cluster of satellites of a ground computing network based in part on scheduled workload; and

FIG. 27 illustrates a computer system that can be implemented with other aspects of the present disclosure.

### DESCRIPTION OF EXAMPLES

Various examples of systems and method of the disclosure are discussed in detail below. While specific implementations are discussed, it should be understood that this description is for illustration purposes only. A person skilled in the relevant art will recognize that other components and configurations may be used without parting from the spirit and scope of the disclosure. Thus, the following description and drawings are illustrative and are not to be construed as limiting.

Numerous specific details are described to provide a thorough understanding of the disclosure. However, in certain instances, well-known or conventional details are not described in order to avoid obscuring the description. References to one or an embodiment in the present disclosure can be references to the same embodiment or any embodiment; and, such references mean at least one of the example embodiments.

Reference to “one embodiment” or “an embodiment” means that a particular feature, structure, or characteristic described in connection with the embodiment is included in at least one embodiment of the disclosure. However, any example or embodiment is not meant to be independent or exclusive of features disclosed elsewhere in the application. The appearances of the phrase “in one embodiment” in various places in the specification are not necessarily all referring to the same embodiment, nor are separate or alternative example embodiments mutually exclusive of other example embodiments. Moreover, various features are described which may be exhibited by some example embodiments and not by others. Any feature of one example or embodiment can be integrated with or used with any other feature of any other example or embodiment.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any example term. Likewise, the disclosure is not limited to various example embodiments given in this specification.

Without intent to limit the scope of the disclosure, examples of instruments, apparatus, methods and their related results according to the example embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

For clarity of explanation, in some instances the present technology may be presented as including individual functional blocks representing devices, device components, steps or routines in a method embodied in software, or combinations of hardware and software.

In the drawings, some structural or method features may be shown in specific arrangements and/or orderings. However, it should be appreciated that such specific arrangements and/or orderings may not be required. Rather, in some examples, such features may be arranged in a different manner and/or order than shown in the illustrative figures. Additionally, the inclusion of a structural or method feature in a particular figure is not meant to imply that such feature is required in all examples and, in some examples, it may not be included or may be combined with other features.

While the concepts of the present disclosure are susceptible to various modifications and alternative forms, specific examples thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

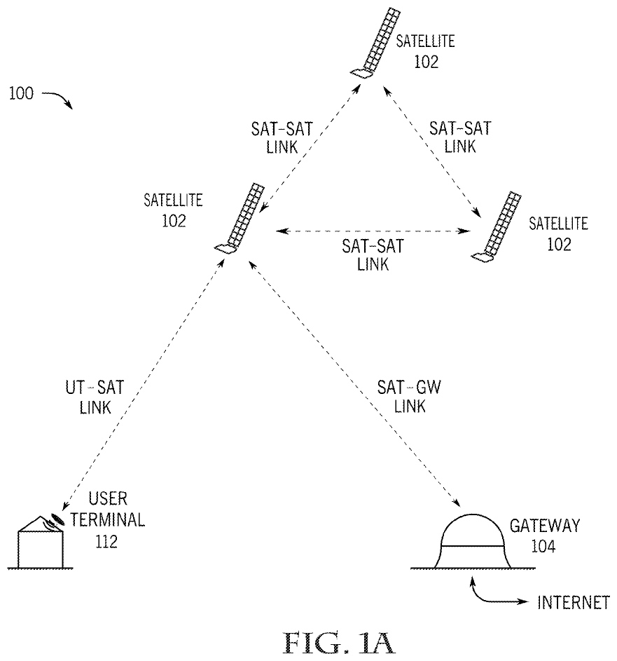

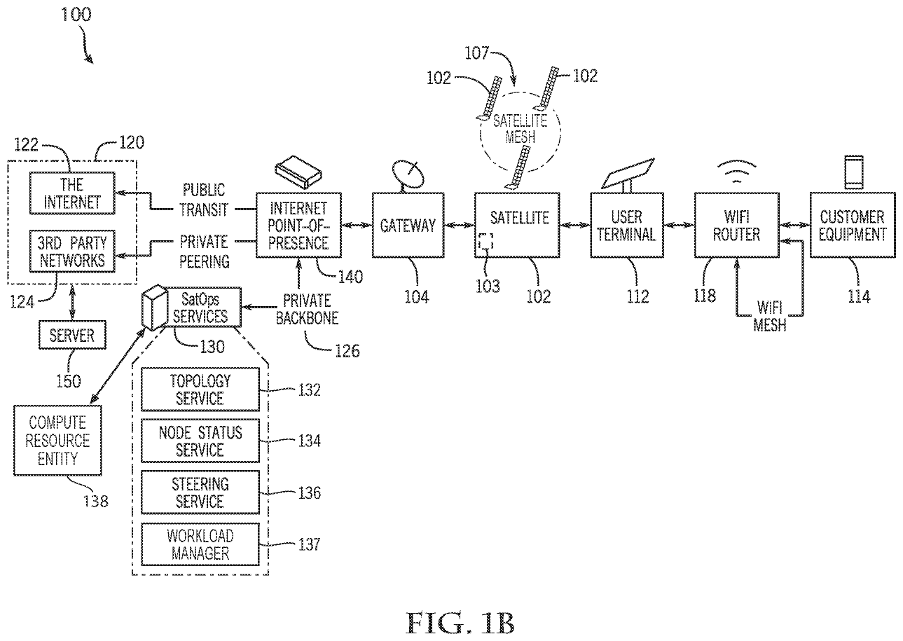

The present disclosure relates to providing cloud computing resources, applications, platforms, data, and similar computer-based resources from one or more satellites in news ways in which the compute resources are available at least in part or possibly available on the one or more satellites and how to access and control those resources. As the innovations operate in the context of a constellation of satellites, user terminals, gateways and ground-based computer environments, this disclosure first provides in FIGS. 1A-4 and the associated discussion an introduction to the various elements and operation of the satellite communication system. Following FIGS. 1A-4 will be a more detailed discussion of the particular focus of this disclosure. In general, this disclosure introduces new techniques for bringing the compute resources closer to the user terminal that communicates with a satellite. The satellite (or a plurality of satellites) can provide data or services to the user computing device (Customer Equipment 114 in FIG. 1B) such that the service or latency is low in terms of providing access to compute resources or providing data to the user computing device. In general, compute resources (data, applications, cloud-services, stock trading platforms, various operations “as a service”, etc.) are more efficient and available with a higher quality of service when they are delivered via a respective satellite to user computing devices. This application discloses ways of essentially enabling a cluster or constellation of satellites, or a single satellite if capable, to act to deliver compute resources in ways not previously possible. “On Earth, traditional computer systems are generally stationary and may be separated from user devices by a large distance. Some entities aim to reduce latency induced by this distance by placing compute resources in close proximity to the downstream user.” However, satellites orbiting the Earth move quickly and are only over a coverage area for a period of time. Satellites cannot simply be positioned close to any individual user terminal. Plus, there are physical constraints or issues with respect to satellites that are not an issue for Earth-based computer systems such as thermal issues, a reboot or reset event based on radiation or software issues, movement issues, battery and energy usage issues, and so forth. While some these issues can also occur on terrestrial networks, they have a higher likelihood of happening in space. This application outlines various approaches to enabling access to compute resources in ways not previously possible from a cluster of satellites and how to manage the access to the compute resources given the many variables that come into play when providing such a service.

Cloud-services are generally computer implemented capabilities that are outside of the capability of an on-premises company computer system. For example, some companies have workloads that may require extra computing power on occasion. They may also need or desire applications or other capabilities that they don't want to pay for in terms of buying their own hardware. Companies may also not want to incur the cost of managing software and hardware infrastructure. In some cases, companies or individuals may want access to capabilities such as more processing power, certain software applications, bandwidth, endpoint-to-endpoint communication channels or data such as streaming video, and so forth. There are many cloud-services characterized by the “X as a service” model where “X” can mean many different functions. For example, XaaS can include banking as a service, blockchain as a service, data management as a service, artificial intelligence or machine learning as a service, software as a service, platform as a service, payment as a service, network as a service, security as a service, and so forth. Any of the capabilities that are available “as a service” can be delivered as compute resources or cloud-services as described herein. Cloud-services can also include access to data such as movies or other media as well as computer processors for processing data or applications. For example, a company may need more computing power than they currently have available on site and desire to expand into a cloud computing environment for the purpose of using processor power. They may gain access to compute resources (hardware and/or virtual resources), and provision applications, software and/or data and then run their jobs on the compute resources. Thus, cloud-services can also include access to such computing power for a period of time. Once a job is complete, the compute resources can be released for others to use.

### Elements of a Satellite Communication System

FIG. 1A is a simplified schematic, and FIG. 1B is a simplified block diagram of elements of a satellite communication system 100. The elements are capable of communication with each other via a mesh topology. The term “mesh topology” refers to the configuration of the elements as nodes in a mesh network. The various nodes in the mesh network coordinate with one another to efficiently route data in order to respond to requests for user data. As will be discussed in more detail herein, the configuration of the nodes in the mesh topology changes dynamically in satellite communication system 100 to account for factors such as the motion of the satellites 102 relative to the Earth's surface and, in some cases, relative motion among the satellites 102. For example, as part of the network mesh topology of the satellite communication network 100, certain satellites 102 may communicate directly with each other in a satellite mesh topology 107.

In addition to the satellites 102, the satellite communication system 100 also includes a user terminal 112 on Earth and a gateway terminal 104 on Earth. The user terminal 112 and the gateway terminal 104 may be referred to collectively as “ground terminals.” Each satellite 102 includes an onboard satellite computer system 103 programmed to manage communications with user terminals 112, satellite access gateways 104, and other satellites 102, using one or more communication terminals (e.g., RF antennas and/or laser communication terminals) of the satellite. In particular, the satellite computer system 103 routes communications to and from those nodes through the respective satellite 102 as part of the network mesh topology. The satellite 102 can also include other components that can be represented generally by feature 103. For example, sensors that detect radiation, electrical signals, and/or temperatures experienced by the satellite 102, a gyroscope and/or any other component related to the health and condition of the satellite 102 in space. The data received from these components can be communicated to the satellite computer system and used to determine how to cluster or organize the deliverance of compute resources such as data, applications, high frequency trading platforms, endpoint-to-endpoint services, computer processor usage, and so forth from a dynamically adjusting cluster or constellation of satellites.

User terminal 112 may be installed at a house, a business, a vehicle (e.g., a land-, air-, or sea-based) vehicle, or another Earth-based location where a user desires to obtain communication access or Internet access via the satellites 102. An Earth-based endpoint terminal 102 may be a mobile or non-mobile terminal connected to Earth or as a non-orbiting body positioned near Earth. For example, an Earth-based endpoint terminal 112 may be in Earth's troposphere, such as within about 10 kilometers (about 6.2 miles) of the Earth's surface, and/or within the Earth's stratosphere, such as within about 50 kilometers (about 31 miles) of the Earth's surface, for example on a stationary object, such as a balloon.

For example, the user may connect one or more network devices 114 such as desktop computers, laptops, mobile devices, Internet of Things (IoT)-enabled devices, and the like (collectively, “customer equipment”) locally to the user's user terminal 112 and obtain access via satellites 102 to the Internet. Although the local connection between the customer equipment and the user terminal is illustrated as a WiFi router 118 (or more broadly a WiFi mesh), other types of wired or wireless local communication are also contemplated.

The gateway terminal 104 serves as a satellite access gateway for the satellite(s) 102 to communicate with one or more ground-based networks 120, such as the Internet 122 or another ground-based network 124, through which content, such as videos or other data, may be accessed (e.g., from a server 150) and provided back to the user terminal 112 and network device 114. The gateway terminal 104 may be connected to a point-of-presence (PoP) 140 on the ground-based network 120.

The illustrated communication signal paths in the satellite communication system 100 include a link between the user terminal 112 and one of the satellites 102 in the mesh, which may be referred to as a UT-SAT link. In the exemplary embodiment, the UT-SAT link is implemented as a Ku-band radio frequency (RF) link. For example, the user terminal 112 and each of the satellites 102 may include a phased array antenna for transmitting and receiving RF signals in the Ku band. However, other types of communication links are also contemplated for implementing the UT-SAT link, for example, other bands or other types of links including optical links. Moreover, while only one user terminal 112 and three satellites 102 are illustrated, satellite communication system 100 may include millions of user terminals 112 and many thousands of satellites 102, and different ones of the user terminals 112 and satellites 102 may use different types of communication links to establish the UT-SAT link.

The illustrated communication signal paths in the satellite communication system 100 include a link between one of the satellites 102 in the mesh and the gateway terminal 104, which may be referred to as a SAT-GW link. In the exemplary embodiment, the SAT-GW link is implemented as a Ka-band radio frequency (RF) link. For example, the gateway terminal 104 and each of the satellites 102 may include a parabolic antenna for transmitting and receiving RF signals in the Ka band. However, other types of communication links are also contemplated for implementing the SAT-GW link. For example, the satellites 102 may also include laser communication terminals, as described below, and the gateway terminal 104 may also include one or more laser communication terminals for communication with the satellites 102 when atmospheric weather conditions are favorable for ground-to-space (and space-to-ground) laser transmission. Moreover, while only one gateway terminal 104 and three satellites 102 are illustrated, satellite communication system 100 may include hundreds of gateway terminals 104 and many thousands of satellites 102, and different ones of the gateway terminals 104 and satellites 102 may use different types of communication links to establish the SAT-GW link.

The illustrated communication signal paths in the satellite communication system 100 may further include links between respective pairs of the satellites 102 in the satellite mesh topology 107, which may be referred to as SAT-SAT links. In the exemplary embodiment, the SAT-SAT links are implemented as optical frequency links, or simply “optical” or “laser-based” links. For example, each of the satellites 102 also includes one or more laser communication terminals for transmitting and receiving laser-based (e.g., optical) signals. The laser communication terminals may be dynamically oriented with respect to the satellite 102 on which they are mounted to enable the laser communication terminals of each satellite 102 to track, and maintain the SAT-SAT links 106 with, other satellites 102 in relative motion with respect to the satellite 102. In the exemplary embodiment, each of the satellites 102 includes multiple laser communication terminals that may be independently oriented to enable each satellite to simultaneously maintain SAT-SAT links with multiple other satellites 102. However, other types of communication links are also contemplated for implementing the SAT-SAT links. Moreover, while only three satellites 102 are illustrated, satellite communication system 100 may include many thousands of satellites 102, and different pairs of the satellites 102 may use different types of communication links to establish the respective SAT-SAT link between them. Additionally, one or more of the satellites 102 may not be configured to establish SAT-SAT links with other satellites 102. SAT-SAT links can be established and changed in the context of dynamic clusters of satellites 102 that can be created based on a schedule or topology for providing access to cloud-services or might be generated dynamically based on one or more requests for compute resources to process workload or access data. After a job is complete, or the use of the compute resources is complete, the cluster of satellites 102 can be removed or eliminated and the SAT-SAT links changed.

In the exemplary embodiment, satellite communication system 100 also includes satellite operations (“SatOps”) services 130 connected to the gateway terminal 104 from a centralized location. For example, each gateway terminal 104 is associated with its own PoP 140, and the PoP 140 is connected to the centralized SatOps 130 via a private backbone 126. The SatOps 130 may transmit various operational and management instructions to the gateway terminal 104, as well as to the satellites 102 (via the gateway terminal) and to the user terminal 112 (via the gateway terminal and the satellites). In the exemplary embodiment, the private backbone 126 may be implemented on an Internet-based secure cloud platform, such as Amazon Web Services® (AWS) by way of a non-limiting example. The AWS PrivateLink is an example system that provides private connectivity between Virtual Private Clouds (VPCs), AWS services and on-premises networks. However, other implementations of the private backbone 126 are also contemplated. In one aspect, the approach disclosed herein can include an endpoint-to-endpoint communication channel through one or more satellites to enable or as part of a private secure network for clients. Note that the concepts disclosed herein enable a secure cloud platform to be moved to one or more satellites 102 and the disclosure provides various approaches to making such a framework feasible given the movement of the satellites and other issues experienced by satellites 102 but not traditional cloud platforms.

The SatOps services 130 and its associated components can in one aspect operate the intelligence to manage or map the access to compute resources across one or more satellites in a network or satellite-based cloud platform. The requests for compute resources can be mapped to the appropriate hardware on one or more satellites in a context of a moving group of satellites with other dynamically changing conditions such as thermal and reboot or reset conditions of individual satellites. In this regard, the SatOps service 130 can operate as a load balancing module (also referred to as feature 130) with respect to requests for compute resources from user terminals 112. For example, the SatOps services 130 can receive information about requests for compute resources and with knowledge of the available compute resources, data, applications, movement of the satellites and so forth across the various satellites, can manage the dynamic generation of clusters of satellites for a period of time to deliver the requested compute resource. The topology service 132 can include or provide the necessary data about the topology of the group of satellites over time and a predicted topology for a future period of time as well. Other components such as the node status service 134 and the steering service 136 can be used to enable the satellites 102 to provide compute resources to requesting user terminals 112. In another aspect, control modules 103 can operate on the satellites to perform these operations as well. In yet another aspect, the functions can be divided between a ground station such as, for example, the SatOps services 130 and a control module 103 on one or more satellites 102.

A workload manager 137 can be included as part of the SatOps services 130. The workload manager 137 can represent an intelligence layer that can receive request for compute resources from one or more customers or user computing equipment 114. For example, the customer equipment 114 might be on-premises equipment for a company wherein the company periodically needs more computing power or access to some kind of compute resource that is not available on the customer equipment 114. The company may request 20 processors, 3 GB of memory, a certain computing environment (operating system, software application, data, and so forth), an endpoint-to-endpoint high-speed communication channel, and submit that request as “workload”. Workload managers typically receives the requests for workload and schedules the workload in a data center such that in each time slice, all or almost all of the processors are actually processing workload rather than being dormant. If a data center for example has 300 processors, the goal is to have for each one second of time, all 300 processors are processing workload. There might be twenty different jobs or workload from twenty different entities that are distributed across the 300 processors for a certain amount of time. Some workload requires a large amount of processing power and other workload does not. However, other workload might only require a few processors. The Moab® workload manager and the Slurm® workload manager are examples of such software tools. Other related tools can include TORQUE (Terascale Open-Source Resource and QUEue Manager) which is a distributed resource manager that provides control over batch jobs and distributed compute nodes. The Maui Cluster Scheduler is another tool that is a job scheduler for use on cluster and supercomputers. This tool is capable of supporting multiple scheduling policies, dynamic priorities, reservations and fairshare capabilities. Other workload automation tools include, but are not limited to, OpenPBS, Oracle Grid Engine, Platform LSF, Apache Airflow, and others. These tools are applicable in the high-performance computing context to provide scalable access to specialized architectures and policy-based management and automation. Those of skill in the art will understand these various workload automation tools. The use of the workload manager 137 relates to the use of any of these types of tools in order to utilize the workload schedule in combination with a topology schedule to improve the clustering of satellites in order to provide more efficient compute resources with less latency.

Fifty-five percent of the United States GDP of around $10 trillion is associated with high performance computing (HPC), including for industrial design, weather prediction, genomic research, vehicle crash simulation and drug discovery. Every industry automotive, aerospace, electronics, financial sector, oil and gas, energy and utilities, life sciences and more is running compute-intensive workloads to optimize designs or predict business outcomes. The approach disclosed herein will make one or more satellites a potential destination for providing compute resources to operate these important workloads.

In many cases, a single job needs to run multiple simulation applications at different scales along with data analysis, in situ visualization, machine learning, and artificial intelligence (AI). Scientific workflow requirements combined with hardware innovations—for example, extremely heterogeneous resources such as GPUs, multitiered storage, AI accelerators, quantum computing of various configurations, and cloud computing resources—are increasingly rendering traditional computing resource management and scheduling software incapable of handling the workflows and adapting to the emerging supercomputing architectures. The supercomputing architectures and such hardware innovations can be implemented on one or more satellites that thus made available via clustering for this type of workload as disclosed herein.

The use of a workload manager that can analyze such data as service level agreements, priority of users or workload, quality of service requirements, types of workload and affinity for certain types of computing environments, and so forth, can enable a highly efficient use of a data center over mere load balancing. In this context of this disclosure, the scheduled workload or scheduled use of compute resources in general and other information about the workload can be utilized by the SatOps services 130 to cluster satellites in a more intelligent manner. The use of the workload manager 137 will be described in more detail below.

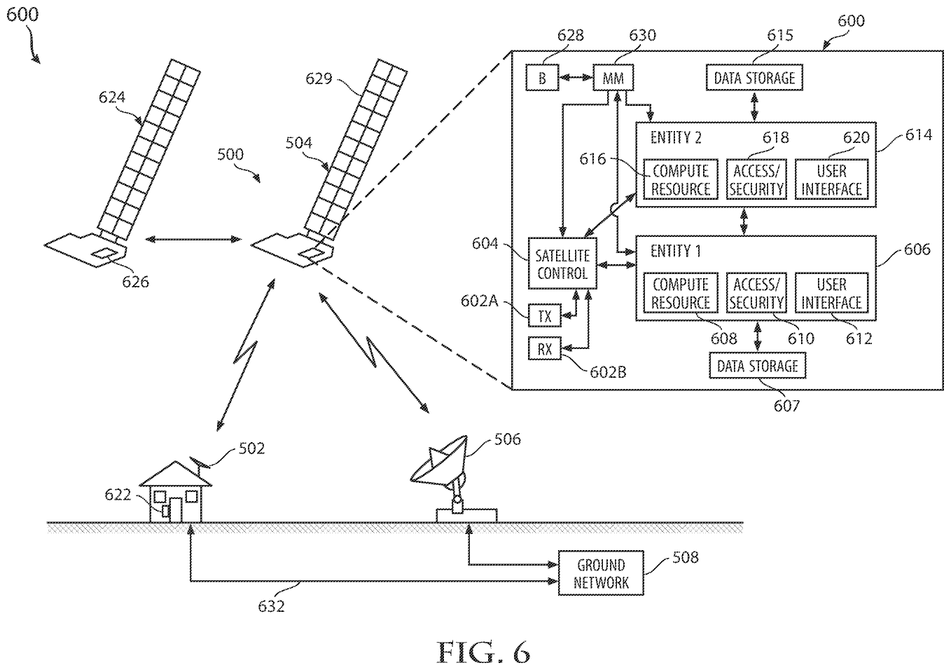

In the context described herein, third parties 138 separate from the entity operating the satellite or satellites 102, can have compute environments configured on one or more satellites and can provide compute resources to user terminals. Compute resource entity 138 can provide data associated with its cloud-services to the SatOps service 130 which can then utilize that data to provide the routing of a request to the proper satellite or satellites 102 and to perform other operations such as clustering based on the various factors disclosed herein. Issues such as user authorization, status of the compute resources (i.e., location of a particular file, scheduled use of the compute resources that may not allow a quality of service to be delivered, a state of the compute resources, etc.), proximity of the compute resources to the user terminal 112 making the request, and so forth can be considered when routing the request to a satellite or satellites 102. Some of that data can come from the compute resource entity 138 which represents typically a third-party cloud-service provider having an entity compute environment configured on one or more satellites. FIG. 6 illustrates a multi-tenant context in which various entity computing environments are configured.

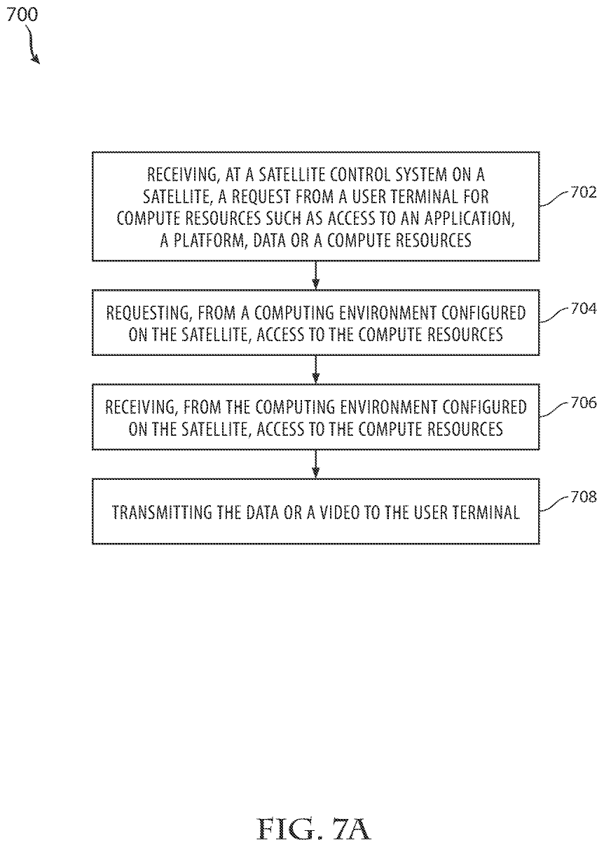

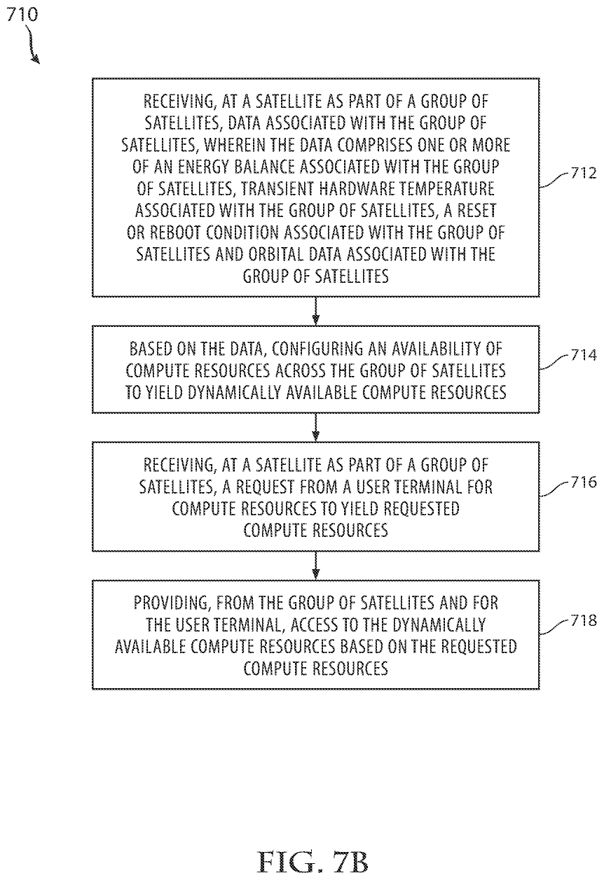

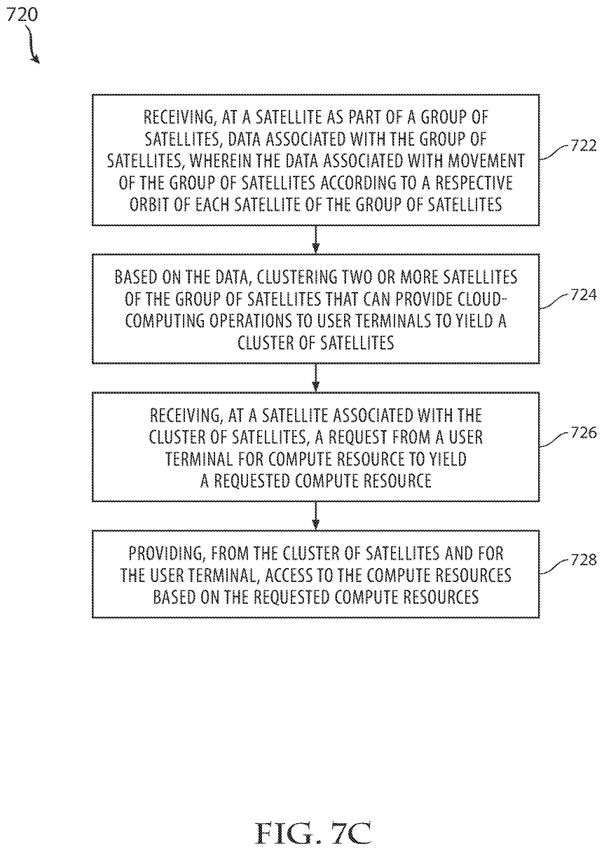

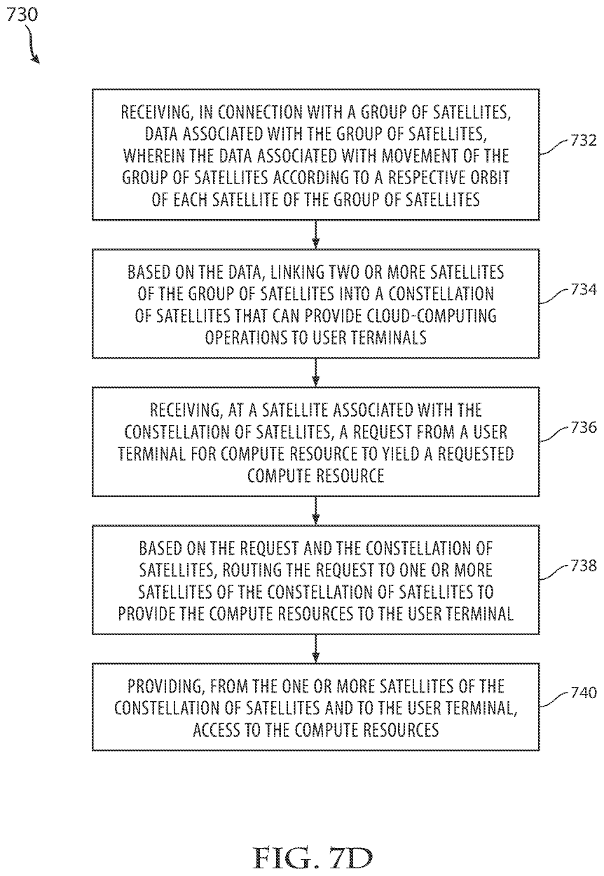

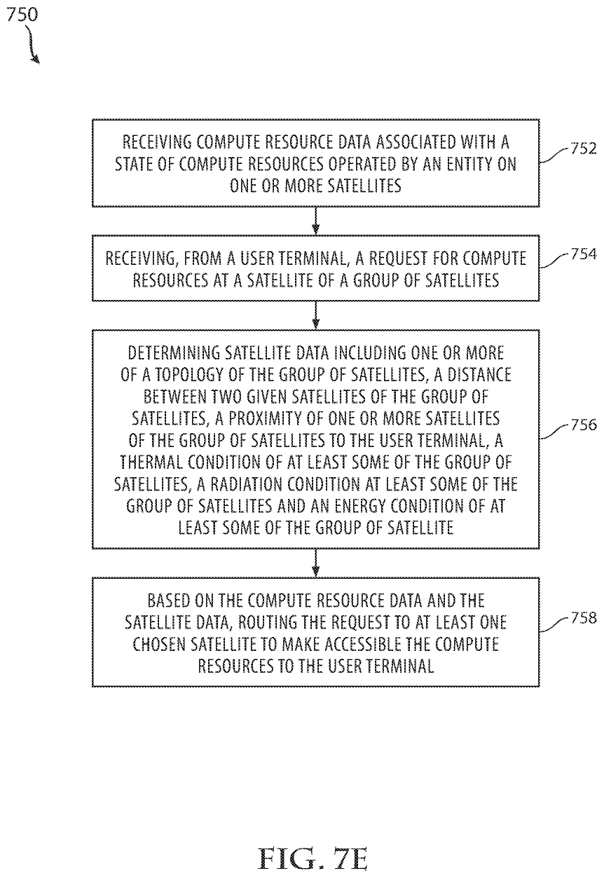

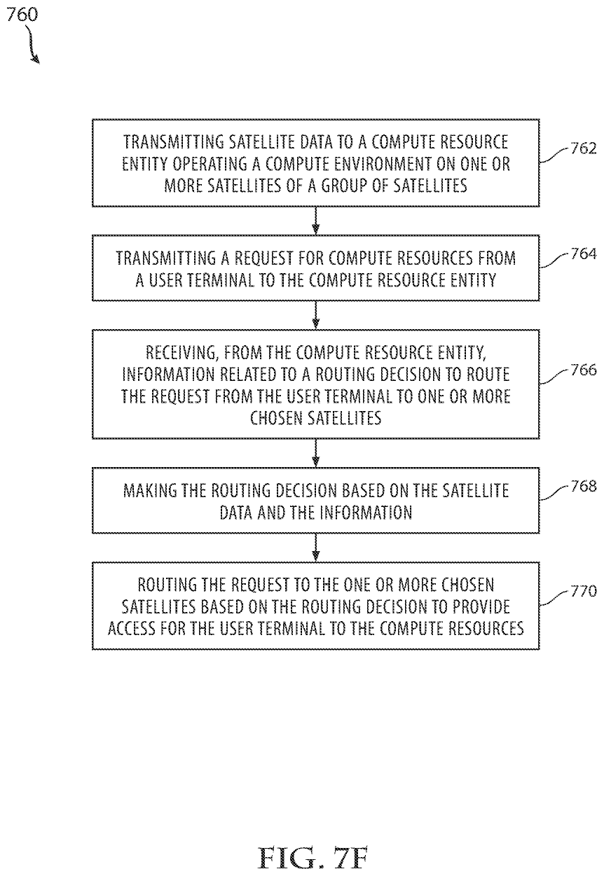

Also shown in FIG. 1B is data flowing from the SatOps service 130 to the compute resource entity 138. In this regard, some compute resource entities 138 may govern access to their compute resources configured in compute environments on respective satellites 102. Permissions may be granted for users that are managed by the compute resource entity 138. Load balancing can occur where requests for use of the compute resources may be balanced to some degree by the compute resource entity 138. Thus, part of this disclosure includes the compute resource entity (such as a company providing streaming video to users) 138 that can receive topology information and use that information to make its routing decisions. For example, a high value customer of the compute resource entity 138 might be guaranteed a certain quality of service. The compute resource entity 138 might manage authorizations for individual users having accounts to access their compute resources. The customer through a user terminal 112 requests access to the compute resource. The request, as well as the topology of the network, is shared with the SatOps service 130 or some other component with the compute resource entity 138. The compute resource entity 138 knows where its compute resources are configured and on what satellites 102. The SatOps services 130 can transmit satellite information or data to the compute resource entity 138 informing the entity of the position of satellites during an upcoming period of time (such as, for example, ten minute intervals) so that the compute resource entity 138 can manage permissions or access to its compute resources configured in respective compute environments on the group of satellites. The compute resource entity 138 can utilize the topology information (which can identify, for example, what satellites are in range or in close proximity to a user terminal 112, which ones are down or have a thermal profile that is too high, which ones are capable of providing the compute resources, and so forth), to either make routing decisions regarding which hardware the request should be serviced by or can make suggestions of several different satellites where the request could successfully be routed. The load balancing module or SatOps services 130 can then either just follow the routing instruction from the compute resource entity 138 with respect to how to map the request to a satellite 102 or can take the suggestions or other data and make a final routing decision for the request for compute resources. The idea of clustering could also be involved. For example, the load balancing module or SatOps services 130 might suggest based on the topology a clustering of satellites to respond to the request. The compute resource entity 138 can approve of the request or make other suggestions or override the request given their data about their compute resources across the satellites 102. The final say might be with the compute resource entity 138 or the satellite entity operating the satellites with respect to routing. This concept is illustrated more in FIG. 7F.

### Satellite Constellation

For global coverage with a reduced latency relative to a terrestrial communication network, satellite communication system 100 employs non-geostationary satellites, and more specifically low-Earth orbit (LEO) satellites 102. Geostationary-Earth orbit (GEO) satellites orbit the equator with an orbital period of exactly one day at a high altitude, flying approximately 35,786 km above mean sea level. Therefore, GEO satellites remain in the same area of the sky as viewed from a specific location on Earth. In contrast, LEO satellites orbit at a much lower altitude (typically less than about 2,000 km above mean sea level), which reduces Earth-satellite signal travel time and therefore reduces communication latency relative to GEO satellites.

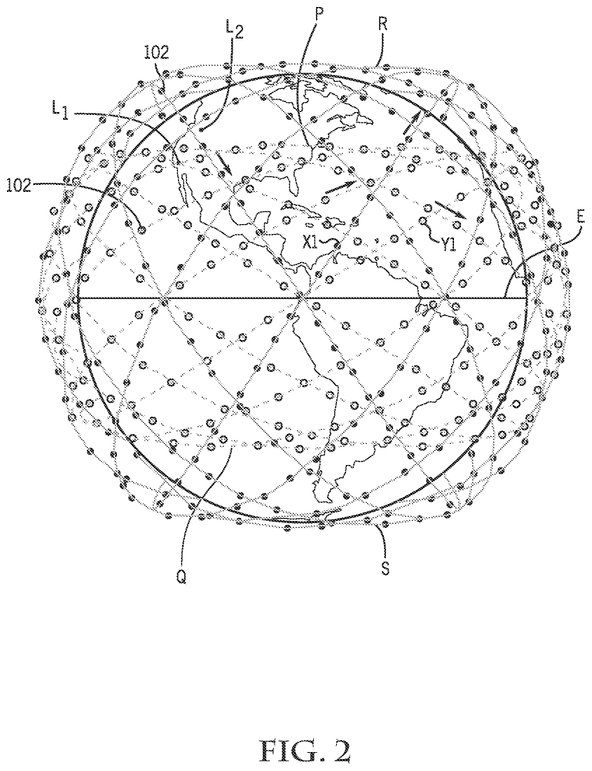

However, a stable low-Earth orbit necessarily corresponds to a much shorter orbital period as compared to GEO satellites. For example, at a particular altitude, a LEO satellite 102 may orbit the Earth once every 95 minutes. Further in the exemplary embodiment, the low-Earth orbits of satellites 102 are prograde. Therefore, LEO satellites do not remain stationary relative to a specific location on Earth, but rather advance generally eastward with respect to the Earth's surface. In addition, the lower orbital altitude means that, in contrast to a GEO satellite, a LEO satellite in an equatorial orbit would not have a “line of sight” for direct communication with user terminals or gateway terminals at middle or upper latitudes on Earth, such as at locations L1 (corresponding to Los Angeles, Calif.) and L2 (corresponding to Seattle, Wash.) identified in FIG. 2.

Accordingly, satellite communication system 100 may include a large number, for example several thousand, satellites 102 arranged in a constellation of inclined orbits that ensures that at least some satellites 102 are always crossing the sky within range of user terminals 112 at any given Earth latitude and longitude. One non-limiting embodiment is illustrated in FIG. 2, which is a schematic showing an example of satellite planar orbital patterns X1 and Y1 of satellites 102 around a rotating Earth. In FIG. 2, the satellites in pattern X1 are represented by closed circles, and the satellites in pattern Y1 are represented by open circles, with arrows illustrating a general direction of travel of the satellites in each string. Each satellite string may include a number of equally spaced or substantially equally spaced satellites 102. More specifically, in a frame that rotates with the Earth, satellites 102 in the first string X1 are in discrete orbits sharing a first inclination, and satellites 102 in the second string Y1 are in discrete orbits sharing a second inclination different from the first inclination.

The angle of inclination of the satellites typically corresponds to an upper and lower limiting Earth latitude (indicated as P and Q for satellite string X1, and as R and S for satellite string Y1) of the orbital paths of the satellites. Although two strings at different inclinations are illustrated, other numbers of strings, such as one string or more than two strings, are also contemplated. Moreover, the illustrated angles of inclination are examples, and other angles of inclination for a single string or for multiple strings are also contemplated. Orbital patterns X1 and/or Y1 may be designed as repeating ground track systems or may have a drifting pattern relative to the Earth's rotation rate.

Due to the inclination of the orbits, in addition to the general eastward motion of the satellites relative to the Earth's surface, each satellite 102 spends half its orbital period ascending from south to north over the Earth's surface, and the other half of its orbital period descending from north to south. The movement of the various satellites 102 is taken into account as disclosed herein in the context of clustering satellites for providing access to a user terminal 112 to compute resources on the satellite 102.

### Ground Terminal Mesh Topology

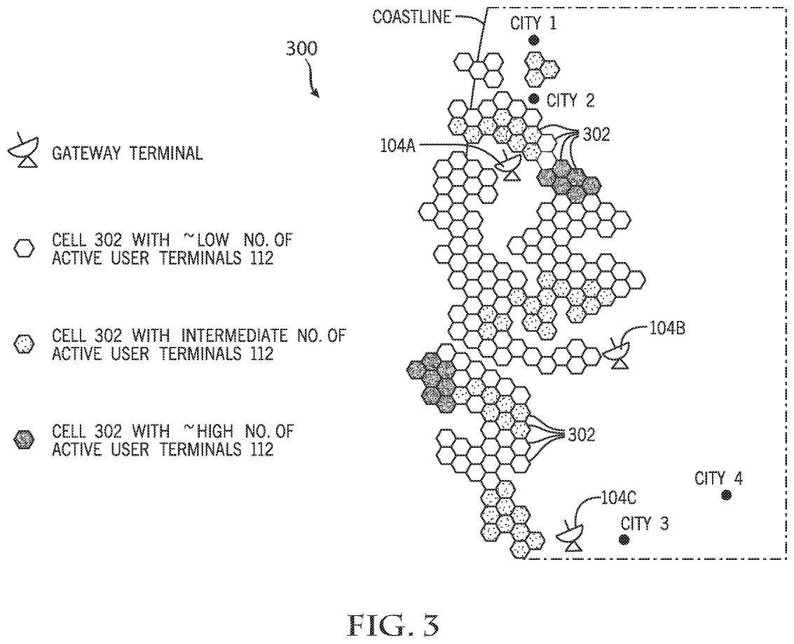

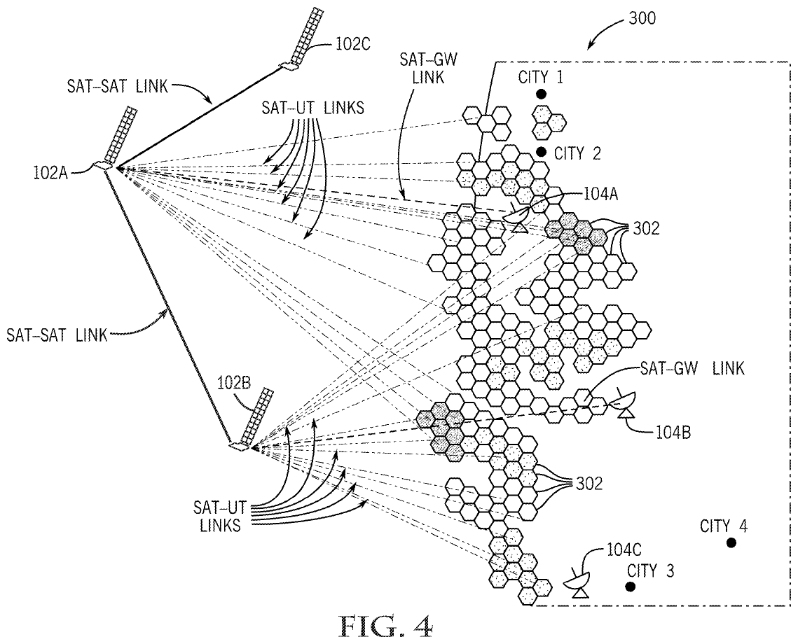

FIG. 3 illustrates a not-to-scale aerial view of an exemplary ground area 300 that may be serviced by the satellite communication system 100. More specifically, the ground area 300 includes a number of user terminals 112 that may transmit requests for user data to be serviced ultimately by, e.g., server 150 (shown in FIG. 1B) or other data sources. The requests for user data, and the data responsive to the requests, may be routed to and from the user terminals via the network topology of the satellite communication system 100. FIG. 4 illustrates a not-to-scale aerial view of requests from, and responses to, ground area 300 being serviced by example satellites 102A, 102B, and 102C of the group of satellites 102 in communication with example gateway terminals 104A, 104B, and 104C.

The network topology of the satellite communication system 100 may be analogized to a map of roads (travel routes) interconnecting a group of cities (nodes). For road travel between two cities separated by a significant distance, several different road routes may be available, each using roads that connect a different set of intermediate cities. One must know which intermediate cities are connected by roads, and how much traffic there will be on each road, in order to select the best travel route between the two cities.

Similarly, for data travel between two nodes in the satellite communication system 100 (e.g., between a user terminal 112 and a data source, such as the ground-based server 150 (shown in FIG. 1i)), several different network routes may be available, each using links that connect a different set of intermediate nodes (i.e., satellites and gateways). One must know which satellites are within the field of view of the user terminal, which satellites and gateways are connected by data links, and how much traffic there will be on each link, in order to select the best data route between the user terminal and the data source. The topology of the satellite communications network 100 is more complex than a road map, however, because the “roads” (data communication routes through the mesh topology) must be frequently reconfigured to accommodate the relative motion of the satellites 102 with respect to the ground terminals 112 and 104, and in some cases with respect to each other. In some examples, the reconfiguration must occur once or more per minute.

In the exemplary embodiment, the ground area 300 includes user terminals 112 grouped into service cells 302. Although each service cell 302 is illustrated as a hexagonally shaped area, service cells 302 of any shape are contemplated. Moreover, although the service cells 302 are illustrated as having a particular size, other sizes of service cells 302 are contemplated. The ground area 300 also includes one or more gateway terminals 104.

With reference to FIGS. 1-4, as a result of the motion of satellites 102 relative to the Earth's surface, a particular satellite 102 may be in a position to establish communication with the user terminals 112 in a particular service cell 302 for only a short time window, such as less than fifteen minutes, less than five minutes, or less than one minute. In the exemplary embodiment, the SatOps services 130 include a topology service 132 that assigns each service cell 302 to one of the satellites 102 on a slot-by-slot basis, in which each slot represents a period of time. The period of time, i.e., time slot length, may be selected to accommodate the short time windows over which any particular satellite may be within the field of view of the user terminals in that service cell, as discussed above. In the exemplary embodiment, the time slot length is between 10 and 20 seconds inclusive. For example, each time slot may be 15 seconds long. However, other time slot lengths are also contemplated.

The topology service 132 may transmit topology schedule data to the user terminals 112 in each service cell 302 on a regular basis (e.g., via the gateway terminal 104 and the satellite 102 that are currently in communication with the service cell 302 associated with the respective user terminal 112). The topology schedule data transmitted to the user terminals specifies one or more of the satellites 102 that will be available for connectivity to the respective user terminal 112 during one or more future time slots. In conjunction with the arrival of the future time slot, the user terminal 112 initiates a SAT-UT link with one of the satellites 102 specified by the topology schedule data for that time slot. In the exemplary embodiment, the SatOps services 130 also includes a steering service 136 that is programmed to manage the routing of the many data requests from, and responses to, user terminals 112 through the network topology of the satellite communications system 100. As disclosed herein, the network topology can vary based on the need to provide access to compute resources available on one or more satellites 102. Thus, the timing and information provided can be utilized by an intelligence layer on the SatOps or load balancing module 130 and can be used as part of the topology schedule. Thus, the topology schedule can be adjusted to take into account that certain satellites might have a SAT-SAT link to enable access to compute resources that might expand beyond one satellite or to provide access to a satellite 102 that is not within a direct view of a user terminal 112 seeking access to a compute resource.

The timing of the regular transmission of the topology schedule data to the user terminals in a service cell 302 may be selected to balance several factors. For example, transmitting the topology schedule data for each time slot well in advance of the arrival of the future time slot helps to ensure that the topology schedule data propagates through the gateways and satellites to the user terminals in time to enable the user terminals to re-orient their respective phased array RF beams when the future time slot arrives. On the other hand, transmitting the topology schedule data for each time slot a relatively short time in advance of the arrival of the future time slot enables the topology service 132 to account for more up-to-date satellite and gateway statuses and ground demand data in assigning service cells to satellites. For example, the SatOps services 130 may include a node status service 134 that monitors the satellites 102 and gateways 104. The node status service may provide projected satellite orbital positions during future time slots based on the position, velocity, and altitude of each satellite. The node status service may also provide data indicating Internet connectivity and performance of the PoP 140 associated with each gateway 104, and/or data indicating weather-based signal attenuation prediction data for each gateway 104. The node status service 134 may further evaluate the health and operability of each satellite and gateway, for example, by tracking a slew rate and alignment performance of each parabolic antenna of the satellite or gateway to determine a current capability of the parabolic antenna to obtain and track links. Other types of health and/or status monitoring of the nodes in satellite communication system 100 are also contemplated. The topology service 132 may be programmed to avoid assigning a potential link between nodes if the node status data suggests the link would be unreliable.

In some examples, the factors involved in advance transmission timing for the topology schedule data may be balanced advantageously by regularly transmitting the topology schedule data to the user terminals in each service cell at an advance transmission time of five to ten minutes in advance of the one or more future time slots associated with the topology schedule data. However, other advance transmission times are also contemplated.

As discussed above with respect to user terminals, a particular satellite 102 also may be in a position to establish communication with a particular gateway terminal 104 for only a short time window. In the exemplary embodiment, the topology service 132 also assigns each satellite 102 to one of the gateway terminals 104 on the slot-by-slot basis. The topology service 132 may transmit topology schedule data to the satellites on a regular basis (e.g., via the gateway terminal 104 that is currently in communication with the respective satellite 102). The topology schedule data transmitted to the satellites specifies an expected connectivity of the respective satellite 102 to one of the gateway terminals 104 during one or more future time slots. In conjunction with the arrival of the future time slot, the satellite 102 initiates a SAT-GW link with the gateway terminal 104 specified by the topology schedule data for that time slot.

The timing of the advance transmission may be based on advance timing factors similar to those discussed above. For example, the satellites and gateways terminals may need to receive the topology schedule data sufficiently in advance of the future time slot to calculate and execute slewing of their respective parabolic RF antennas as required by the topology schedule data for that future time slot. In some examples, the advance transmission time for the topology schedule data to the satellites is five to ten minutes in advance of the one or more future time slots associated with the topology schedule data. However, other advance transmission times are also contemplated.

For example, as illustrated in FIG. 4, three satellites 102A, 102B, and 102C are approaching ground area 300 at the start of a particular time slot. The service cells 302 in the ground area have varying numbers of active user terminals 112. The user terminals 112 in each service cell 302 have previously received topology schedule data for the particular time slot, specifying satellites 102A, 102B, and 102C as being available for UT-SAT links during the particular time slot. Accordingly, in conjunction with the arrival of the time slot, the various user terminals 112 in ground area 300 establish respective links with satellite 102A, 102B, or 102C for communication with satellite communication system 100.

In some examples, the topology schedule data specifies, on a per service cell 302 basis, a priority sequence in which the user terminals 112 should attempt to establish links with the available satellites 102A, 102B, and 102C. In other words, the topology schedule data sent to user terminals in some service cells 302 may specify a priority of 102A, 102B, and 102C for attempts to establish links during the time slot, while the topology schedule data sent to user terminals in other service cells 302 may specify a priority of 102B, 102A, and 102C for attempts to establish links during the time slot. Each user terminal 112 attempts first to establish a UT-SAT link with the first satellite in the priority sequence, and if unsuccessful, attempts to establish a UT-SAT link with the second satellite in the priority sequence, and so on. Although three satellites are listed in the example priority sequences above, other numbers of satellites in a priority sequence are also contemplated, and different service cells may be given different numbers of satellites in their priority sequences. In other examples, the topology schedule data merely identifies, on a per service cell 302 basis, a non-prioritized list of satellites that should be available to establish links, and each user terminal 112 is programmed to select for itself an order in which the user terminal will attempt to establish a link with each of the listed satellites.

There may be several advantages in providing the user terminals 112 in each service cell 302 with more than one candidate satellite 102 for establishing a UT-SAT link during a given time slot. For example, for a service cell 302 that receives topology schedule data including a list of candidate satellites 102A, 102B, and 102C, some user terminals in that service cell may become blocked from communication with satellite 102A, as the satellite moves across the sky relative to the ground, by a local obstacle, such as a tree or building. The list of candidates in the topology schedule data enables the user terminal to quickly move to establish a link with the next candidate satellite during the same time slot. In addition, there may be an upper limit on the number of UT-SAT links that can be maintained by each satellite 102A, 102B, and 102C. For example, this may be due to a physical limitation on the number of channels that can be maintained simultaneously by the phased array RF antennas on each satellite 102, and some of the channels may occasionally fall offline for short periods. Accordingly, some user terminals 112 in a service cell 302 with a relatively high number of active user terminals may be blocked from linking to one or more of the candidate satellites in the topology schedule data because other user terminals were first to take the available channels. Again, the list of candidate satellites in the topology schedule data enables the blocked user terminal to quickly move to establish a link with the next candidate satellite during the same time slot. For these or similar reasons, even in examples where all user terminals in the same service cell 302 receive the same priority list of satellites for a particular time slot, user terminals in that service cell actually may establish UT-SAT links with different satellites during that time slot.

Similarly, the satellites 102A, 102B, and 102C have previously received topology schedule data for the particular time slot shown in FIGS. 3 and 4, specifying gateway terminals 104A, 104B, and 104C as being available for SAT-GW links during the particular time slot. Accordingly, in conjunction with the arrival of the time slot, the various satellites 102 establish respective SAT-GW links with gateway terminals 104A, 104B, and 104C for communication with satellite communication system 100. The topology schedule data provided to the satellites 102 may specify a prioritized sequence of gateway terminals for link attempts or may simply identify a non-prioritized list of candidate gateway terminals that are available to establish links, in which case the satellite is programmed to select for itself an order in which the satellite will attempt to establish a link with each of the listed gateway terminals.

There may be several advantages in providing the satellites 102 with more than one candidate gateway terminal 104 for establishing a SAT-GW link during a given time slot. For example, satellite 102A receives topology schedule data including a list of candidate gateway terminals 102C, 102A, and 102B, but may be blocked from establishing a high-quality link with gateway terminal 104C by weather-based signal attenuation. The list of candidates in the topology schedule data enables the satellite to quickly move to establish a link with the next candidate gateway terminal during the same time slot. In addition, there may be an upper limit on the number of SAT-GW links that can be maintained by each gateway terminal 102A, 102B, and 102C. For example, this may be due to a physical limitation on the number of satellites that can be tracked simultaneously by the parabolic RF antennas at each gateway terminal site, and some of the parabolic antennas may occasionally not track as expected for short periods. Accordingly, some satellites 102 may be blocked from linking to one or more of the candidate gateway terminals in the topology schedule data because other satellites were first to take the available channels. Again, the list of candidate satellites in the topology schedule data enables the blocked satellite to quickly move to establish a link with the next candidate gateway terminal during the same time slot.

### Satellite Mesh Topology and Sub-Meshes

The term “satellite mesh topology” refers specifically to the network interconnectivity among the group of satellites 102 as nodes within the overall mesh network, and the configuration of the satellite mesh topology 107 changes dynamically over time in the satellite communication system 100 to account for relative motion among the satellites 102 and other factors. With respect to clustering of satellites 102, the concept is applied herein to provide via one or more satellites a cluster of satellites that are chosen based on a number of factors to enable users to access cloud-services or compute resources from the cluster of satellites. This is beyond merely seeking access to the Internet through the satellite network as was traditionally done. In this case, where a particular compute resource entity 138 has for example establishes a cache of data or has respective compute environments configured on a sub-group of satellites, the satellite mesh topology can involve clustering the sub-group of satellites and establishing SAT-SAT laser links between those satellites because: (1) a user terminal (or multiple user terminals 112) has requested a compute resource provided by the compute resource entity, (2) the system expects requests for compute resources from a geographic region and is preconfiguring a cluster of satellites to prepare for requests for compute resources and/or (3) other reasons determined by the load balancing module 130.

One factor that affects the satellite mesh topology 107 is that each satellite 102 can only link directly to a limited number of other satellites 102 at any given time, due to each satellite 102 having a finite number of laser communication terminals (and/or other SAT-SAT communication devices). In other words, at any given time, each satellite 102 is capable of establishing a direct network connection to only a few other satellites 102 out of potentially thousands of satellites in the constellation. In one embodiment, each satellite 102 has four laser communication terminals available to link to other satellites 102. However, examples in which one or more of the satellites 102 has a different number of laser communication terminals (or a different number of other SAT-SAT communication devices) are also contemplated.

Due to the finite number of possible direct connections between pairs of satellites 102, and other factors discussed in more detail below, the topology service 132 may dynamically assign each satellite 102 to a sub-mesh that includes a particular subset of satellites in the constellation. A “sub-mesh” is defined, for purposes of the present disclosure, as a set of satellites 102 that are all capable of communicating with each other using SAT-SAT links within the set. In other words, two satellites 102 in the same sub-mesh need not have a direct SAT-SAT link between them, but must at least be linked indirectly via a communication path through SAT-SAT links with one or more satellites in the same sub-mesh. In some examples, at any given time, hundreds or thousands of different sub-meshes may be established among the thousands of satellites in the constellation.

In the exemplary embodiment, the topology service 132 assigns each satellite 102 to a sub-mesh on the slot-by-slot basis. The topology service 132 may include the sub-mesh assignments in the topology schedule data transmitted to each satellite 102 on the regular basis, as discussed above (e.g., via the satellite access gateway 104 currently in communication with the respective satellite 102). More specifically, the topology schedule data may specify a connectivity of the respective satellite 102 to other satellites in the satellite mesh topology 107 during the one or more future time slots. In conjunction with the arrival of the future time slot, the satellite computer system 103 dynamically establishes SAT-SAT links with the other satellites specified by the topology schedule data for that time slot, as well as the SAT-GW link with the gateway terminal 104 specified for that time slot.

Another factor that affects the satellite mesh topology 107 is that reliable communication links between each satellite 102 and other satellites 102 can typically be established only within a threshold distance between the satellites, due to parameters such as a line-of-sight requirement for laser-based links and/or tracking and pointing accuracy limitations of the antennas. Accordingly, as satellites 102 move relative to each other on their respective orbital paths, previously established links between satellites may become untenable as the distance between them increases. Those satellites can each be dynamically assigned to a respective different sub-mesh as they move to within the threshold distance of other satellites in the constellation.

As a practical matter, it is beneficial to select the set of satellites 102 for a sub-mesh from satellites that are relatively close to each other in physical space. For example, physically close sub-meshes may be beneficial to reduce a signal travel-time (communication latency) within the sub-mesh, to reduce a precision needed for antenna alignment to establish SAT-SAT links among the set, and/or to reduce a transmitter power needed to maintain the SAT-SAT links in the sub-mesh.

Satellite velocity is another factor that affects the satellite mesh topology 107. In particular, reliable communication links between each satellite 102 and other satellites 102 can typically be established only within a threshold relative velocity between the satellites. For example, the laser communication terminals on a first satellite 102 may not be able to reliably track and point at a second satellite 102 as that second satellite moves at a high relative velocity through the first satellite's field of view, even if the distance threshold between the first and second satellites is satisfied.

Yet another factor that affects the satellite mesh topology 107 is satellite altitude. Satellites 102 within the constellation may be placed at differing orbital altitudes, for example within an altitude band about a nominal altitude of the satellite string. The field of view of the surface of the Earth from a first satellite at a higher orbital altitude typically is broader than the field of view of a second satellite 102 at a lower orbital altitude above the same location on Earth. Thus, the first satellite 102 may be able to reliably link with ground terminals across a broader geographic range. Moreover, satellites 102 have different velocities at different orbital altitudes. Thus, satellites 102 in relatively close proximity at a certain time, and moving in the same general direction, may nonetheless separate from each other over a relatively short time if they are at different ends of the orbital altitude band.

Still another factor that affects the satellite mesh topology 107 is the differing demand levels from user terminals 112 in different service cells 302 during each time slot. Sub-meshes may be assigned in part based on satellite positions relative to one or more service cells 302 or satellite access gateways 104. For example, satellites 102 passing close to a high-demand ground area (e.g., a geographic area that includes service cells 302 having a relatively high density of active user terminals 112) during a time slot may be preferentially assigned to sub-meshes covering the high-demand ground area, rather than to sub-meshes covering adjacent, lower-demand ground areas.

In some examples, the mesh topology time slot length selected to accommodate the relative motion of the satellites 102 to ground terminals 112 and 104, as discussed above with respect to the general system mesh topology, also works well to accommodate the potentially short duration of the various links associated with the satellite mesh topology 107, based on the factors described above. In the exemplary embodiment, the time slot length is between 10 and 20 seconds inclusive. For example, each time slot may be 15 seconds long. However, other time slot lengths are also contemplated. In the exemplary embodiment, the time slot start time, end time, and/or duration for the satellite sub-mesh assignments are selected to correspond to the time slot start time, end time, and/or duration for the time slots used to assign service cells to satellites and satellites to gateway terminals. However, non-corresponding time slot start times, end times, and/or durations are also contemplated.

The topology service 132 may be programmed to evaluate one or more of the factors above in determining the satellite sub-mesh topology schedule data for each of the time slots. For example, as discussed above, the node status service 134 may provide status data, e.g., position, velocity, altitude, health, and operability, of each satellite, which may include tracking a slew rate and alignment performance of each laser communication terminal on the satellite to determine a capability of the terminal to make and maintain new links. The topology service 132 may use such data from the node status service 134 in making sub-mesh assignments.

In certain examples, the topology service 132 may further be programmed to assign a reliability rating to each SAT-SAT link in the topology schedule data. For example, the topology service 132 may evaluate the node status data provided by the node status service 134 for a particular pair of satellites to predict a reliability of an assigned SAT-SAT link between that pair of satellites. For example, if the link is assigned to a particular laser communication terminal on one of the satellites, and that particular laser communication terminal has demonstrated slightly degraded slewing/tracking performance, the link may be assigned a lower reliability rating. The reliability rating may be included, along with the assigned SAT-SAT link, in the topology schedule data transmitted to that pair of satellites.

As noted above, the topology service 132 may be programmed to transmit the sub-mesh topology schedule data to the satellites on the same regular basis, such as five to ten minutes in advance of the one or more future time slots, as is used to transmit general mesh topology schedule data to the nodes. However, other advance transmission times are also contemplated. The topology schedule may be transmitted sufficiently in advance of the future time period to enable each satellite 102 to re-orient one or more laser communication terminals as necessary to establish communication with any satellites 102 in the future time-slot sub-mesh that were not in the previous time-slot sub-mesh to which the respective satellite was assigned.

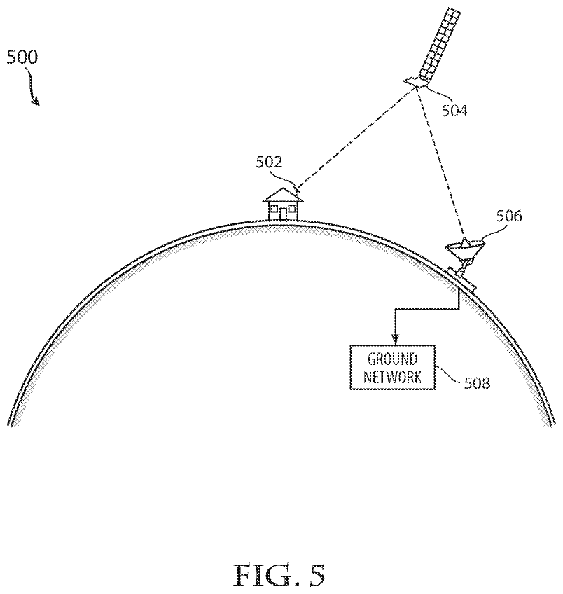

Systems are currently being deployed to provide communication via constellations of satellites. FIG. 5 is a not-to-scale schematic diagram that illustrates an example of communication in such a satellite system 500. An endpoint terminal or user terminal 502 is installed at a house, a business, a vehicle, or another location where a user desires to obtain communication access or Internet access via a network of satellites. A communication path is established between the endpoint terminal 502 and a satellite 504. The satellite 504, in turn, establishes a communication path with a gateway terminal 506. In another embodiment, the satellite 504 may establish a communication path with another satellite (not shown) prior to communication with a gateway terminal 506. The gateway terminal 506 is physically connected via fiber optic, Ethernet, or another physical or wireless connection to a ground network 508. The ground network 508 may be any type of network, including the Internet.

What is needed in the art is an improved structure and/or function that enables data to be requested from a user terminal 502 and provided directly from the satellite 504. In one nonlimiting example, this disclosure addresses limitations with respect to the process described above in which a user requests a video (or any data) for viewing and the satellite 504 and must receive the video from the gateway terminal 506 which obtains the video from a ground network 508, such as the Internet. There is latency involved in the need to transfer the video from the gateway terminal 506 up to the satellite 504, and then down to the user terminal 502. Backhaul processes in the context of satellite communications can also cause latency issues. This disclosure introduces a new computing environment that is configured directly on the satellite 504. The new computing environment stores video, files or any other data which might be requested. Rather than forwarding a request from the satellite 504 to the gateway terminal 506, this disclosure provides the ability of the satellite 504 to simply retrieve the requesting data from its own storage or memory as managed by a media entity (such as a video streaming service or a video sharing web site) in its own independent and secure computing environment. The secure computing environment would be firewalled—in terms of hardware, software, or a combination of both technologies—from other environments and control systems for the satellite.

Furthermore, what is needed in the art can be a broader application of servers, memory, and other components integrated into the satellite 504 to enable what had been traditionally considered to be terrestrial “cloud” computing components to operate in and be accessible from the satellite 504. Thus, in the broadest sense, the concept disclosed herein provides similar compute resources as traditional cloud computing environment but offers those services from one or more satellites 504. This regard, the various services such as platform as a service (PaaS), software as a service (SaaS), hardware as a service (HaaS), content as a service (CaaS), and so forth can be provided from the satellite 504. As can be imagined, however, there are fundamental differences that need to be taken into account when providing such services from a satellite 504. As a non-limiting set of example issues can include latency, energy, thermal, bandwidth, spectrum, reboot or reset events and weight are introduced in the context of providing compute resources from the satellite 504. These issues are typically not relevant on a terrestrial computing system 508 or arise at a lower rate.

Examples of the present disclosure are directed to any one or more node in the network including the user terminal 502, the satellite 504, or the gateway terminal 506 and particularly with respect to new capabilities in software and/or hardware on the satellite 504. For example, one aspect can include claims directed to structure on the satellite 504 or operations/steps that are practiced on the satellite 504 or a group of satellites. In another aspect, structure or operations could be considered from the standpoint of the user terminal 502 or the gateway 506 or other ground-based components such as the load balancing module 130 and how they respectively function when the compute resources are configured on the satellite 504.

FIG. 6 illustrates the new features introduced herein. One example disclosed herein will relate to the compute resources made available from the satellite 504 and provided upon request to users that gain access to the satellite 504 from a user terminal 502. One example of such a compute resource is cached data such as media which is typically transmitted to a user device 622 via a ground-based cloud computing environment 508. Thus, any hardware compute component, virtual compute resource, data or media content, applications, operating systems, data storage, endpoint-to-endpoint communication channel or any other compute resource can be moved to the satellite 504 and made available to users using the principles disclosed herein. This application discloses a topology and routing scheme that enables the various compute resources to be made available to user devices on the Earth through communication with the respective user terminal 502. As used here, the term “compute resource” can mean data, media, computing processing power, memory, endpoint-to-endpoint communication channels, bandwidth, time of use of hardware or virtual processors, cloud-services, or any compute resource that is traditionally available through the use of cloud computing technology.

As shown in FIG. 6, the satellite 504 can communicate with the user terminal 502. The user terminal 502 can also connect to a user device 622. In this manner, the user device 622 can be a mobile device, desktop computer, IoT (Internet of Things) device, television, or any other device. The user through their user device 622 can access the Internet 508 to obtain data of various types. In one example, the user device 622 will request media such as a movie from a media streaming service or a video from a video sharing web site. The request would be communicated from the user device 622 to the user terminal 502 and transmitted from the user terminal 502 to the satellite 504. In the traditional approach, the satellite 504 must also request and receive, over the air interface, the media from the gateway 506, which requires time and bandwidth, prior to transmitting the media down to the user terminal 502. The approach disclosed herein reduces the latency experienced by the user device 622 due to the distance the signals must travel. The approach also reduces the amount of data that needs to be transmitted over the air interface.

In FIG. 6, new computing components are added to the satellite 504 to enable additional data or compute resources and functionality to be operational on the satellite 504. The computer system 600 of a satellite 504 typically includes the satellite control 604, and one or more antennas 202. The standard or general function of these satellite components is to communicate with one or more of the user terminal 502 and the gateway 506 to provide requested data to the user device 622.

This disclosure also introduces additional memory or storage devices and functionality to enable one or more computing environments in which media entities, such as Netflix®, Disney+®, YouTube®, Hulu®, Apple TV®, or the like, can operate to provide their respective functionality, access, and control as well as content. In one aspect, the concept is essentially moving a media distribution service or a media node or nodes from the ground network 508 on Earth to the satellite 504. The entities can also represent any entity that operates compute resources on the satellite 504, 624. For example, one entity might operate a stock trading platform while another entity provides access to compute processors for on-demand access to processor power for a period of time. A first entity (1) (represented by numeral 606) can represent a contained computing environment with its own operating system and applications to provide a first type of compute resources. The entity (1) 606 can include a compute resource 608 which can be data, software, a cloud-service, a platform, an application and so forth, an access and security control module 610, and a user interface module 612. Any other required functionality can also be provided. Another entity 614 can provide the same or different type of compute resources available on the satellite 504, 624. The entities (1) 606 and (2) 614 can also represent any application, platform, service, operating system and so forth as described herein. The entities (1) 606 and (2) 614 can operate or communicate with each other and other systems within the satellite 504, 624 using an operating system that can be used by, for example, a media entity to manage its distribution of media and communication with other components. Such operating systems can include redundant system drives, power supplies, and network interface ports. Entities (1) 606 and (2) 614 can represent any third-party application as well that can be hosted on the compute environment 600 configured on one or more satellites 104, 624. The entities (1) 606 and (2) 614 can also represent compute resources that enable endpoint-to-endpoint communication channel capability.

Assume, for example, entity (1) 606 is a data streaming service. In this scenario, movies and other programs could be stored in memory 207, or compute resources 616 on the satellite 504 and a separate secure physical or virtual environment of the entity (1) 606 could be dedicated to the media streaming service. The memory 607, can represent any type of memory device used for storing or caching content such as media content or other data. Thus, when a user device 622 requests a movie from the media streaming service, the request is received on the Rx antenna 602B of the satellite 504. The satellite control 604 can access the separate computer environment for entity (1) 606 to fulfill the request. The request does not need to be forwarded to the gateway 506 to obtain the media from the ground network 508. The requested movie will simply be downloaded from the media entity 1 (606) via the Tx antenna 602A to the user terminal 502 and provided to the user device 622.

The entity (1) 606 could control or verify access to a user via the access and security control module 610 and could then transmit, with the data and via the Tx antenna 602A, an optional user interface via the user interface module 612. This way, the user can have a traditional experience on the user device 622 when obtaining media from their registered account at the respective media entity 606, 614. These additional features are optional from the core idea of obtaining the transmission of data from the satellite 504 to the user terminal 502. The user interface may or may not be necessary as in one aspect, users will not know that they compute resources they request are being served from one or more satellites 504, 624. In this regard, there may not be any change or different user interface from what is normally used to request compute resources.

Another entity (2) 614 could also be provided within the computer system 600 on the satellite 504 that provides another type of compute resources. The entity (2) 614 could also have compute resources such as data, processing power, a cloud-service, and so forth 616, access and security controls 618 and optional user interface controls 220. The user experience at the user device 622 could be the same as was previously experienced. However, when the compute resource relates to accessing data, latency can be reduced and less data needs to be transmitted because the satellite 504 stores the data and the other controls for the entity (2) 614. In this regard, the approach makes the satellite available to provide the compute resources to the user terminal 502. Each entity computing environment 606, 614 can operate their own operating system and software and be in separate compute environments (such as in separate containers or virtual environments) in a similar manner to different entities use different compute resources in a public cloud. In this manner, content providers such as Apple® or Hulu® can consider the satellite 504 as a server of their content. The compute resources 614, 608 represent the respective available cloud-services, applications, data, or other functionality made available to user terminals 502.

The one aspect, the computer system 600 can be arranged in a similar manner to a public or private cloud infrastructure. In some scenarios, different entities can gain access to compute resources today via the establishment of virtual environments which are secure and independent of other environments owned by other entities. Thus, the entity (1) 606 and the entity (2) 614 can represent either separate hardware environments which are accessed by the satellite control 604 or they can represent separate virtual computing environments which are either fixed or flexible or elastic in size based on any computing parameter. The environments can also span multiple satellites which are clustered based on the various parameters disclosed herein such as one or more of a topology schedule and scheduled workload.

For example, the computer system 600 could enable load balancing of compute and memory requirements amongst the different compute environments 606, 614 and control systems. In order to save power or weight on the satellite 504, environments could be established as virtual and if the entity (1) 606 has a reduced need for memory 607 and if the entity (2) 614 has extra need for memory 615 or computing power, resources could be adjusted down or up for the respective virtual environment 606, 614 to be able to achieve their goal of servicing their clients with the desired compute resource. A management module 630 could provide a global view of all the resources of the computing system 600 and manage the load balancing or adjustment of compute resources amongst the entities (1) and (2). The management module 630 can also communicate with a load balance module 130 that has a universal view of all the satellites 102 that are available and that will be available. In other words, the management module 630 can receive data regarding the various different entity computing environments 606, 614, their status, their usage, or other data and can transmit that data to the load balancing module 130 that can utilize that data with other topological data as disclosed herein to generate a steering or routing plan or schedule for requests for compute resources across one or more satellites including clustering of one or more satellites to provide the compute resources.

In one aspect, the desired data or other software enabling various cloud-services can be stored in connection with the compute resources 608, 616 in the respective entities 606, 614. However, additional functionality is possible in the context of the structure. For example, the satellite controller 604 could receive a request for the movie “Star Wars” to be directed to entity (1) 606. If the compute resource 608 includes the movie “Star Wars”, the satellite 504 can receive the movie from entity (1) 606 and download the movie down to the user terminal 502 via the Tx antenna 602A. However, if that data is not available as part of the compute resources 608, then the entity (1) 606 could request the video from the other entity (2) 614. If entity (2) 614 has the requested media, then it could transmit or make available the requested media to entity (1) 606 or provide that media to the satellite controller 604 for download to the user terminal 502. A charge could be provided between entities 606, 614 for such a service. This operation could work for any type of compute resource that is requested by a user terminal 502.

Otherwise, if the entity (2) 614 does not have the requested media, then the entity (1) 606 could instruct the satellite 504 to communicate with the gateway 506 and have the media obtained from the ground network 508 and transmitted from the gateway 506 to the satellite 504 for download to the user terminal 502. In one aspect, as the requested media would have to pass through the satellite 504 on its way to the user terminal 502, a copy of the media could be added to the compute resources 608 and thus be available for download based on a later request. In another aspect, bandwidth and costs could be improved as well where the entity (1) 606 and the entity (2) 614 share in duplicate copies of media. In this case, where each entity offers the same video for download, a single copy could be stored on the satellite 504 and accessed via each entity for sale or rent. These principles are applicable to any type of data as well as any cloud-service offered by the entity or entities.

Additionally, the compute resources 608, 616 could be balanced based on a number of different factors. For example, if memory 607, 615 on the satellite 504 is becoming full, then some data can be deleted from the compute resources 608, 616 and other data could be uploaded based on any one or more parameters. For example, if the holidays are coming soon, then holiday-related data or applications (such as on-line payment processes or platforms) could be uploaded to the satellite 504 in preparation for expected requests for the holiday-related compute resources. New release movies may be immediately uploaded as there would be an expectation of request for such media. Trending videos or videos that are beginning to go viral on YouTube® or social media based on the user views could be uploaded to reduce the latency of requests for such videos. Trading platforms that are traditionally busier at a given time could be provisioned in advance as compute resources based on an expected use. Users may have priority such that a particular cloud-service, movies or videos of the request from a priority user are automatically uploaded to the satellite 504 if the requested media or compute resource is not already in storage on the satellite 504. In other aspect, bandwidth could be made available or scheduled in advance for expected endpoint-to-endpoint communication channel requests such as at the beginning of a day of trading on a stock exchange platform.

In another aspect as noted above, load balancing can also occur between satellites. For example, a second satellite 624 could also include similar computer systems that store media, compute resources, operating systems, and architecture 626 locally on the satellite 624. In some cases, satellite 504 may not have the requested compute resource 608 and the satellite 504 could obtain the compute resource from another satellite 624 which could either transmit the compute resource to the satellite 504 or could deliver the compute resource to the user terminal 502 via its Tx antenna. Satellite 504 and satellite 624 could communicate via laser as part of a laser mesh network of satellites.

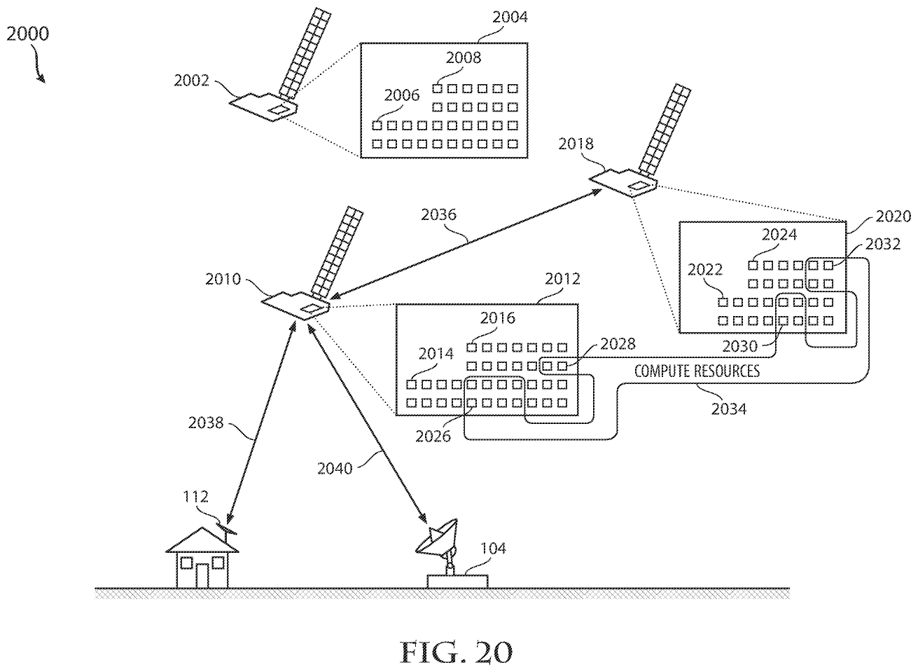

The use of the second satellite 624 in connection with the first satellite 504 can also be representative of a combination or a group of satellites 504, 624 that can operate as a combined “cloud” computing environment or virtual large compute environment or compute resource center. For example, where each of the satellites 504, 624 has compute resources such as one or more of servers, data, cloud-services, operating systems, applications, data storage components, and so forth, the group of satellites 504, 624 can function in the context of a group of servers operating on Earth which share in providing requested compute resources to users. The group of satellites 504, 624 can operate a distributed file system, for example, that can be accessed and shared amongst the satellites 504, 624 to respond to requests for data from the user terminal 502. The group of satellites can be clustered together as disclosed herein dynamically based on parameters including one or more of thermal conditions, reset or reboot events, proximity to each other and to a user terminal 502 or gateway, movement, state, energy availability relative to a requested use of compute resources, number of user terminals in a geographic area over which one or more satellites will pass, a predicted future state of any of these parameters, and so forth. Note that feature 2034 in FIG. 20 shows a set of compute resources that spans multiple satellites.

In another example, assume a user requests compute resources such as processing power, data storage, an application or content. The request is received at the satellite 504 and a control system 630 determines that the satellite 504 does not have sufficient processing power, memory or the proper data for the application. The satellite 504 can communicate via laser or other communication means with another satellite 624 and request the additional compute resources from the second satellite 624. Lasers are a preferred approach for inter-satellite communication as a high-throughput connection is needed for the communication link between satellites. For example, a workload may be requested by the user for a particular compute intensive application such as a weather analysis or a trading platform. If the satellite 504 does not have sufficient computing resources available to process the workload under a quality-of-service (QoS) requirements, then the request can be shifted to a secondary satellite 624 for processing. The resulting data can be communicated from the satellite 624 to the originating satellite 504 and transmitted down to the user terminal 502. The shift can also occur in coordination with a topology schedule received from a load balancing module 130, a workload schedule from a workload manager 137, and/or in connection with data from a compute resource entity 138.

Note however, that any form of wireless communication or communication protocol can be used to transmit data between satellites and lasers are not a requirement for such communication.

The constellation of satellites 504, 624 could operate in one aspect as a mesh network in which the various nodes coordinate with one another to efficiently route data, workload, instructions, and functionality to and from each other in order to respond to requests for compute resources. Many more satellites can be part of the network rather than just two as shown in FIG. 6. Satellites 504, 624 are representative of a potentially larger group of satellites, such as a shown in FIG. 2.

As noted above, one example approach is to provide compute resources entities 138 operating compute resources on the satellite 504 with an ability to cache content or cloud-services available for request by a user. In one aspect, the data and the application that would be necessary to operate entity (1) 606 and/or entity (2) 614 can be transmitted to the satellite 504 after launch. However, because the data would be large, another aspect of this disclosure could be that the satellite 504 is loaded prior to launch with the necessary hardware, software, firmware, data, and so forth which would be necessary or desirable to create the entity (1) 606 and the entity (2) 614. For example, data storage of over 100 terabytes of memory per satellite might be necessary to operate the computing environments of the entities 606, 614.

The addition of the entities to the satellite 504 can cause an extra power draw on the battery 628 of the satellite 504. The satellite 504 has a solar panel 629 that charges the battery 628. A flight computer can manage a power converter board which converts the solar power to bus and battery power. In one scenario, an additional feature added to the satellite 504 is the management module 630 that can perform a number of different functions. As noted above, the management module 630 can manage load balancing and the access of data between the entity (1) 606 and entity (2) 614. The management module 630 can load balance in terms of power drawn from the battery. The management module 630 can reduce the power used by entity (2) 614 if the battery 628 becomes low on power and the entity (2) 614 is drawing too much power. The power might be used for computer processing, access media, transmitting media, and so forth. The management module 630 could place the satellite control system 604 into a low-power state. The management module 630 could cause a delay in some transmissions either to or from the gateway 506, to or from the user terminal 502 or two or from one of the media entities 606, 614.

Energy data can be reported to the load balancing module 130 for use in its intelligence layer in terms of how to cluster satellites for enabling access to compute resources, and how to incorporate that data into a topology schedule which is distributed for a period of time or for dynamic clustering of satellites. In some cases, a request for compute resources might be routed away from a given satellite who has the compute resources available but not sufficient energy at that time to respond timely to the request.

Generally, the management module 630 will evaluate the energy level in the battery 628 and report the energy level to the load balancing module 130 as well as implement power conserving actions amongst the various operations on the satellite 504. Some functions might have priority and thus be given power priority in a low battery situation. In general, the management module 630 will evaluate not only the energy level and the battery 628 but the energy either being consumed by one of the other components or that are scheduled to be consumed and can implement, if necessary, energy saving operations.

In one example, the functions and thus the use of battery power might be known because the functions or operations are scheduled. If a new movie is about to be released, there might be a scheduled or expected increase of activity by entity (1) 606 for obtaining and downloading multiple copies of the movie to various user terminals 502. Other data streams or use of the compute resources of the entities 606, 614 could be scheduled by a workload manager that could be a part of the management module 630. For example, if 1000 requests for different videos are received simultaneously, a workload manager in the management module 630 could schedule the various requests at specific times over a period of five or ten seconds or minutes such that the workload (i.e., accessing and providing the movie copies to the satellite control system 604 for transmission) is predictably and efficiently carried out. This scheduling of workload could also have a corresponding schedule or an expectation of power usage which can be evaluated and managed by the management module 630. The functions of the management module 630 can also be performed on a ground station like the load balancing module 130.

In another example, the entity (1) 606 might be scheduled to download 500 videos to various user terminals 502. This scheduled operation can be called “scheduled workload” for the satellite. Since the management module 630 knows the power consumption associated with the scheduled workload, the management module 630 might grant full power to the entity (1) 606 but then, after the completion of the batch of work associated with the scheduled workload, place the entity (1) 606 in a low power mode or state. Similar scheduling could also occur by the satellite control component 604 in terms of its communication via the Tx antenna 602A with various user terminals 502 and gateways 506. Thus, the power consumption amongst the satellite control system 604, and the entities 606, 614, as well as other components, could be managed and balanced or adjusted based on a management module 630 and an analysis of energy usage, available energy from the battery 628, and/or a schedule of workload and other factors as well. Other parameters might include priority of data, priority of users accessing data, quality of service requirements, expectation of access to the sun for the solar panel 629, historical power usage or workload usage, and so forth. Such function can also be performed by the load balancing module 130 as well.

It is noted that latency can be an issue with respect to satellite communications. Accordingly, the management module 630 can take latency into account in terms of power management as well as scheduling of functions or actions by the satellite control system 604 or the entities 606, 614. Latency can primarily occur in streaming or receiving data from Earth-based stations 502, 506 but can occur in various ways in these compute environments.

It one aspect, the entities 606, 614 can represent compute environments that are configured in a “container.” A container is a unit of lightweight, executable software that packages application code and dependencies in a standardized way. Containers enable an abstraction away from an operating system in the infrastructure (hardware) that the application needs to run on. The container image contains all the information for the container to run, such as application code, operating systems and other dependencies such as libraries or data. There are multiple container image formats and a common one which would be known to those of skill the art is the Open Container Initiative (OCI). The container engine pulls the container images from a repository and can run them.

There can be a number of container engines such as Docker, RKT, LXD as would be known by those of skill the art. The container engines can run on any container host which in this case is the computing environment on the satellite 504. In one sense, the container will essentially provide a separate and secure operating environment for each entity 606, 614. Any of these different entities might have separate operations in “the cloud”. Similar separate virtual resources can be provided on the satellite 504. Also, the software or other compute resources that are provided can also be configured on “bare metal” and not in a virtual environment as described above.

The entities 606, 614 can also operate in virtual machines which aim to abstract an operating system from a physical server. A virtual machine hypervisor can virtualize the hardware to host multiple isolated operating systems. Virtual machine environments can also be implemented on one or more satellites. By using virtual machines and containers, the system can provide a configured computing environment as required by the entities 606, 614. Any other type of compute environment is contemplated as well.

While entities providing videos are discussed by way of example, the computing environments 606, 614 can represent any application or cloud-service having data that is requested by a user terminal 502. Thus, these environments 606, 614 are not limited to media data but can be any kind of data or any kind of compute resource. Furthermore, any number of different entities 606, 614 can exist within the computer system 600 of the satellite 504 as part of a multi-tenant environment. Different entities of different types as well can exist where various services such as Software as a Service (SaaS), Platforms as a Service (PaaS) and so forth can be made available directly on the satellite using the approach disclosed herein.

In one aspect, in a container environment, the management module 630 could include a container orchestrator which can be considered a software platform that addresses the management of multiple containers and a lifecycle management of the containers. For example, a container orchestrator can perform tasks such as provisioning and deployment of the container and the application, data, operating system, and so forth that will function within the container. The container orchestrator in the management module 630 can provide resource allocation associated with a respective container. The container orchestrator can also manage container uptime and application health as well as a dynamic scaling up and down of the container resources perhaps in the context of power management as discussed above. The container orchestrator can also perform functions such as service discovery, networking, security, data storage, use or authorization and access control and other functions. One example container orchestration platform is known as Kubernetes (K8s). This platform can be deployed as part of the management module 630, or a separate orchestration platform on the satellite 504. In one example, a compute resource might be requested by a user terminal 502. In response to the request, the load balancing module 130 or other control component can cluster a group of satellites together, provision operating systems and application software, provide access to data to run on an application, and then run the application, with the data, and download output data to the user terminal 502. The hardware or virtual components are thereby used just be that user for a period of time and then made available for other users.

It is also noted that the respective compute environment, whether configured on dedicated hardware for the environment, configured in a virtual machine or a container or some other type of compute environment, can also support the concept of cloud bursting. In this scenario, with respect to the compute environment operating on the satellite 504, the concept could be considered in an inverse manner from the standard environment in which a private cloud requires additional resources and “bursts” into a public cloud for provisioning and obtaining additional compute resources as they are needed. In the present context, where one of the entities 606, 614 might require additional resources, networking, storage, and so forth, the respective compute environment might expand into cloud-based resources available on the Earth via communication with the gateway 506. Rather than cloud bursting, the concept could be called ground bursting as it would be the satellite 504 that seeks additional compute resources from a ground network 508.

In this context, the ground network 508 might include available compute resources which can be “burst” into from the satellite 504. The reverse might occur as well where a satellite 504 which is configured to accommodate entities 606, 614 with all of the computing power, memory 607, 615, and capability of operating such environments, could also have compute resources available for bursting activities from a ground-based network 508 connected via the gateway 506 or from a user device 622 connected via the user terminal 502. In this scenario, a different analysis might apply than is normal. For example, the ground network 508 or user device 622 might include a compute environment for a company such as Hulu® and involve streaming media upon request. The workload management issue might be that a large number of requests for videos has been made at the ground network 508. An analysis by a workload manager can be performed which includes the consideration of stored media and the possibility of providing that media from the satellite instance (say entity (1) 606) of the media streaming service compute environment. Thus, rather than necessarily bursting into using compute resources on the satellite 504 from the ground network 508, a request for a video or other data that is received at the ground network 508 might be transferred to the satellite 504 for the purpose of delivering that data from a different origination location (the satellite 504) than the ground network 508.

In another example, assume the clustering of satellites as indicated by the load balancing module 130 works to provide compute resources to a user terminal 502. However, if conditions change (which they can with moving satellites) such that continuing to provide the compute resources is not feasible due to one or more of thermal conditions, reset or reboot events, energy conditions, movement of a satellite, additional demands for compute resources, and so forth, then the cluster of satellites might be adjusted or at least some of the requested compute resources might be served from ground-based cloud environments. This bursting into using ground-based computer systems can be dynamic but would utilize the topology data and other data relevant to satellites that are not applicable to terrestrial computer systems.

In one example, the user device 622 might have a standard Internet connection 232 as well as a satellite Internet connection via the user terminal 502 to the satellite 504. In one case, the user device 622 may request data or compute resources from the ground network 508 through a wired connection 232 to the Internet. While the ground-based network 508 might simply provide the data or compute resources in the manner it was requested, due to one or more of latency, cost, power management, priority issues, quality of service issues, and other possible issues, the ground-based network 508 might transfer the request to the satellite 504 and instruct its counterpart compute environment 606 to respond to the request because the data can be transmitted to the user terminal 502 for viewing by the user on the user device 622 or because it might be more efficient to provide access to the compute resources via a satellite 504 or a cluster of satellites. The user may not notice any difference as they may have a standard user interface and simply receive the data such as a view for viewing, without noticing that the source of the data was the satellite 504 rather than the ground network 508.

FIG. 7A illustrates an example method related to storing data directly on the satellite 504 for download to a user terminal 502. While the examples provided include the idea of streaming or providing access to a stored video, the concepts are also equally applicable to any compute resource that might be requested, such as processor power, time, access to machine-learning models, endpoint-to-endpoint communication channels, cloud-services and so forth.

A method 700 can include receiving, at a satellite control system on a satellite, a request from a user terminal for compute resources such as access to an application, a platform, data or compute resources (702), requesting, from a computing environment configured on the satellite, access to the compute resources (704), receiving, from the computing environment configured on the satellite, access to the compute resources (706) and transmitting the data associated with the compute resource to the user terminal (708). The request for compute resources can include a request for media such as a movie or access to cloud-services such as a trading platform, access to an application or other data. The computing environment can be a secure computing environment or any other computing environment, application or service made available by the satellite. The satellite can access, via the laser mesh, another satellite that is configured with the desired compute resource and have the compute resource made available or transmitted (if it is data such as media) to the servicing satellite for communication to the user terminal 502. The satellite might also be part of a dynamic mesh of satellites with SAT-SAT laser communications for the purpose of providing the compute resources. The decision regarding how to cluster satellites together can be based on one or more factors including a topology schedule and/or a workload schedule.

The entity computing environment 606, 614 configured on the satellite 504 can include a memory device 607, 615 that stores the data on the satellite 504. The entity computing environment 606, 614 configured on the satellite 504 further can include one or more of data storage of data such as videos, an access/control module and a user interface module. A management module 630 can manage power, data streaming, scheduling of functions or data requests, access to compute resources, and any other management needs associated with the use of the entity computing environment 606, 614.

When the entity computing environment 606, 614 configured on the satellite 4504 does not store the data on the satellite 504 or have the requested compute resources, the entity computing environment 606, 614 can request the data or access to the compute resources from one of another entity computing environment configured on the satellite 504, a ground network 508 via the gateway 506, or another satellite 624.

The method can further include identifying the entity computing environment 606, 614 configured on the satellite 504 as either having the data or compute resources or being associated with an account of a user associated with the user terminal 502.

Receiving, from the entity computing environment configured on the satellite, the data further can include the entity computing environment 606, 614 performing at least one of authorizing access to the data for a user associated with the user terminal 502 and optionally transmitting a user interface associated with the entity computing environment 606, 614 to the user terminal 502 for use by a user device 622 connected to the user terminal 502. The entity computing environment 606, 614 configured on the satellite 504 can include one of a virtual computing environment and a hardware computing environment. The entity computing environment 606, 614 configured on the satellite can be one of a plurality of entity computing environments configured on the satellite 504.

Note that the entity computing environment could also be any computing environment 606, 614 having associated data or compute resources that the user terminal 502 requests. When the user terminal 502 requests data or compute resources, the computing environment 606, 614 can seek to retrieve from the memory 607, 615 on the satellite 504 the requested data or make available the requested compute resources and if that data is available or the compute resources are available, the computing environment 606, 614 can cause the requested data to the be transmitted via the transmission antenna 602A to the user terminal 502 or enable access to the compute resources. The requested data could be a website, a file, a cloud-service, or an application to download from, for example, an “app store” such as is operated by Apple®, and so forth. Any data can be stored on the satellite 504 and offered for download in the context of this disclosure.

The combination of the first satellite 504 and the second satellite 624 can represent two or more satellites that are in communication via the communication means such as a laser and which can be utilized to create a network of components each of which is a satellite and which can be utilized to provide compute resources to user terminals 502. In one example, with respect to the entities 606, 214 being media entities, a caching topology amongst the plurality of satellites 504, 624 can be implemented in which data, application functionality, cloud-services, processing power, and so forth can be distributed amongst a constellation of satellites 504, 624 to balance the workload requirements across the available compute resources, which are limited because each node or component is a satellite. Issues arise in this context such as which orbital planes the applications on respective satellites 504, 624 should exist in and how frequently does the system distribute the data or content across the constellation of satellites 504, 624. These are issues that are raised through configuring applications and other compute resources to satellites and that introduce new constraints not at issue on Earth. In one aspect, a novelty with this approach can be to communicate data, requests, responses and so forth between satellites using inter-satellite lasers. A distributed application with its associated data and functions can then provide a response to a request for a service, compute resources, or data (media) through receiving the request at a first satellite 504 and utilizing inter-satellite lasers to communication with another satellite 624 or more than one other satellite 624 to coordinate the necessary compute resources to respond to the request.

FIG. 7B illustrates an example method 710 focusing on load balancing in accordance with examples of the present disclosure. The method 710 includes receiving, at a satellite as part of a group of satellites, data associated with the group of satellites, wherein the data can include one or more of an energy balance associated with the group of satellites, a transient hardware temperatures associated with the group of satellites, a reset or reboot events associated with the group of satellites, scheduled workload on one of more satellite, and orbital data associated with the group of satellites (712), based on the data, configuring an availability of compute resources across the group of satellites to yield dynamically available compute resources (714), receiving a request from a user terminal for compute resources to yield requested compute resources (716) and providing, from the group of satellites and for the user terminal, access to the dynamically available compute resources based on the requested compute resources (718). The receiving of the request can occur at one or more of the satellites in the group of satellites. The transient hardware temperature relates to the temperature of the hardware as it transitions from being in the sun to being shaded by the Earth. The reset or reboot event can be the result of the satellite control system rebooting or resetting due to any factor such as a software error or a radiation upset that is experience in space. Some of these events are simply not experienced by computer systems on Earth or can be experienced at lower rates.

In one example, depending on the requested compute resource, a particular satellite or satellites 504, 624 may not have enough energy to respond to the request and thus that might trigger a load balancing operation in which the request is transferred to another satellite or satellites to provide the compute resources. The transfer might occur through inter-satellite communications. In one example, the battery 628 on a satellite 504 might be relatively low, and given the position in orbit, the solar panels 629 on the satellite may not be in the sun for a relatively long period of time for recharging. A power converter is used to manage the conversion of solar power to bus and battery power. In this case, taking the position and movement of the satellite 504 relative to the sun (the source of recharging the battery 628) into account, as well as the nature of the request for compute resources 616 and the power needed to provide the compute resources, the system can handoff the request to other satellites 624. The system can also include the load balancing module 130 on the Earth which can make the steering or routing decisions.

Different requests for compute resources can consume different amounts of energy, such as a difference between a first request for downloading a file and other request for use of a trading platform for a period of time or processing power to process a large amount of data. There are issues not experienced by terrestrial cloud computing environments. Further, thermal conditions may not be appropriate for a given request for compute resources as well. Some requests may cause the satellite 504 to operate hotter just as a computer having a processor that runs constantly for some time can generate heat. Thus, the amount of heat that workload may generate when operating on one or more satellites 504 can be taken into account as well as the thermal condition of the satellite (such as, for example, when it is hot because it is in the sun), when determining how to route or steer requests for compute resources 616, 608.

In another example, depending on the country over which the satellite 112 is passing, the amount of processing requested can change. Some countries have many users and thus the satellite 504 heats up in a similar manner as a computer heats up when it constantly runs. Thus, the transient hardware temperatures are typically related to the satellite 504 being in or out of a view of the sun but also can be based on an amount of use of the satellite 504 over a particular geographic area.

The data associated with the movement of the group of satellites can be received from the topology service 132 described in FIG. 1B. Similar topology services may also reside in one or more of the satellites 504. The topology service 132 typically will provide a schedule of the availability of satellites for a particular coverage of area on the Earth over a period of time and can provide the schedule on particular time frame like fifteen seconds or ten minutes, for example. The topology service 132 can provide data regarding what satellites are operational and that will be in the proper position for a period of time to service or more cells on the Earth in which user terminals 502 reside. Using this topology data, the system whether via a SatOps services component or load balancing module 130 or via cloud-computing managing components on one or more satellites 504, can group the satellites into constellations or clusters on a dynamic or static basis to provide compute resources to user terminals 502.

Compute resources can include any application, data, processing power, or combination thereof from a cluster or a constellation of satellites 504. In one case, the constellation or cluster of satellites is determined by a combination of position and operational status of the respective satellite 504 plus the availability of the compute resource 616, 608 or a portion of the compute resource on the respective satellite 504. For example, a group of satellites might include thirty satellites, of which eight satellites include the necessary software to run a trading platform and fifteen satellites include the necessary data to provide access to media such as movies and television programs. Perhaps a different set of twelve satellites are configured to provide compute resources for users to run a particular software application. The selection or configuration of a constellation or a cluster of satellites can take these individual capabilities into account as well as other issues such as thermal issues, a reset or reboot issue, energy usage, and so forth when considering how to cluster satellites to provide cloud-computing capabilities to user terminals 502.

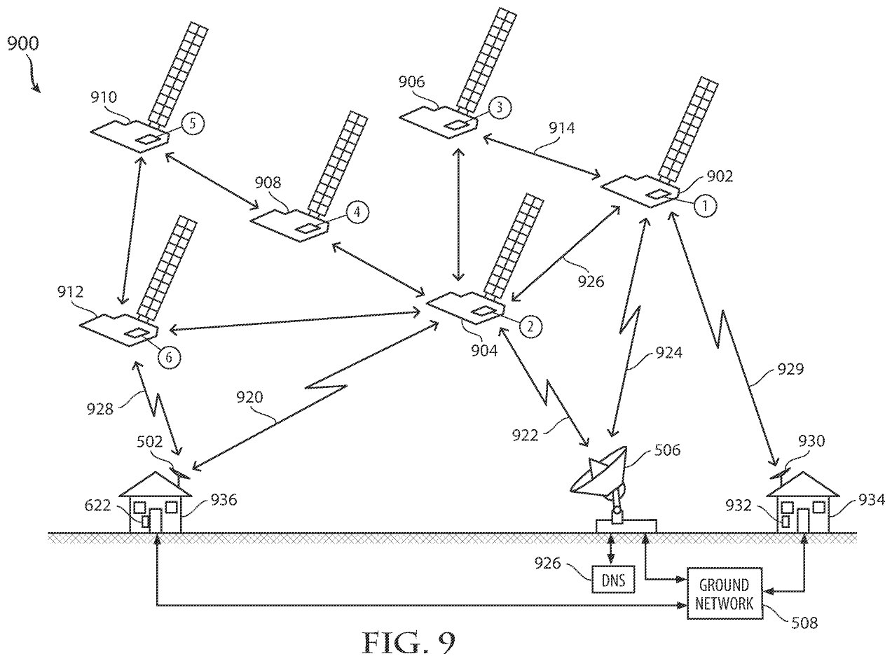

In one example, as shown in FIG. 1B and FIG. 9, the process can be performed by a group of satellites 900 and/or a SatOps service 130. A group of satellites can be configured to perform the following operations: receiving, at one or more satellite of the group of satellites, data associated with the group of satellites, wherein the data includes one or more of an energy balance associated with the group of satellites, a transient hardware temperature associated with the group of satellites, a reset or reboot event(s) associated with the group of satellites, scheduled workload on one or more satellites, and orbital data associated with the group of satellites. The operations can include, based on the data, configuring an availability of compute resources across the group of satellites to yield dynamically available compute resources, receiving, at one or more satellite of the group of satellites, a request from a user terminal for compute resources to yield requested compute resources and providing, from the group of satellites and for the user terminal, access to the dynamically available compute resources based on the requested compute resources.

A reboot can occur based on hardware responses to radiation. For example, hardware may have to reboot due to radiation exposure in space. There can be radiation-induced outages or failures of a satellite 504. The failure may be permanent or may be temporarily and the satellite may need to reboot according to its reactive logic. These failures, predicted failures, and the temporal nature of these failures and whether the satellite 5045 can recover are taken into account by the intelligence built into the control on the satellite or the ground-based load balancing module 130. The load balancing module 130 can make clustering, steering and routing decisions to service requests for compute resources. Further, how the satellites 504 might be clustered together for a period of time and for how long can take this data into account.

FIG. 7C illustrates an example method 720 focusing on dynamic or static clustering of satellites in accordance with examples of the present disclosure. The method 720 includes receiving, at a satellite as part of a group of satellites, data associated with the group of satellites, wherein the data is associated with movement of the group of satellites according to a respective orbit of each satellite of the group of satellites (722), based on the data, clustering two or more satellites of the group of satellites that can provide cloud-computing operations to user terminals to yield a cluster of satellites (724), receiving, at a satellite associated with the cluster of satellites, a request from a user terminal for compute resource to yield a requested compute resource (726) and providing, from the cluster of satellites and for the user terminal, access to the compute resources based on the requested compute resources (728). The method can include the cluster of satellites being a dynamic cluster that adjusts over time amongst the group of satellites or a static configuration of the same subgroup or cluster of satellites as the group of satellites orbit the Earth.

The clustering can occur before or after the request for compute resources. In one example, the cluster can be managed by a load balancing module 130 that uses the topology information to cluster satellites across a given geographic area and for a period of time. This can mean providing for example a large cluster of say twelve satellites as they cross an area with many subscribers who typically access cloud-services. The cluster would be in place for a period of time such as, for example, ten to fifteen minutes.

In another aspect, the cluster might be organized on a dynamic based on one or more requests. For example, if one or more user terminals requests a particular compute resource, then the cluster can be organized and linked wirelessly through, for example, laser communication between the chosen satellites, and then provide the requested compute resource. After the use of the compute resource, then the cluster can be disbanded in this aspect. Provisioning of data, operating systems and/or applications or software can be part of the clustering process and the de-clustering process of disbanding the cluster of satellites.

The above method is useful in a scenario where a group of satellites 900 as shown in FIG. 9 is moving across the sky and access to a portion of the satellites for receiving or accessing cloud-services is changing and dynamic. The method can be practiced by a group of satellites 900 and/or a SatOps service 130 or similar service. For example, a group of satellites can be configured to perform the following operations: receiving data associated with the group of satellites, wherein the data is associated with movement of the group of satellites according to a respective orbit of each satellite of the group of satellites and based on the data, clustering two or more satellites of the group of satellites that can provide cloud-computing operations to user terminals to yield a cluster of satellites.

The operations can further include receiving, at a satellite associated with the cluster of satellites, a request from a user terminal for compute resource to yield a requested compute resource and providing, from the cluster of satellites and for the user terminal, access to the compute resources based on the requested compute resources.

When cluster of satellites is a dynamic cluster that adjusts over time amongst the group of satellites as the group of satellites orbit the Earth, another aspect of this approach is a “handoff” from one cluster of satellites to another. Assume a cluster of satellites, say six satellites, is offering a cloud-service to a user terminal 502. The moving satellites offer the service to a particular user terminal 502 for typically ten to fifteen minutes. The direct communication with the user terminal 502 might change from one satellite of the six to another satellite of the six as they orbit the earth over the user terminal 502. The six satellites can be configured to communicate via a high-speed communication protocol or hardware such as using lasers to communicate one with another.

Throughout providing the cloud-service to the user terminal 502, the user terminal may communicate with different respective satellites of the six satellites over time. However, at some point, all six satellites will no longer be able to communicate with the user terminal 502. In this scenario, a “handoff” can occur in a number of different ways.

For example, the handoff may involve a completely new set of six satellites that receive state data associated with the state of providing the cloud-service from at least one satellite of the original cluster of six satellites. The processing of the data or providing the service can be transferred from the original cluster to a secondary cluster of satellites to continue offering the service. In this manner, if a movie is in the middle of being streamed to the user, or a weather analysis is only partly completed, or a stock trading session by the user is still in process, then the state of the project can be transitioned to a new cluster to continue providing the cloud-service. The transition can be transparent to the user or the user may get some notice of the changeover.

In another aspect, the transition to anew cluster can be overlapping in nature. In this aspect, the original six satellites in a cluster could be adjusted such that as they move across the sky, the system reorganizes the cluster such that satellites four to six of the original cluster of six are now arranged as the first three satellites of a new cluster having seven satellites. In this manner, for a next period of time (say, for example, ten minutes), the new cluster of seven satellites provides the cloud-service and there is some overlap from a previous cluster to a new cluster. This could be characterized as a partial handover as some satellites are removed from the cluster and other satellites are added to the cluster but there is always some overlap.

The decision of whether to provide a completely new cluster or perform a partial handover can be based on any factors disclosed herein. For example, issues like an energy balance, thermal cycles as a satellite moves in and out of a view of the sun, reset or reboot issues, or any other orbital concerns or condition can be used by the system such as the load balancing module 130 to determine which type of handoff to perform. Any one or more factor such as the type of cloud-service, quality of service factors, guarantees to users via service level agreements, a priority of users, bandwidth or computer processing power, and other issues with respective to load balancing of workload on individual satellites as well can be used to determine what kind of handoff to perform. For example, if an entirely new cluster handoff would impose a large workload on the new cluster in that it is already at capacity in terms of processing power used, or how much data is being streamed to user terminals, or has a high thermal load, then a partial handoff may be implemented by the system to give the satellites in the new cluster time to complete their workload, cool down, power up, or take some other step which might be helpful to better position them for the delivery of the cloud-service associated with the new cluster.

The topology service 132 as part of a load balancing module 130 can provide a schedule in advance which can identify which satellite or cluster of satellites a particular user terminal 502 should connect with. For example, the topology service 132 can provide for a period of time such as two minutes, five minutes or ten minutes what the expected or scheduled satellite or cluster of satellites that one or more user terminals 502 should use. The topology service 132 can utilize in one example which user terminals 502 are utilizing cloud-services and at what state the cloud-service usage is in and can take that information into account when it schedules the set of satellites for connecting with the user terminals 502 for a period of time. The schedule may be for a group of user terminals 502 in a cell as is shown in FIG. 4 or where cloud-services are being accessed by one or more user terminals 502, the schedule may be more dynamic where the one or more user terminals in a cell may be given a different schedule (so that they can connect to the cluster of satellites configured to enable the cloud-service) than other user terminals 502 in the cell that may be simply accessing the Internet or other non-cloud-service applications. The topology service 132 can utilize the information it receives about the use of cloud-services, such as one or more of which satellites have the capability and the availability as well as the other factors such as quality of service, orbit or movement of the satellites, state of the use of the cloud-service and so forth to generate a schedule that includes the continuation of or availability of particular cloud-services. In one aspect, the timing or period of a particular schedule may be adjusted when cloud-services are included in that there may need to be a more dynamic update to the cluster of satellites that provide the cloud-service. The topology service 132 may also include the ability to schedule in a hybrid approach where a scheduled cluster of satellites for a new time period includes some existing satellites in a cluster plus some new satellites to make up the new cluster.

In one embodiment, a group of satellites can provide cloud-services in which one or more of the group of satellites includes a processor, a memory storing computing instructions and a communication component to enable communication with a user terminal and another communication component to enable communication with other satellites as well as a gateway. The group of satellites can perform operations including receiving data associated with the group of satellites, wherein the data is associated with movement of the group of satellites according to a respective orbit of each satellite of the group of satellites and, based on the data, clustering two or more satellites of the group of satellites that can provide cloud-computing operations to user terminals to yield a cluster of satellites. The operations can include receiving a request from a user terminal for compute resource to yield a requested compute resource and providing, from the cluster of satellites and for the user terminal, access to the compute resources based on the requested compute resources.

Clustering decisions can also take into account distance between satellites in a cluster. As the satellites all orbit the Earth, there are times where two respective satellites might be closer together at one time and farther away from each other at other times. This data can be provided by the topology service 132 and taken into account by a load balancing module 130 with respect to how to cluster satellites for providing cloud-services or compute resources. For example, when a request for compute resources is received, the load balancing module 130 (or a component on a satellite that has topology information), can dynamically cluster two or more satellites to enable the delivery of the requested resource. One satellite might have needed data and another satellite might have available computer processors for processing the data. The clustered satellites might be determined to be close enough for being clustered and have the appropriate thermal or reboot/reset condition as well. The clustering approach can be for a particular request for compute resources and can be removed after the job is complete or the clustering might be for a given period of time.

In one aspect, the idea of clustering can be dynamic in that it occurs based on the request for compute resources. The method can include receiving, at a satellite control system on a satellite, a request from a user terminal for compute resources, requesting, from an entity computing environment configured on the satellite, the compute resources and clustering, based on the request, two or more satellites based on one or more of a thermal condition, a reboot or reset event, movement of a group of satellites including the satellite, a proximity of one or more satellites to the user terminal, or a schedule of future positions of the group of satellites to yield a cluster of satellites. Once the cluster is established after receiving the request, the method can include receiving, from the computing environment configured on one or more of the cluster of satellites, data associated with the compute resources or access to the compute resources and transmitting the data associated with the compute resources to the user terminal.

FIG. 7D illustrates an example method 730 focusing on constellation-specific steering and routing strategies in accordance with examples of the present disclosure. The method 730 includes one or more of receiving, in connection with a group of satellites, data associated with the group of satellites, wherein the data is associated with movement of the group of satellites according to a respective orbit of each satellite of the group of satellites (732), based on the data, linking two or more satellites of the group of satellites into a constellation of satellites that can provide cloud-computing operations to user terminals (734), receiving, at a satellite associated with the constellation of satellites, a request from a user terminal for compute resource to yield a requested compute resource (736), based on the request and the constellation of satellites, routing the request to one or more satellites of the constellation of satellites to provide the compute resources to the user terminal (738) and providing, from the one or more satellites of the constellation of satellites and to the user terminal, access to the compute resources (740). The method can include the constellation of satellites being a dynamic constellation of satellites that adjusts over time amongst the group of satellites or a static constellation of satellites as the group of satellites orbit the Earth.

In one embodiment, a group of satellites can provide cloud-services in which one or more satellite of the group of satellites includes a processor, a memory storing computing instructions and a communication component to enable communication with a user terminal and another communication component to enable communication with other satellites as well as a gateway. The group of satellites can perform operations including receiving, in connection with the group of satellites, data, wherein the data is associated with movement of the group of satellites according to a respective orbit of each satellite of the group of satellites and, based on the data, linking two or more satellites of the group of satellites into a constellation of satellites that can provide cloud-computing operations to users. The operations can further include receiving a request from a user terminal for compute resource to yield a requested compute resource and, based on the request and the constellation of satellites, routing the request to one or more satellites of the constellation of satellites to provide the compute resources to the user terminal. The operations can include providing, from the one or more satellites of the constellation of satellites and to the user terminal, access to the compute resources. The steps outlined herein can be practiced via any number of hardware configurations. For example, one or more satellites of a group of satellites 900 can perform the operations. Some steps can be performed by ground based-systems accessible via a gateway 504 by one or more satellites, or the steps may occur in a combination of different hardware components. Examples of this disclosure can include any one hardware component configured on Earth or in orbit and can include multiple different components each performing a step or part of a step claimed. This can also include user terminals 502 or associated hardware components performs steps as well.

FIG. 7E illustrates another method 750 that relates to the type of parameters and data used to route a request to which satellites or satellites. The method can relate to the use of the compute resource entity 138 from one entity that is provided to a load balancing module 130 which can take into account a changing satellite topology to make routing decisions. The method 750 includes receiving compute resource data associated with a state of compute resources operated by an entity on one or more satellites (752), receiving, from a user terminal, a request for compute resources at a satellite of a group of satellites (754), determining satellite data including one or more of a topology of the group of satellites, a distance between two given satellites of the group of satellites, a proximity of one or more satellites of the group of satellites to the user terminal, a thermal condition of at least some of the group of satellites, a reset or reboot event(s) of at least some of the group of satellites and an energy condition of at least some of the group of satellite (756) and based on the compute resource data and the satellite data, routing the request to at least one chosen satellite to make accessible the compute resources to the user terminal (758).

The compute resource can be data such as a streaming video or cloud-services such as an application or function as a service. Routing the request to at least one chosen satellite to make accessible the compute resources to the user terminal can be managed on one or more satellites or via a load balancing module 130 operating on the ground.

A clustering of satellites can occur based on the request for compute resources or can be provided for a period of time based on other factors and independent of any one or more requests for compute resources.

FIG. 7F illustrates another method 760 that relates to the interaction between the SatOps services 130 and the compute resource entity 138 which is typically a third-party entity that operates one or more compute environments on the satellites 102 but does not manage the satellites 102. The method 760 includes transmitting satellite data to a compute resource entity operating a compute environment on one or more satellites of a group of satellites (762), transmitting a request for compute resources from a user terminal to the compute resource entity (764), receiving, from the compute resource entity, information related to a routing decision to route the request from the user terminal to one or more chosen satellites (766), making the routing decision based on the satellite data and the information (768) and routing the request to the one or more chosen satellites based on the routing decision to provide access for the user terminal to the compute resources (770). The method may also include the compute resource entity 138 authorizing access to the compute resources for users having an account with the compute resource entity 138. Therefore, the method 760 can include authorization processes. In general, each compute resource entity 138 can have a secure entity computing environment which does not enable other entities access to the respective entity's computing environment. These environments are shown by way of example as features 614, 606 in FIG. 6.

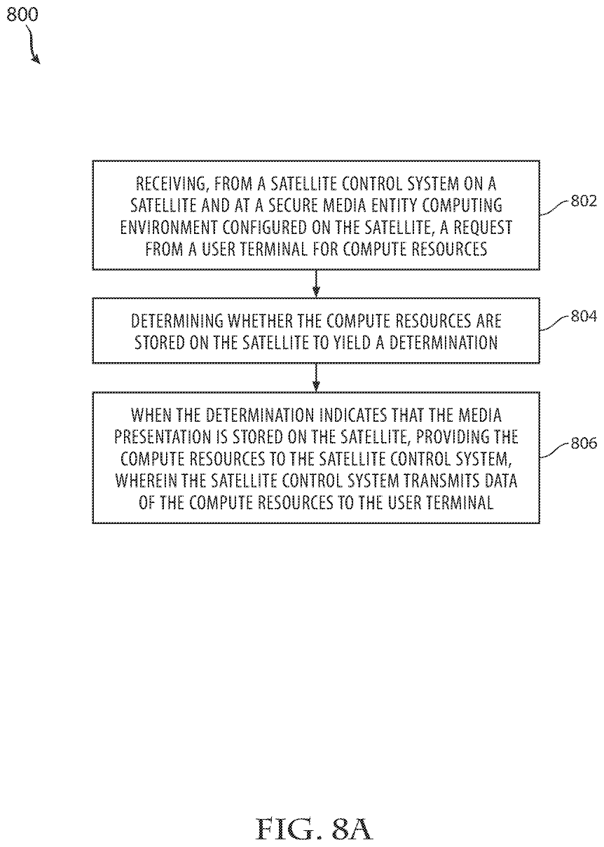

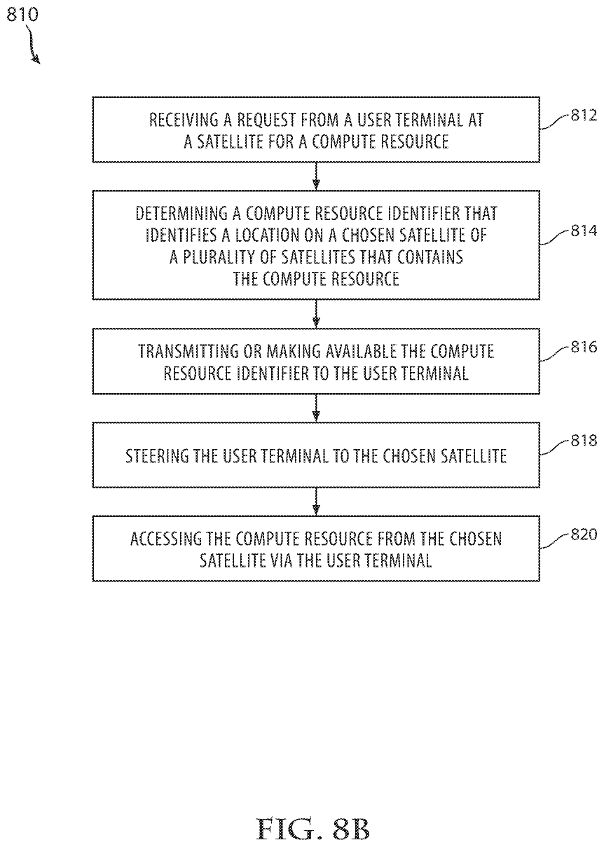

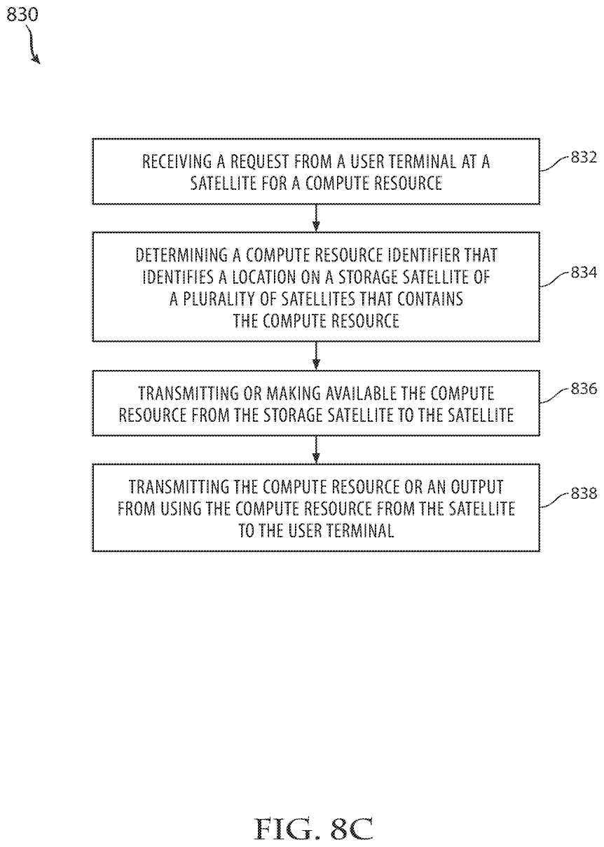

FIG. 8A illustrates another method 800 from the standpoint of an entity computing environment 606, 614. The method 800 can include receiving, from a satellite control system 604 on a satellite 504 and at an entity computing environment 606, 614 configured on the satellite 504 (which can be a media entity or can provide any compute resource or cloud-computing service), a request from a user terminal 502 for compute resources (802), determining whether the compute resources are stored or available on the satellite 504 to yield a determination (804) and, when the determination indicates that the compute resources are stored on the satellite 504, providing the compute resources to the satellite control system 604, wherein the satellite control system 504 transmits data associated with the compute resources to the user terminal 502 (806). As noted above, the request can encompass any compute resource such as processing power, access to a machine-learning model, bandwidth, endpoint-to-endpoint communication channels, access to a stock trading platform at a certain low latency, any cloud-services and so forth. In this regard, the framework described herein enables any entity who desires to provide compute resources in the form of data (media programs for example), or an algorithm or functions, or access to an application such as speech processing technology, can provide those resources to one or more satellites and make them available to users. The satellite topology, since it is dynamic as satellites are moving, adds an additional parameter that the system has to track when making clustering decisions. Issues related to the use of satellites (thermal issues, energy issues, positional issues, reboot/reset issues, etc.) will come into play when organizing a cluster of satellites to provide compute resources to user terminals 502 for a period of time.

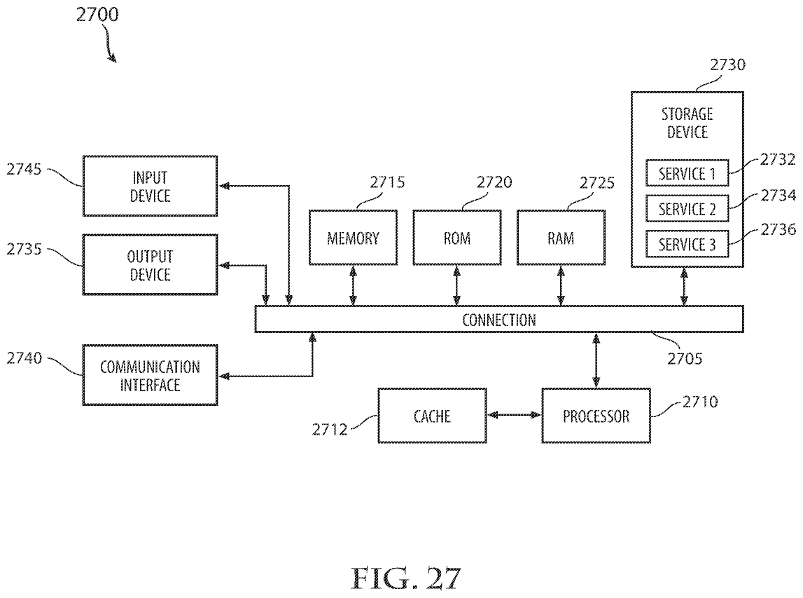

As noted above, the entity (1) or entity (2) can provide media as one example to user terminals 502. A satellite 504 can include a satellite control system 604, a transmission (Tx) antenna 602A and a receive (Rx) antenna 602B connected to the satellite control system 604, a memory device (shown in FIG. 27), and an entity computing environment 606, 614 configured on the satellite 504. The entity computing environment 606, 614 can be separate from the satellite control system 604 and a plurality of videos can be stored in the memory device 607, 615 as part of the entity computing environment 606, 614. When a user terminal 502 requests via the satellite control system 604 a video or data, the entity computing environment 606, 614 retrieves, if available, the data from the plurality of data or videos stored in the memory device 607, 615 and provides the data to the satellite control system 604 for transmission via the Tx antenna 602A to the user terminal 502 and thus to the user device 622 for viewing or using the data. Again, the concepts above further apply to any compute resource beyond provide access to data such as a video.

The entity computing environment 606, 614 further can include an access and control module 610, 618 for managing user access to the plurality of media presentations. The entity computing environment 606, 614 further can include an optional user interface module 612, 620 for providing to the satellite control system 604 a user interface for transmission to the user terminal 502. In some cases, the user interface will not change and the routing to a chosen satellite to provide the compute resources is performed independent of any change or special user interface.

The satellite 504 further can include a plurality of entity computing environments 606, 614, each respective entity computing environment of the plurality of entity computing environments 606, 614 being separate from the satellite control system 604 and other entity computing environments. This describes a multi-tenant scenario where separate compute resource entities operate different computing environments 606, 614 independent of one another.

When the user terminal 502 requests via the satellite control system 604 the compute resources, the satellite control system 604 can determine that the entity computing environment 606, 614 is a chosen entity computing environment from a plurality of entity computing environments configured on the satellite 504. A user account associated with the entity computing environment 606, 614 can be used to determine that the entity computing environment is the chosen entity computing environment from the plurality of entity computing environments configured on the satellite 504 to which the user has an account and thus access to compute resources. Access control 618, 610 can also occur or be managed by the compute resource entity 138 as well.

When the video, data or compute resource is not available on the memory device 607, 615, then the entity computing environment 606, 614 can obtain the video or data or compute resource from one of another entity computing environment on the satellite 504, a ground network 508 via a gateway 506, or another satellite 624. The satellite 504 can also include a battery 628 and a solar panel 629 and a management module 630 which can also represent a power converter and which can manage power usage amongst components, workload management and/or container orchestration for the various entity computing environments 606, 614.

Another aspect of this disclosure relates to how the system can direct or steer a user terminal 502 to the correct satellite 504/624 that provides a compute resource. In this aspect, the system could use some type of resolution or feedback in order to making steering decisions or instructions for user terminals 502 to communicate with the proper satellite. For example, in the standard Internet service, a Domain Name Server (DNS) will resolve or translate a universal resource locator (website name) to a translated IP address and thus route the request to the proper server. In the satellite context, a user terminal 502 may make a request for a certain compute resource and the request might be received at a satellite 504. The satellite 504 can have information regarding the location of the compute resource that will need to be accessed to respond to the request from the user terminal 502. The information can be an Internet Protocol (IP) address of a server operating in the satellite 504 or operating on a second satellite 624. The satellite 504 can receive the compute resource or data confirming that the compute resource is available on the second satellite 624 from the second satellite 624 via, for example, an inter-satellite laser communication. The compute resource may also have to be provisioned or a cluster of satellites might have to be configured dynamically to provide the requested compute resources.

The satellite 504 can transmit an instruction to the user terminal 502 to steer to the second satellite 624 and initiate communication with the second satellite 624. The instruction can include the IP address (or other compute resource identifier) of the server on the second satellite 624 and thus the satellite 624 to which the user terminal 502 needs to steer. In this context, the compute resource identifier can be an IP address of a server, or an identification of an application, a satellite identifier, hardware, compute resources, data, and so forth. In another aspect, the IP address can be provided or identified in a refined protocol which relates to or maps a traditional IP address to a satellite IP address which can include within the protocol identifying information for the second satellite 624 as well as other protocol structures which can be used to identify the server operating on the second satellite 624.

The satellite 504 can store data regarding which satellites store which applications or data as part of the network of satellites 504, 624. Thus, the method can include receiving, from a user terminal 502, a request for compute resources at first satellite 504 and determining, based on the request, that the compute resources to respond to the request are on a second satellite 624. If so, then the method would include instructing the user terminal 502 to steer to the second satellite 624 in order to obtain the compute resources. As an alternative, as the constellation of satellites 504, 624 can be configured as a distributed file system, the method can include retrieving from the second satellite 624 and at the first satellite 504, the proper data via a broadband communication link (such as a laser communication link) and downloading the data from the first satellite 504 to the user terminal 502. In this regard, the approach would emulate static terrestrial services for content or other compute resources.

FIG. 8B illustrates generally a method example of the approach discussed above. A method 810 can include receiving a request from a user terminal at a satellite for a compute resource (812), determining a compute resource identifier that identifies a location on a chosen satellite of a plurality of satellites that contains the compute resource (814), transmitting the compute resource identifier to the user terminal (816) and steering the user terminal to the chosen satellite (818). The method can include further accessing the compute resource from the chosen satellite via the user terminal (820).

In one aspect, the entity operating the compute resource such as a media streaming company or other type of company might not want or need to inform the satellite company that deploys the satellites where a particular compute resource is. For example, a media streaming company might distribute movies across multiple different satellites 504, 624 and not necessarily inform the satellite company of which movies are on which satellites. The satellite company 138 may only know that the media streaming service is available on a set of one hundred satellites but not know (or desire to know) the granularity of which shows are on which satellites. In this regard, the method may include accessing a DNS server (which can be operated by the media streaming company) or other entity that provide the compute resource identifier to the satellite so that the chosen satellite can be identified and the user terminal 502 can steer to the proper satellite. The satellite company can coordinate the exchange of data to enable the proper steering of the user terminal 502 to the appropriate satellite to access the compute resource without knowing what exactly the compute resource is. Obtaining the compute resource identifier may involve the satellite 504 communicating with the gateway 506 to retrieve the compute resource identifier from a server or computer operated by the company providing the compute resources.

FIG. 9 shows a satellite or satellites 900 that can be configured to perform operations including receiving a request from a user terminal for a compute resource, determining a compute resource identifier that identifies a location on a chosen satellite of a plurality of satellites that includes the compute resource, transmitting the compute resource identifier to the user terminal and steering the user terminal to the chosen satellite. In this manner, the user terminal can access the compute resource from the chosen satellite. The chosen satellite can be part of a dynamic cluster or constellation of satellites 900 that is changing periodically based on movement of the satellites and other factors such as transient hardware temperatures relevant to space that are not experienced on Earth, energy balancing, reboot/reset issues, respective satellite capability with respect to the requested compute resources such as whether a particular satellite has the data requested, or the software application that is desired or whether a computer processor is available for use as a compute resource.

FIG. 8C illustrates another aspect of this disclosure in which the user terminal 502 does not steer to a new satellite but where the compute resource is retrieved from another satellite and then transmitted or made available to the user terminal 502. In this regard, a method 830 includes receiving a request from a user terminal at a satellite for a compute resource (832), determining a compute resource identifier that identifies a location on a storage satellite of a plurality of satellites that contains the compute resource (834), transmitting or making available the compute resource from the storage satellite to the satellite (836), and transmitting the compute resource or results from use of the compute resource from the satellite to the user terminal (838). The storage satellite can transmit the compute resource via a laser or other wireless communication protocol and communication hardware components.

As noted above, the satellite might not have the compute resource requested and it may need to communicate or identify a storage satellite that has the compute resource. The computer resource as explained herein can be data, an application, a cloud-service, a platform, bandwidth, endpoint-to-endpoint communication services, and/or computer processor usage. Thus, use of the compute resource might be streaming data to the user terminal 502 such as to enable the user to watch a movie, or it might mean providing an application or platform such as a cryptocurrency trading platform. In this manner, the satellites can coordinate amongst themselves or as instructed by a load balancing module 130 such that the user terminal (and the ultimate human user requesting the compute resources), in a transparent way, can access the storage satellite having the compute resources.

One embodiment can be from the standpoint of a group of satellites. In this regard, a first satellite of the group of satellites can perform operations including receiving a request from a user terminal for a compute resource and the first satellite or another satellite or ground-based system can determine a compute resource identifier that identifies a location on a second satellite that contains the compute resource. The second satellite can communicate with the first satellite and transmit or making available the compute resource from the second satellite to the first satellite and the first satellite can transmit the compute resource or results from use of the compute resource from the first satellite to the user terminal.

In another aspect, FIG. 9 illustrates a group of satellites 900 which can be used to illustrate a distributed compute resource. For example, an entity can distribute a first portion of its content or compute resources on a first satellite 902, a second portion of its content or compute resources on a second satellite 904, a third portion of its content or compute resources on a third satellite 906, a fourth portion of its content or compute resources on a fourth satellite 908, a fifth portion of its content or compute resources on a fifth satellite 910 and a sixth portion of its content or compute resources on a sixth satellite 912. The satellites can communicate with each other via a laser 914, 916 to transmit data between the satellites. Where the compute resource is data, the idea is that the data is persistent or stored in memory or in a cache on the respective satellite and not transitory in nature such as where the satellite would simply be temporarily retrieving data from the gateway 506 and passing the data down to the user terminal 502 as would currently occur. The compute resource might also be other forms of cloud-services such as machine-learning models or access to a certain number of processors for a reserved period of time. Such compute resources can also be distributed across multiple satellites 900.

The compute resources that are distributed across a mesh network of satellites 900 can be any compute resource as disclosed herein or other compute resources that can be accessed. In some cases, where the compute resource is for example computer processors and memory, such a compute resource cannot be transmitted from satellite to satellite as data can, and so the process of providing the compute resource to the user terminal might vary depending on the type of compute resource that is requested.

With the infrastructure disclosed herein, many different types of compute resources can be provided to users. For example, a machine learning or artificial intelligence algorithm could be trained to make some kind of a recommendation to a user or provide a predicted outcome based on some data. Artificial intelligence or machine learning algorithms generally are models built on training data and seek to make predictions or decisions without being explicitly programmed to provide a specific output. Machine learning models can be used in a variety of contexts such as speech processing, medical diagnostics, email filtering, advertising recommendations, computer vision, or many other tasks. The models that are contemplated herein include any models such as artificial neural networks, decision trees, support-vector machines, regression analysis, Bayesian networks, genetic algorithms, and/or federated learning algorithms.

The trained model might require a lot of computational power to receive data and generate the output or the recommendation. There are many different types of models and the context of this disclosure can encompass any such model. Speech recognition or spoken language understanding models are exemplary but other models can apply. In this case, the model(s) could be uploaded as compute resources onto one or more satellites. When a user of a user device 622 accesses a satellite through the user terminal 502, the need or context might be for speech recognition and/or spoken language understanding model compute resources. Assume satellite 504 is communicating 520 with the user terminal 502 and the user provides speech (audio waveforms) through a microphone on their computing device 622. The user might be in a document and seeking speech recognition for dictation or the audio waveform might be in a video or a recording of a conversation and user may seek the speech recognition and/or spoken language understanding models to process the data. The data transmitted to the satellite 504 can include the raw data and meta data indicating the desired compute resources.

Assume in this case that the speech recognition models are configured on satellite 910 and the spoken language understanding models are configured on satellite 906. A routing table or data on the satellite 904 can cause it to communicate via a communication channel such as a laser the necessary instructions and data (raw data) to the respective satellites such that the speech recognition is performed at satellite 910 and the spoken language understanding is processed at satellite 906. Those two satellites might even exchange data through a communication link as part of the process. The results can then be returned to the satellite 904 communicating 920 with the user terminal 502, for transmission to the user terminal 502.

An alternate approach is that the satellite 904 can provide the user terminal 502 with data regarding where to steer its signal to the proper satellite in the group of satellites 900 that has the requested compute resource, if it is possible for the user terminal to access that satellite. The user terminal might be steered to a series of or cluster of satellites to accomplish a larger task if multiple satellites have the necessary compute resources to accomplish a multi-step task. The load balancing module 130 can organize the cluster of satellites for this purpose. In another aspect, such as a highly complex machine learning model, a group of satellites might run the model in a distributed manner and the user terminal 502 might be directed to one of the group of communication with and the communicating satellite can coordinate the exchange of data between the group that is going to run the model on the user data.

FIG. 9 also illustrates how a compute resource such as an endpoint-to-endpoint communication channel can be accessed. In this case, assume that one user terminal 502 is in Los Angeles and is positioned with a building 936 and the user desires to perform a stock trade in the London stock exchange which is represented by building 934 with a user terminal 930 and other applications or devices 932 at that location. In this example, low latency communication is desired because the timing of such trades can impact income. The standard Internet connection may have a certain amount of latency which may not be desirable for such a high-speed trading application. Rather than using the standard internet to transmit a requested trade from the building 936 to the London Stock exchange 934, the user might be granted access to a low latency communication channel which may include a first branch 920 from the user terminal 502 to a first satellite 904, and then through a second branch 926 to a second satellite 902 and then through a third branch 928 from the satellite 902 to the user terminal 930. Laser communication may be utilized for the one or more branches between respective pairs of satellites. Other branches may be used as well depending on the topology of the satellites and their capabilities for high-speed laser communication.

When endpoint-to-endpoint services are provided, an identification of the endpoints is typically received so that the satellites can utilize the topology data to configure a communication channel between the endpoints. The identification can relate to data associated with user terminals on either side of the channel or based on the computing devices having Internet Protocol (IP) addresses. In one example, the endpoints can be computers with traditional IP addresses that are used to identify the endpoint devices. A high-speed communication channel can be established from a first endpoint (e.g., computer 622 in a home 936), though a first user terminal 502, to a first satellite 904 and then either to a second user terminal 930 or a second or more satellite 902 (via a laser connection 926) to the second user terminal 930 via a communication channel 929 and finally a second endpoint 932 which can be another computer with an IP address. This path can have less latency than a channel 922 between the first satellite 904 and the gateway 506. The final branch in this scenario is transmitting the data through the ground network 5098 to the second endpoint 932, which can introduce more latency. The ground stations that communication with one or more satellites can be user terminals or gateways or other devices that are capable of communication with a satellite such as a mobile device.

Granting access to the use of the laser communication channel for transmitting data can occur dynamically such as via a request for some kind of transaction. The satellite 904 might receive the trade request with metadata or an indicator that it must be transmitted through the constellation of satellites 900. The use of the endpoint-to-endpoint communication channel might also be scheduled in advance. For example, a user might schedule the communication channel at the beginning of a trading day and use the channel for one hour. The scheduling can occur via a user interface or application associated with the stock trading platform or via a third party.

In one aspect, platforms such as trading platforms, sports or video streaming platforms, a cloud-service, video-conferencing platform or any application that might benefit from low latency communications with their customers can integrate a satellite endpoint-to-endpoint option for accessing their platform. Thus, as users interact with a graphical user interface, and initiate the use of an application, there may be a default option or a selectable option to communicate with the application via a satellite endpoint-to-endpoint communication channel which is generally offered as a “compute resource” to the user.

In another example, a platform such as a stock trading platform, can contract with a satellite company to offer a high-speed communication channel to their customers. The customers may also contract to obtain this service. A user with an account on a particular platform such as a stock-trading platform may be in Los Angeles and log into their account for the London Stock exchange. The user interface may be modified for the user based on an account profile or by default to include a selectable object which can confirm a request for a high-speed communication channel. The initial communication channel to access the website might be a standard Internet communication channel. However, if the user selects the high-speed communication channel, the routing of the packets can be adjusted or steered through the mesh of satellites to reduce the latency to perform the particular functions that require a faster connection. A channel monitoring service may also ensure that between the standard Internet channel and the satellites mesh, the fastest communication path (or a sufficiently fast communication path) is selected. The satellite infrastructure can receive the Internet Protocol (IP) addresses or other identifier of the respective endpoints and configure through the known topology of the group of satellites what the path should be through one or more satellites to provide a communication channel that has less latency than a standard Internet connection.

In one example, a system can include a first satellite 904 configured with a first laser communication device and a second satellite configured 902 with a second laser communication device. The first satellite 904 and the second satellite 902 are configured to receive, from a first user terminal 502 and at the first satellite 904, a request for an endpoint-to-endpoint communication channel and identify the second satellite 902 as a link to provide the endpoint-to-endpoint communication channel. The first satellite 904 establishes a laser connection with the second satellite 902 and receives data from the first user terminal 502. The first satellite 904 transmits the data 926 to the second satellite 902 through the laser connection 926 and the second satellite 902 transmits the data 920 to a second user terminal 930.

A method in this regard can include receiving from a first user terminal 802 and at the first satellite 904, a request for an endpoint-to-endpoint communication channel and identifying a second satellite 902 as a link to provide the endpoint-to-endpoint communication channel. The method can include the first satellite 904 establishing a laser connection with the second satellite 902 and receiving data from the first user terminal 502. The method can further include the first satellite 904 transmitting the data 926 to the second satellite 902 through the laser connection 926 and the second satellite 902 transmitting the data 920 to a second user terminal 930.

The endpoint-to-endpoint services might be provided by a system including just one satellite. In this example, a satellite 904 can include a laser communication device and be configured to receive, at the satellite 904 from a first ground station 502, a request for an endpoint-to-endpoint communication channel, receive, at the satellite 904, data from the first ground station 502 and transmit the data received from the first ground station 502 at the satellite to a second ground station 506 as part of the endpoint-to-endpoint communication channel. The ground station in this case at either end of the endpoint-to-endpoint communication channel can be a user terminal 502, 930 or a gateway 506. The first ground station can therefore be a first user terminal or a first gateway and the second ground station can be a second user terminal or a second gateway.

Another system can include two or more satellites that are used to establish the endpoint-to-endpoint communication channel. The system can include a first satellite 904 configured with a first laser communication device and one or more additional satellite 902 each configured with a respective second laser communication device. The first satellite 904 and the one or more additional satellite 902 can be configured to: receive, at the first satellite 904 from a first ground station 502, a request for an endpoint-to-endpoint communication channel, identify the one or more additional satellite 902 as a link to provide the endpoint-to-endpoint communication channel, establish a laser connection 926 between the first satellite 904 and the one or more additional satellite 902, wherein when there are three or more satellites in the endpoint-to-endpoint communication channel, a respective laser connection is established between each respective pair of satellites in the endpoint-to-endpoint communication channel, receive, at the first satellite 904, data from the first ground station 502, transmit the data from the first satellite 904 to the one or more additional satellite 902 through the laser connection 926 and transmit the data from the one or more additional satellite 902 to a second ground station 506. Again, the ground stations can be user terminals 502, 930 or gateways 506 as well.

A method of providing an endpoint-to-endpoint communication channel via a single satellite 904 can include receiving, at a satellite 904 from a first ground station 502, a request for an endpoint-to-endpoint communication channel, receiving, at the satellite 904, data from the first ground station 502 and transmitting the data received from the first ground station 502 at the satellite 904 to a second ground station 506 as part of the endpoint-to-endpoint communication channel.

A method with respect to using two or more satellites to establish an endpoint-to-endpoint communication channel can include receiving, at a first satellite 912 from a first ground 502, a request for an endpoint-to-endpoint communication channel, identifying one or more additional satellite 904, 902 to provide the endpoint-to-endpoint communication channel, establishing a laser connection between the first satellite 912 and the one or more additional satellite 904, 902, wherein when there are three or more satellites in the endpoint-to-endpoint communication channel, a respective laser connection is established between each respective pair of satellites in the endpoint-to-endpoint communication channel, receiving, at the first satellite 912, data from the first ground station 502, transmitting the data from the first satellite 912 to the one or more additional satellite 904, 902 through the laser connection and transmitting the data from one of the one or more additional satellite 902 to a second ground station 506.

In another example, there may not be a communication link in the ground between the user device 622 and the ground network 508. This can occur when the only access to the ground network 508 is through one or more of the satellites 912, 904. However, when there is a connection such as a standard Internet connection, one aspect of this disclosure can include, for example, performing an evaluation of an expected latency when communicating from the user device 622 to a network server via the ground network 508 relative to potentially accessing the network server via an endpoint-to-endpoint communication channel via one or more satellites. When low latency is desired and can be achieved using a selected communication channel such as using the satellites network, then the routing of the communication can be through the lower latency channel and thus provide improved service to the user.

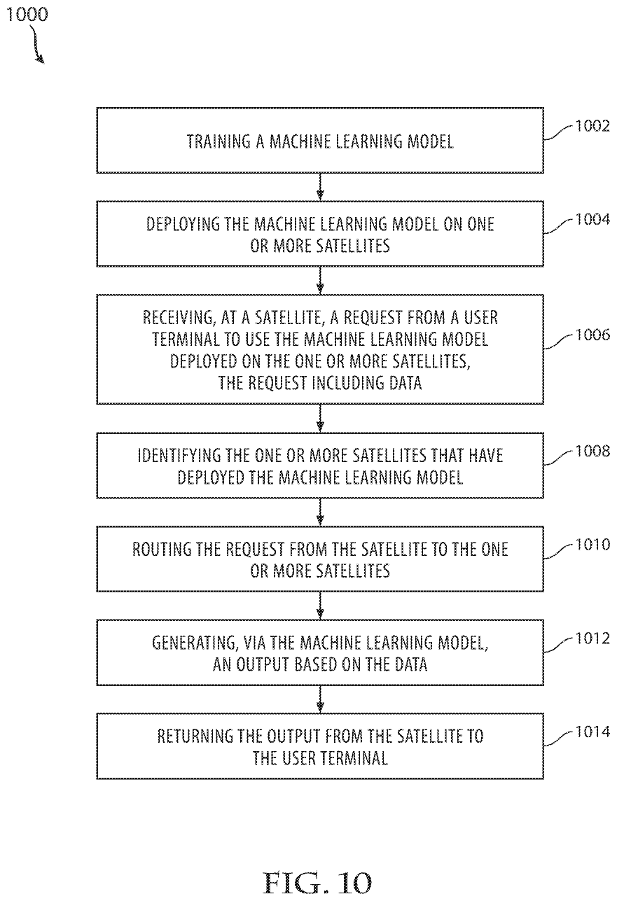

FIG. 10 illustrates an example method 1000 with respect to machine learning or artificial intelligence models and how they can be deployed on a satellite and then later accessed by users. In this method, the “machine learning model” includes any trained model, artificial intelligence, or similar model that receives data and produces a predicted output based on the data. The method 1000 includes training a machine learning model (1002), deploying the machine learning model on one or more satellites (1004), receiving, at a satellite, a request from a user terminal 502 to use the machine learning model deployed on the one or more satellites, the request including data (1006), identifying the one or more satellites that have deployed the machine learning model (1008), routing the request from the satellite to the one or more satellites (1010), generating, via the machine learning model, an output based on the data (1012), and returning the output from the satellite to the user terminal (1014). The entity that trains the model might also be different from the satellite operating entity and thus the training step (1002) is optional. In other words, the method might include simply receiving and storing or distributing across a group of satellite the machine learning model trained by another entity. Typically, the training entity will be different from the satellite company operating the satellites.

The method of FIG. 10 can also include transmitting data and/or output data between satellites and causing the user terminal to steer to an appropriate satellite to obtain the output from the compute resource. The satellite communicating with the user terminal can also be the same or different from the one or more satellites that have deployed the machine learning model.

Another issue that arises in the context of the group of satellite 900 is how to address the problems of topology and how does the overall system shift from state to state as satellites move across the sky. In the context of the group to satellites, the network topology in this case includes the arrangement of the various nodes (satellites), communication links (which can be via laser or other wireless communication protocol), transmission rates, distances between satellites, transmission time between satellites or between a user terminal or gateway and a particular satellite, satellite movement, satellite position relative to one or more user terminals or gateways, co-orbiting data for a group of satellites and they orbit relative to each other, and so forth. In one example, the physical topology between satellites can include a communication topology in a ring, mesh, star, fully connected, line, tree or bus arrangement. Depending on the distances and relative position of the various satellites in a group of satellites 900, various topologies with respect to how they communicate with each other can be determined. The topologies might be static once the compute resources are configured on various satellites or might be dynamic. In a dynamic scenario, a first topology might be configured for a group of satellites over a given geographic region and a second topology might be configured for the same group of satellites over a different geographic region.

Each satellite will have limited computing power, data storage capabilities, bandwidth capabilities and size, as well as other characteristics such as thermal issues or reboot/reset issues. Data centers on earth do not have such limitations and can provide in one location a large amount of compute resources. In the context of a group of satellites 900, there is much more limited computer capabilities and the compute resources likely have to be distributed. The issue as noted above arises when one is to deploy a compute resource such as a machine learning algorithm, a media streaming service, or other compute resource offering a cloud-service, and how to distribute that compute resource across the network topology with the network is a group of satellites 900. In FIG. 9, the distribution of compute resources is represented as compute resources 1, 2, 3, 4, 5 and 6.

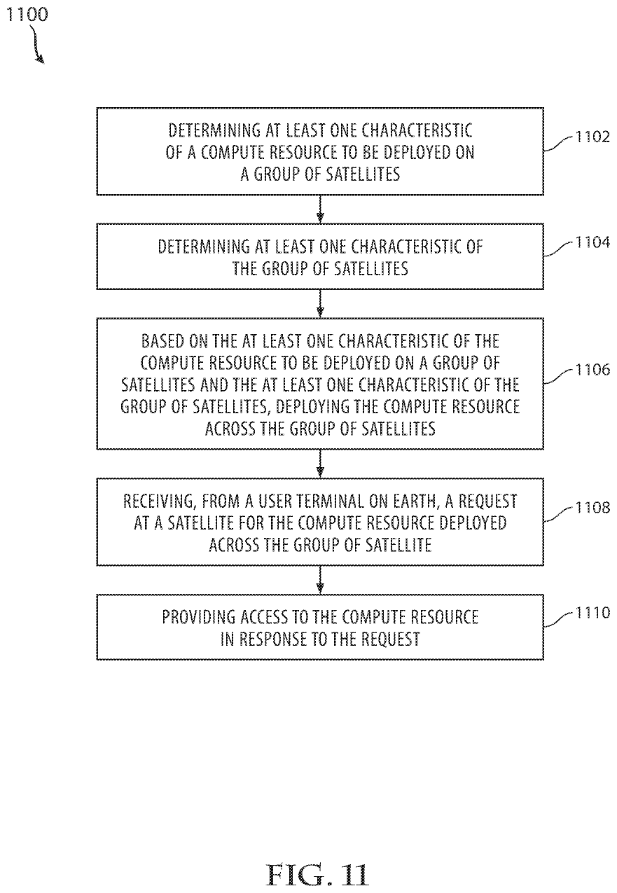

Thus, one aspect of this disclosure is a method 1100 shown in FIG. 11 which outlines the basic process of evaluating how to distribute a compute resource across a group of satellites 500. The method 1100 includes determining at least one characteristic of the compute resource to be deployed on a group of satellites (1102). The at least one characteristic can include one or more of an amount of data, a type of the compute resource, how much computing power the compute resource needs, what type of operating system the compute resource prefers, how much memory the compute resource requires, a frequency of requested use for the compute resources, a geographic location of user terminals on earth that are likely to request the compute resource, privacy concerns over the compute resource, a cost of use of the compute resource, a quality of service requirement for accessing the compute resource, an up-time requirement for the compute resource, how much data is transmitted when the compute resource is accessed. These characteristics can be used to evaluate the one or more characteristic of the compute resource. For example, a media streaming service may not require much computing power but requires a lot of memory to store media files. A machine learning compute resource or a trading platform might require a lot of computing power but will not transfer much data when using the compute resource.

Next, the method 1100 can include determining at least one characteristic of the group of satellites (1104). The at least one characteristic can include one or more of a distance between respective satellites, hardware characteristics of each respective satellite, communication bandwidth possible between any two satellites, an endpoint-to-endpoint communication channel capability, a speed or location of each respective satellite, software capabilities of a respective satellite, an orbital configuration for one or more satellite, a timing of when one or more satellites is in a position relative to one or more user terminals or gateways, computing power capabilities on one or more satellite, data storage capabilities for one or more satellites, a distance of a respective satellite to earth (which orbit the satellite is in), other compute resources deployed on a respective satellite, and/or characteristics associated with the capability to run virtual environments or virtual machines on a respective satellite. Based on the at least one characteristic of the compute resource to be deployed on a group of satellites and the at least one characteristic of the group of satellites, deploying the compute resources across the group of satellites (1106). The method can also include receiving, from a user terminal 502 on Earth, a request at a satellite 504 for the compute resources deployed across the group of satellite (1108), and providing access to the compute resources in response to the request (1110). Providing access to the compute resources might include coordinating access to the compute resources via the satellite that is communicating with the user terminal 502 or might include causing the user terminal to steer to the one or more satellites 900 that are configured with the requested compute resource such that the user can access the compute resources. The compute resources might be an endpoint-to-endpoint high speed communication channel which can provide a lower latency that would be experienced on the Internet.

Note that the group of satellites 900 might actually be a subgroup of a larger set of satellites and the analysis outlined above could include an analysis of a larger set of satellites with a selection of the group of satellite 900 from the larger set for deployment of the compute resources. In this manner, a cluster of satellites can be configured via the load balancing module 130.

The various characteristics outlined above can be used to determine which compute resources or services, with what frequencies and patterns, get deployed on which satellites in the group of satellites 900. Then, routing tables or other data can be used to map requests for respective compute resources to the proper location of the compute resources across the group of satellites 900. Again, typically a user terminal 502 is in communication with a respective satellite and will then request a particular compute resource. A DNS server 926 or similar routing table or database can be provided on the satellite (not shown but could be part of any one or more satellites) or accessed from earth to map or route the request to the proper satellite that has the compute resource and/or to cause the user terminal 502 to be steered to the proper satellite of the group of satellites 900. The DNS server 926 can be operated by the satellite company and have up-to-date information about which IP address or which satellites a particular user terminal should access at a given time, according to the orbits of the group of satellites that contains the requested compute resource. The compute resource entity 138 can also provide data to the DNS server in order to enable the proper routing of requests for compute resources to the proper hardware on one or more respective satellites 900.

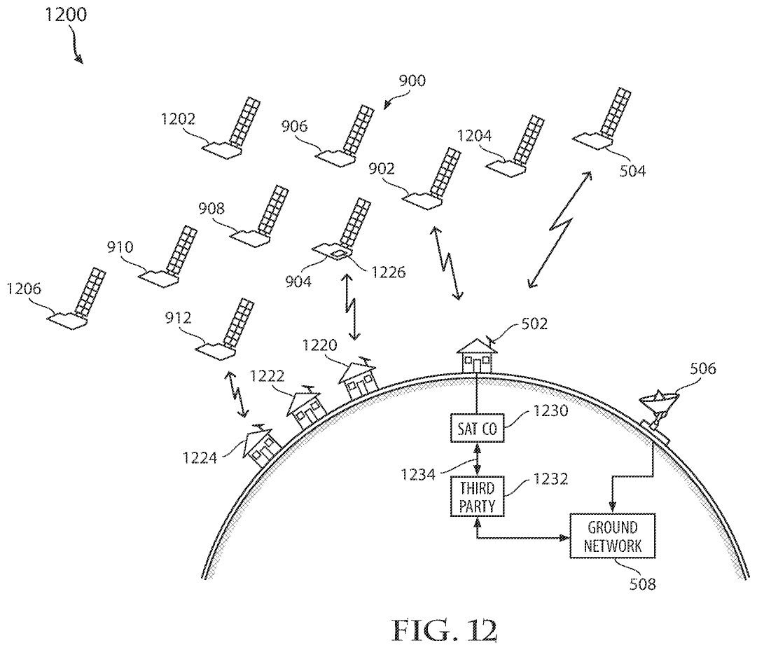

FIG. 12 illustrates the group of satellites 900 as part of a larger set of satellites that includes satellites 1202, 1204, 1206. The larger set of satellites 1200 will travel around the Earth and across some areas where there might be a small number of buildings with user terminals 502 or other areas where there are more user terminals 1220, 1222, 1224. The distribution of compute resources across the set of satellites 1200 differs from Earth-based compute or data centers in that the resources are much smaller and they move, and thus the relative position of a respective satellite to the respective user terminal 502, 1220, 1222, 1224 is always changing. Typically, as a satellite is in range or in communication with a user terminal 502, such as satellite 504 shown in FIG. 12, the satellite will at some stage be moving towards a position of being out of range or where a hand-off needs to occur to another satellite such as satellite 502. The user experience is uninterrupted as they simply will continue to experience Internet access across the handoff. However, in the context of this disclosure, the transition when the user is utilizing compute resources deployed on one or more satellites can differ. The typical hand-off can pass a state of the user's experience from the current satellite 504 to the hand-off satellite 502. The state is usually a state of communication with a ground network 508 such as the Internet so that the user access to the ground network 508 through the new hand-off satellite 902 via a gateway 506 continues without interruption.

The concept of state information in this disclosure differs in that as satellites move across the sky and a hand-off from one satellite 504 to the next 902 satellite needs to occur, when the user terminal 502 is accessing compute resources which may or may not be configured on the satellite 904 but might be provided from one or more other satellites, the “state” of the use of those compute resources needs to be transitioned to the new serving satellite 902. For example, if the user terminal 502 started a streaming service of a movie while communicating with satellite 904, and the data (compute resource) was actually configured on satellite 906, the satellite 906 might stream the movie through direction communication with the user terminal 502 or may communicate the data to the serving satellite 904 which then transmits the movie to the user terminal 502. However, if part way through the movie, the user terminal 502 needs to hand-off to satellite 902, the state information of that access of the movie (compute resource) is transferred from the storage satellite 906 to the new serving satellite 902 which may then start to receive the movie at the proper moment from the satellite 906 so that it can begin to transmit the movie to the user terminal 502. Alternately, if the serving satellite 906 needs to hand-off to a new serving satellite as it is moving out of range, then a redundant storage satellite might need to be identified and the state of the streaming video needs to be transmitted to a new serving satellite such as satellite 912 that also is configured with the data or compute resources and can continue the download to the user terminal 502 or to provide continued access to the compute resources.

If the compute resource is something other than data but the operation of an application or a service, and a job that is being processed is only party way complete, then the state information can be one or more of a configuration or state of the job, hardware, software or other provisioned compute environment data, sources of data or a status of output data, and so forth.

If the compute resource is a machine-learning model, and a hand-off needs to occur, a new satellite configured with the machine learning model might need to be identified and accessed to continue the service, or, through the laser mesh network, the output data from the satellite operating the model might need to simply transfer the data to a new serving satellite with the user terminal 502.

FIG. 12 also shows other computer components such as a server or servers 1230 operated by the satellite company that deploys the satellite and third-party servers 1232 that represent third parties that provide compute resources on the satellites. These entities can correspond to the compute resource entities 138 of FIG. 1B. These different compute systems can communicate via an application programming interface 1234 to exchange data to address some issues that arise in the context of the use of this group of satellites 1200 offering compute resources. These issues will be discussed more fully below.

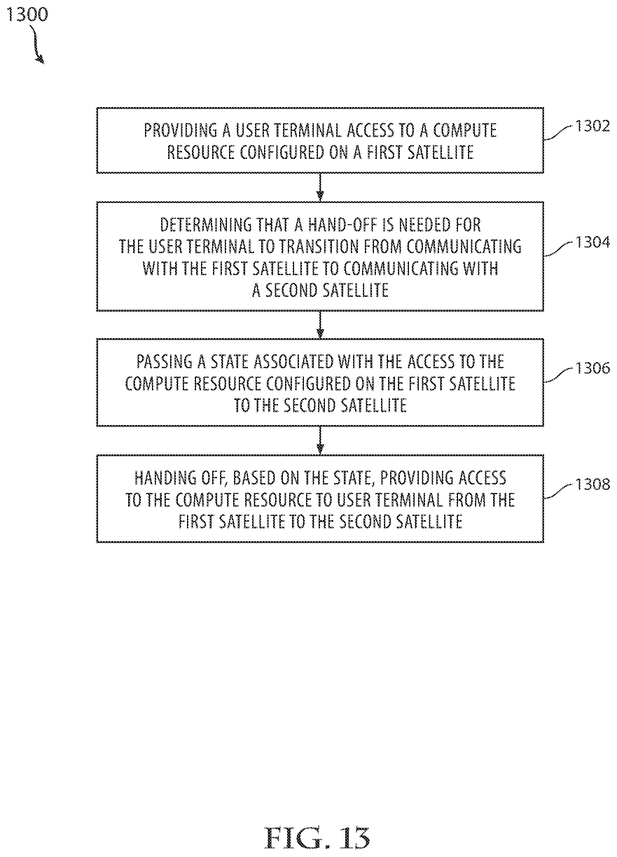

FIG. 13 illustrates a method 1300 with respect to passing “state” information on to a new serving satellite in a hand-off scenario. The method 1300 includes providing a user terminal access to a compute resource configured on a first satellite (1302), determining that a hand-off is needed for the user terminal to transition from communicating with the first satellite to communicating with a second satellite (1304), passing a state associated with the access to the compute resource configured on the first satellite to the second satellite (1306) and handing off, based on the state, providing access to the compute resource to user terminal from the first satellite to the second satellite (1308). In this manner, the user terminal 502 can continue accessing the desired compute resource across a hand-off scenario by the passing of state information. The first satellite might be in one cluster of satellites and the second satellite might be in a second and different cluster of satellites. There also might be some overlap between the first cluster and the second cluster of satellites.

Note that the satellite network topology obtained via the topology service 132 can also be important in terms of handing off from one satellite to the next satellite and according to the state information. For example, with reference to FIG. 12, if the access to compute resources is for a machine-learning model or other computing operating that is to be provided from compute resources on a satellite 906 to a user terminal 502. Assume that the satellite 504 is in communication with the user terminal 502 and that the satellite 904 coordinates the access to the compute resources between the user terminal 502 and the satellite 906 that is running the compute resources (to produce, for example, a predicted output of a weather model or speech processing model). In this scenario, the user terminal 502 does not get steered to communicate directly with the satellite 906 operating the model. Now, if a hand-off occurs from the satellite 906 to, for example, satellite 902, then a “state” of the processing of the model can be provided and the satellite 504 will transition its communication from the serving satellite 906 to communication with the new satellite 902. In this sense, there are two handoffs that occur.

In one aspect, as shown in FIG. 12, one of the satellites such as satellite 902 could be a larger satellite that perhaps is different in its capabilities from the other satellites in the set of satellites 900. In this case, the satellite 902 could for example have a much larger data storage capability and/or processing capability and could transmit or communicate with the other satellites in the group or set of satellites. In one example, the satellite 902 may not be configured to communicate with user terminal 502 but may only communicate or primarily communicate with other satellites that do receive requests for compute resources from user terminals 502, 1220, 1222, 1224. In this regard, where there is a need for a larger group of compute resources than can be normally serviced by a single satellite, the use of a larger satellite 902 can be utilized to provide the larger group of compute resources.

In another aspect, where the compute resources are distributed across the group of satellites 900, the access to a large group of resources can exist through a pooling of compute resources from the group of satellites 900. This can be achieved through establishing a cluster of satellites.

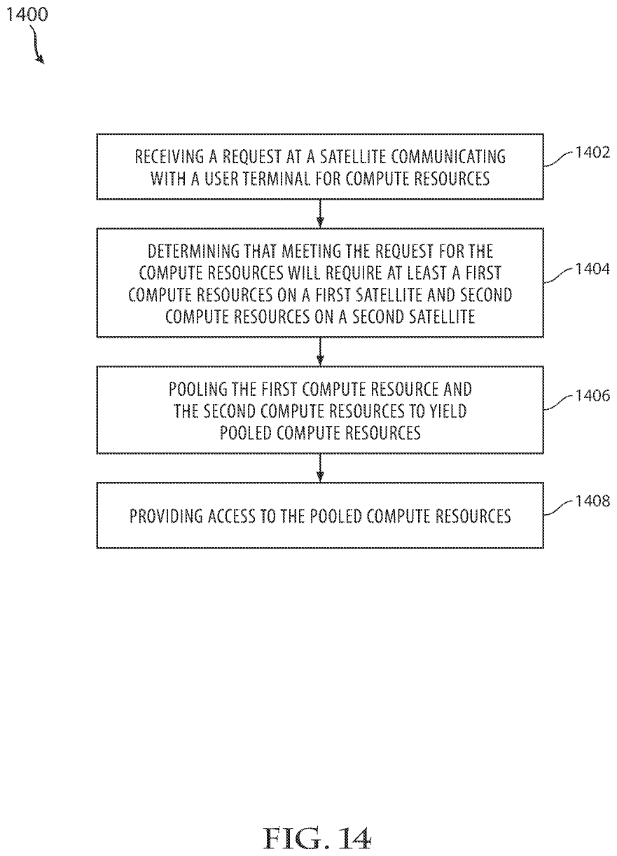

For example, the amount of computing power or memory that is required might span across multiple satellites. In this regard, FIG. 14 illustrates an example method of pooling resource from a plurality of satellites. The method 1400 can include receiving a request at a satellite communicating with a user terminal for compute resources (1402), determining that meeting the request for the compute resources will require at least a first compute resources on a first satellite and second compute resources on a second satellite (1404), pooling the first compute resource and the second compute resources to yield pooled compute resources (1406) and providing access to the pooled compute resources (1408). Pooling the first compute resources and the second compute resources can include reserving or coordinating data between the first satellite and the second satellite such that the compute resources (whatever type they are) can be combined in a virtual pool of compute resources across different satellites to service the request for compute resources. If necessary, additional satellites besides just two satellites could have compute resource pooled together to meet a request. The pooling can include setting up communications between the pooled satellites to share state data or any other data necessary to use to compute resources according to the request.

In some cases, the pooling of computer resources across co-orbiting satellites might be dynamic. For example, a cluster of satellites 908, 504, 904 might be pooled for a period of time with respect to their compute resources due to factors such as the number of requests over a geographic area or other factors. As the larger set of satellites 900 orbits, the pool might adjust dynamically to add or subtract from the pool as the needs might differ over a different geographic region, or a demand or a predicted demand for the compute resources might occur. For example, as the holidays approach, the system might expect a large increase in the request for streaming media at certain times or access to certain purchasing, social media or commerce platforms is expanded. A number of different changes or adjustments could be made to meet the demand. In one aspect, data stored on one satellite might be duplicated on another satellite such that the pool of satellites could expand to meet the temporary demand. In another aspect, more satellites having a portion of the compute resources might be virtually added to a pool or cluster of satellites to enhance the compute resources available. Thus, such clusters or pools of satellites can be created, expanded, reduced, and so forth to create a virtual large compute resource center. Such adjustments can also occur in response to a single request. For example, a request for compute resources might be serviced starting with three satellites operating a machine-learning model and complete with just a single satellite performing final calculations. Again, accessing the compute resources can occur through steering user terminals to the appropriate satellite or through a data transfer via the mesh network of satellites 900 to the servicing satellite which can then transmit data to the user terminal 502.

Note that a workload management component 1226 can be configured on a satellite 904 or ground station (such as part of the SatOps service 130) which can evaluate requests for compute resources and schedule future access and make reservations of compute resources across one or more satellites 900 in order to make the access to and use of the compute resources more efficient.

The parameters for scheduling or balancing such requests can take in to account thermal conditions, reboot/reset conditions and/or energy levels as describe herein. In this manner, a greater efficiency can maximize the use of all CPU cycles, memory, communication bandwidth, and so forth. In other words, in a group of satellites 900 that in a distributed manner provide access to compute resources, it is desirable to provide efficient use of the compute resources such that compute resources are not wasted and requests can be timely provided a response. For example, a satellite 504 might receive one thousand requests for different types of compute resources from user terminals 502, 1220, 1222, 1224. Some of these requests might be for streaming media, and others might be for use of machine learning models, and so forth. The requests might have certain characteristics such as qualities of service, priorities, and so forth. The workload management component 1226 would place each request in a queue and could determine when to make reservations of the various compute resources across the network of satellites 900 to meet the various requests. A workload management component 1226 (much like the management module 630 in FIG. 6 or load balancing module 130 in FIG. 1) could evaluate a current list of requests in a queue, and evaluate one or more parameters such as a quality of service, the type of compute resources, capabilities and locations across the satellites of the compute resource, and so forth, and reserve access to the compute resource across one or more satellites (pooled or clustered if necessary) to carry out the request. The reservation could encompass a period of time the compute resources is “reserved” for the user as well as an amount of the compute resource (CPUs, nodes, memory, bandwidth, etc.). This, in the future, all one thousand requests for different types of compute resources can be served in an efficient manner and in harmony with expected response times (quality of service) and any other requirements.

Where a pool or cluster of satellites are organized to provide a larger pool or available set of compute resources, and where that pool might be dynamically changing, note that updates to a routing table or to the workload management component 1226 can be provided such that each request for resources can be served or provided via a current understanding of the network topology. In some cases, the queue of request might drive a change in the network topology as well such that additional satellites might be added to a pool or a duplication of data or adjustment of some type might occur to meet the demands of requests in a queue.

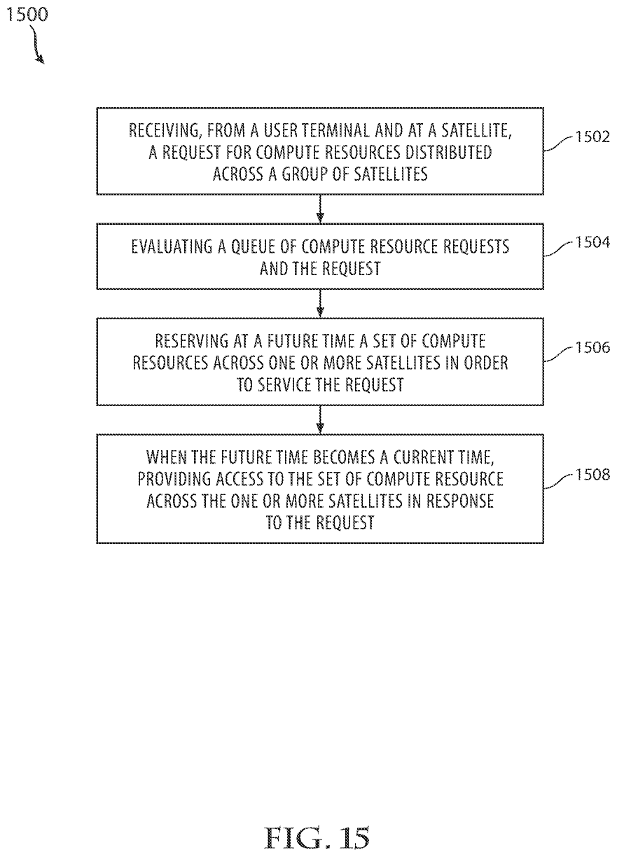

FIG. 15 illustrates an example method 1500 with respect to reservations of compute resources. The method 1500 can include receiving, from a user terminal and at a satellite, a request for compute resources distributed across a group of satellites (1502), evaluating a queue of compute resource requests and the request (1504), reserving at a future time a set of compute resources across one or more satellites in order to service the request (1506) and when the future time becomes a current time, providing access to the set of compute resource across the one or more satellites in response to the request (1508). As an example of how this can work, in one aspect, the queue might be first-in and first-out in terms of when requests for compute resources are served. However, such a simple approach might not provide the most efficient use of the compute resources. Many compute cycles might be left unused for a period of time. High priority users might have jobs waiting to be processed when compute cycles might be available. In another aspect as outlined above, each request in a queue of requests can have a specific schedule time in which the compute resources for that request is made available to the requester. Because the system can evaluate one or more parameters such as the type of request, a priority of the request, a quality of service requirements, service level agreement terms, and so forth, the workload management component 1226 can receive a respective request, evaluate the queue and the schedule of requests that is set forth in the future and look for potentially snippets of time in connection with compute resources in which the new request can be scheduled.

For example, if there is a five second opening in which no request is scheduled for streaming a video and that is available, the workload management component 1226 can schedule that five second opening to enable access to the compute resources for that period of time. Thus, available openings in time can be filled and thus lead to increased efficiency in the overall use of the compute resources. Because the compute resources in this case are going to be distributed across a group of satellites 900, the evaluation and the reservation process can take into account such factors as the movement of one or more satellites, the position of the one or more satellites relative to the requesting user terminal 502, the capabilities of respective satellites with respect to power, processing capabilities, memory storage, energy requirements, thermal issues, reboot/reset issues, distance between satellites over time and a distance between respective satellites and a respective user terminal, and so forth.

In another example, reserving compute resources might take into account the fact that a pooling of compute resources across a subgroup of satellites might occur for a particular period of time while one or more of the subgroup of satellites is in communication with a respective user terminal 502. Over time, the subgroup of satellites might move into a new position and no longer be capable of providing direct communication with the requesting user terminal. Thus, where a new subgroup of satellites might need to receive a transition or a handoff of the servicing of the request for compute environments, such handoffs or the likelihood in the future of the need for such handoffs might be taken into account with respect to reserving compute resources from a group of satellites.

For example, given the movement of the various groups of satellites, the workload management component 1226 might determine to delay the reservation of the compute resources until a certain subgroup of satellites are in a certain position such that no handoff will be needed throughout the process of providing access to the required compute resources. In another aspect, where handoffs might need to occur amongst either a satellite that is going to be communicating with the user terminal 502 or one or more satellites that will actually be providing the compute resources, the timing and bandwidth needed in order to achieve a handoff situation can be taken into account with respect to the overall efficiency of servicing a request for compute resources. Thus, these additional factors will need to be taken into account in the context of providing access to distributed compute resources across a group of satellites 900 which factors are not at play in a ground-based network 508.

In some cases, compute resource providers, such as a media streaming company, might simply want their cloud-services made available via the set of satellites 1200 and might not need to know all of the details about how their compute resources will be delivered. The satellite company may not need to or desire to know where any particular file is stored on their satellites but might be focused on how to generally deliver access to the compute resources. The question is how will a user terminal 502 be able to access or request compute resources in such a scenario? To address this issue, the satellite service might provide all the user terminals 502, 1220, 1222, 1224 a map of IP addresses (or other identifying data) to satellites and the company providing the compute resources can get a listing of all IP addresses of satellites upon which their software, cloud-service, or application is running. For example, the satellite company might instruct the compute resource company that their compute resources are running on satellites 902, 904 and 1204 with IP addresses of 192.158.1.38; 192, 158.1.39; 192.158.3.40. The user terminals 502, 1220, 1222, 1224 might tag the IP address 192.158.1.38 noting that this IP address is on a satellite and/or which satellite the service is on. The serving satellite for the user terminal 502 can receive the request and know to transition the user terminal 502 to the appropriate satellite or to retrieve via a satellite-to-satellite communication (through a laser satellite mesh network 1200) the requested compute resource or to access the data on the appropriate satellite. In another aspect, the user terminal 502 might respond to the tag associated with the IP address and simply immediately transition to that satellite identified via the tag.

There can be different routing strategies. For example, the request from the user terminal 502 may state that it needs to get to any one of a group of twenty satellites that has the requested compute resource. The servicing satellite can then select via an algorithm or a routing table or some other mechanism and route the request to one of the other of the twenty satellites. The serving satellite might choose the one closest to it based on distance, or the servicing satellite might “ping” the other of the twenty satellites or the closest ten satellites determining how burdened each one is and whether a respective satellite can respond to the request. Other factors can take into account characteristics such as a thermal condition, a reset/reboot event(s), an energy level, a current distance between satellites or a predicted or future distance between two given satellites.

In another example, the data in the request from the user terminal 502 may indicate that the user terminal 502 should get access to a certain “group A” of satellites (such as satellites 912, 1206, 908) that are over North America and that represent the pooled satellites offering the compute resources that are needed. The data in the request that identifies the group of satellites that it needs to be directed to might be based on the tag associated with the IP address, wherein the tag indicates that the computers associated with the IP address are on satellites (rather than being configured on Earth).

The compute resources that are needed might span more than one satellite. This, a particular request might include the pooling of compute resources from multiple satellites to deliver the requested compute resources. For example, one request might be served by satellites 906, 910, 912 and 1206. Another request might be served by satellites 902 and 1204. A workload management component 1226 might utilize data indicating the compute resources on each satellite and construct a determination of which satellites are to be pooled to meet the request. Different parts of the workload can then be divided up and communicated to the proper satellites in the laser mesh of satellites 1200. Part of processing the workload can include interim communications which might be necessary to complete the workload processing on these separate nodes of the pool.

In one aspect, one factor that can be utilized to select or organize a pool of satellites to service a compute resource request can be to include one satellite in the pool that is the satellite designated to communicate with the user terminal 502. This might be the same satellite that was currently communicating with the user terminal 502 or a handoff to another satellite in the pool that is also participating in servicing the request with compute resources. As noted above, the pooling of computer resources can also be determined based on the fact that satellites in the pool are co-orbiting satellites. Thus, there are a number of different strategies for pooling satellites to create virtual large compute resource centers via a cluster or pool of different satellites.

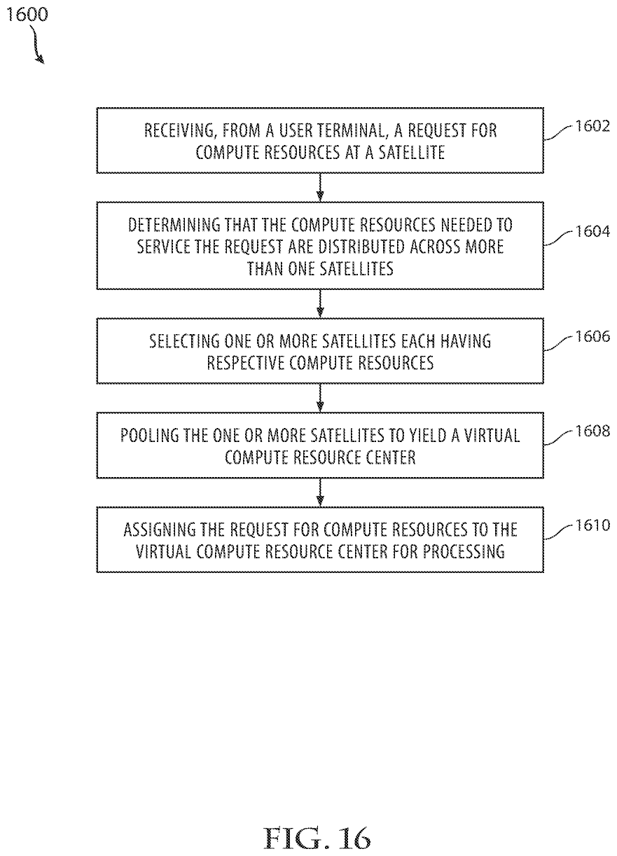

FIG. 16 illustrates an example method with respect to pooling compute resources. The method 1600 can include receiving, from a user terminal, a request for compute resources at a satellite (1602), determining that the compute resources needed to service the request are distributed across more than one satellites (1604), selecting one or more satellites each having respective compute resources (1606), pooling the one or more satellites to yield a virtual compute resource center (1608) and assigning the request for compute resources to the virtual compute resource center for processing (1610).

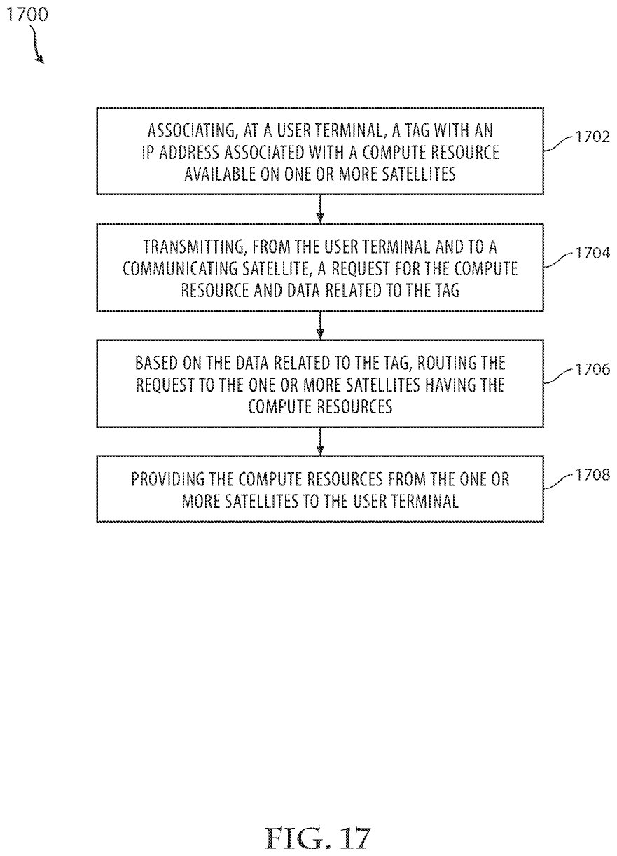

FIG. 17 illustrates another example of using IP tags for user terminals. The method 1700 includes associating, at a user terminal, a tag with an IP address associated with a compute resource available on one or more satellites (1702), transmitting, from the user terminal and to a communicating satellite, a request for the compute resource and data related to the tag (1704), based on the data related to the tag, routing the request to the one or more satellites having the compute resources (1706) and providing the compute resources from the one or more satellites to the user terminal (1708). Using the laser mesh of satellites 900, the system can route the request to the proper satellites for servicing the request with the proper compute resources.

One issue addressed herein is the fact that in the context of the capability of providing a laser mesh of communicating satellites that can house distributed compute resources, the third parties 138 that provide the compute resources or software and data to operate or provide the compute resources, those third parties will not want to know or need to know about orbital mechanics. Additionally, the company providing the satellites does not want to or need to know about each file or piece of data or algorithm provided as a compute resource and which satellite stores or caches which data. A challenge exists with respect to how to coordinate with third parties to distribute their compute resources across the satellites. However, the system needs to know both pieces of information in order to properly route requests to the right satellites. The disclosed solutions address these problems. Notably, the communication between the compute resource entity 138 and the load balancing module 130 achieves this goal.

One example solution to this problem is to provide some new data communicated between the user terminal 502, servers 1230 operated by the satellite company and servers operated by a third part compute resource provider 1232. The issues set forth above can be solved in a number of different solutions. For example, the satellite company servers 1230 can communicate via an application programming interface (API) 1234 or some other communication protocol with the third-party servers 1232. Assume for this example that the third-party company is a media streaming company. They know that their service is operating on one hundred satellites, but they do not know where the satellites are or which ones are in range at any given time for their customers. The structure of the API in one example can be that the third-party servers 1232 transmit a set of IP addresses and options or data. A particular episode of a show might be stored on ten of the one hundred satellites. The third-party company will not know the orbital patters or locations of those ten satellites (they orbit the earth every 95 minutes) that have the proper episode but they know which ten satellites store that episode. The media company third-party server 1232 may receive a request from a user operating software and/or hardware associated with the media company for the particular episode and transmit via the API data about the user (location, for example, which enables the satellite company to determine which user terminal 502, 1220, 1222, 1224 will receive the streaming media) and data about the ten satellites that will be capable of responding to the request. In this case, assume that satellites 902 and 910 in FIG. 12 store the requested episode and the user terminal 502 is associated with the user making the request. The satellite company can respond via the API 1234 with the information that satellite 902 will be the proper satellite that can communicate with the user terminal 502. Data such as the IP address associated with satellite 902 can be transmitted back to the third-party servers 1232 and the third-party servers can then provide that data to the user (via the media company application) such that it can be routed to the right satellite 902 to receive the streaming data of the requested episode. This approach also can relate to any cloud-service offered via the satellites 900.

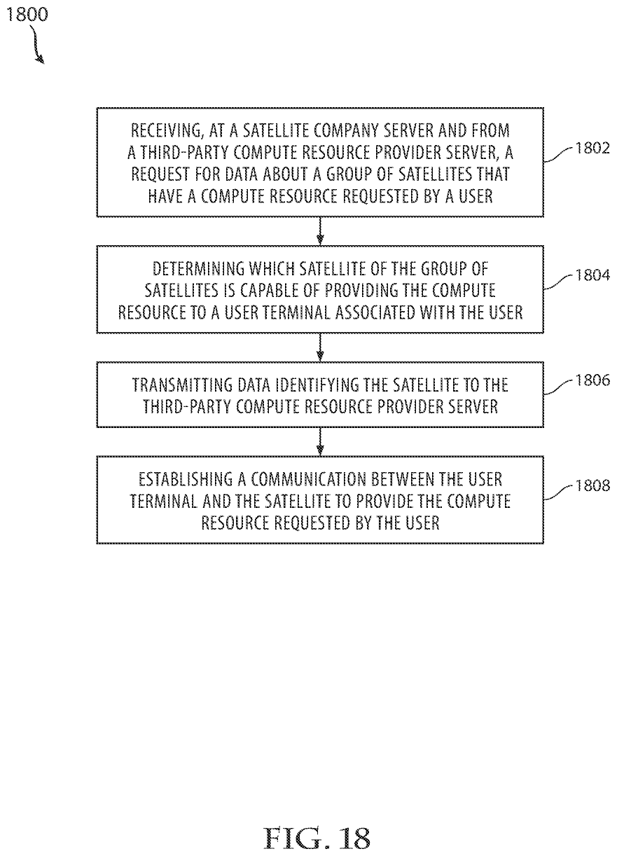

FIG. 18 illustrates a method 1800 of providing the user with the proper routing to the right satellite. The method 1800 can include receiving, at a satellite company server and from a third party compute resource provider server, a request for data about a group of satellites that have a compute resource requested by a user (1802), determining which satellite of the group of satellites is capable of providing the compute resource to a user terminal associated with the user (1804), transmitting data identifying the satellite to the third-party compute resource provider server (1806) and establishing a communication between the user terminal and the satellite to provide the compute resource requested by the user (1808). Note that these are the steps performed by the nodes or components operated by the satellite company. Establishing a communication between the user terminal and the satellite to provide the compute resource requested by the user can be made possible by the third-party servers 1232 informing a user device of the proper satellite to access to receive the compute resource. An API or other communication protocol or communicate scheme 1234 can be used to exchange the necessary information between servers 1230, 1232. The approach above of course can work for any compute resource and is not limited to streaming data or data caching.

In another aspect, the third-party company that provides compute resources such as a media streaming service can provide to its customers a universal resource locator (URL) with data that could identify the various satellites that house the compute resources. When the customer (through an application, website or other software operated by the media streaming service) requests a program or a compute resource, the customer software or other application on a user device can access a DNS service 926 (directly or via a ground network 508 shown in FIG. 9) which can be operated by the satellite company. The DNS service 926 can, in one aspect, perform an operation similar to what is outlined in FIG. 18 above in which it requests data from the company servers 1232 regarding the group of satellite that have the requested compute resources contained thereon. The company servers 1232 can return the data regarding which group of ten (for example) satellites contains the requested compute resources. Then the DNS server 926, because it is operated by the satellite company, can further resolve the URL to determine which of the ten satellites should be chosen to communicate with the user terminal 502. The data identifying the chosen satellite can be transmitted back to the user such that the user terminal 502 can steer its signal to the chosen satellite.

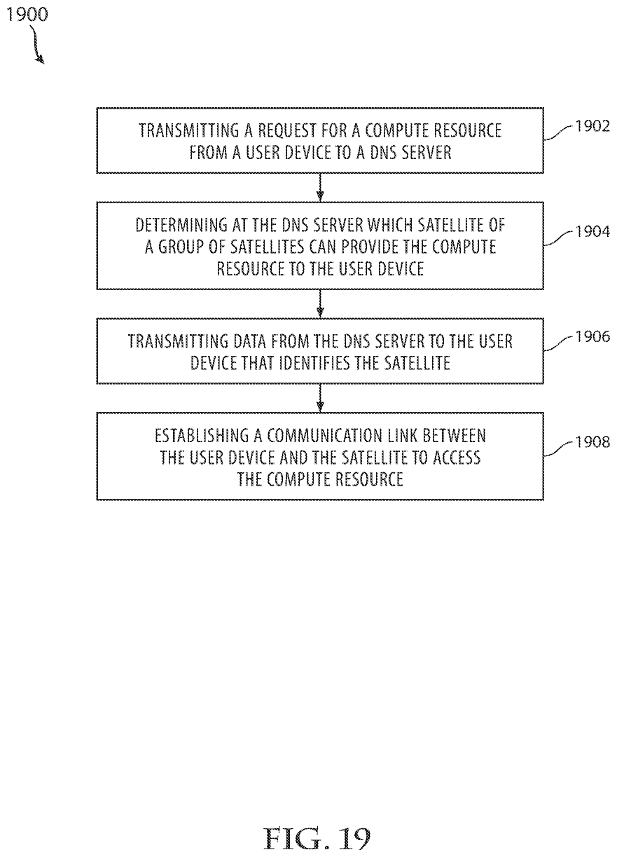

FIG. 19 illustrates a method 1900 of using a URL as outlined above. The method 1900 can include transmitting a request for a compute resource from a user device to a DNS server (1902), determining at the DNS server which satellite of a group of satellites can provide the compute resource to the user device (1904), transmitting data from the DNS server to the user device that identifies the satellite (1906) and establishing a communication link between the user device and the satellite to access the compute resource (1908). Determining at the DNS server which satellite of a group of satellites can provide the compute resource to the user device

### Clustering Based on Scheduled Workload

Another aspect of this disclosure relates to the clustering process and how decisions are made to generate a cluster of satellites for providing compute resources. FIG. 20 shows the group of satellites 2000 including satellite 2002, satellite 2010 and satellite 2018. The original group of satellites 2000 typically relates to a plurality of satellites that will be potentially available for accessing or providing compute resources to one or more terminals in a geographic area. As noted above, a topology schedule from the topology service 132 can be used to identify a schedule for a period of time (such as, for example, ten minutes) where satellites are going to be available for a cell on the Earth having at least one user terminal 112. The discussion above includes the idea of clustering satellites based on conditions such as movement of satellites, transient thermal conditions, reset/reboot events and energy conditions. This additional concept described here relates to determining how to cluster satellites based on the scheduled workload or scheduled use of compute resources which may or may not use compute resources on those satellites.

Each satellite 2002, 2010, 2018 has respective compute resources 2004, 2012, 2020 including computer processors 2006, 2014, 2022 and memory 2008, 2016, 2024. The computer processors 2006, 2014, 2022 and memory 2008, 2016, 2024 are representative of compute resources but they could also include ports for endpoint-to-endpoint high speed data communication between satellites, or applications, or cloud-service instances, and so forth. These are available for use as compute resources or they may have software configured thereon to provide access to services such as a stock trading platform or other “X” as a service.

In cloud computing and on-demand high performance computing environments, many requests for compute resources can be received from different users. A data center having many compute nodes can have workload manager that acts as an intelligence layer to evaluate the requests, evaluate the scheduled workload on the data center and schedule the new requests in ways that seek to efficiently use each computer processor in each time slice so that computer processor cycles are not wasted. This approach is applied to a satellite context in which in addition to the physical condition of one or more satellites or based on satellite movement and relative position, a scheduled workload or scheduled requests for compute resources are evaluated for determining which satellites from the group 900 to cluster together.

In one example, the workload manager 137 shown in FIG. 1B knows the scheduled workload for the group of satellites 2000 and can provide that data to the SatOps service 130. The workload manager 137 can also include machine learning or artificial intelligence models or other models that utilize historic data of a particular cell or geographic region over which the group of satellites 2000 will pass. In this regard, the “scheduled workload” can mean the expected workload or expected requests for compute resources from one or more cells. For example, a group of satellites 2000 moving from being over the ocean to being over New York or Seattle might expect many requests from user terminals 112 from a highly populated area. Furthermore, the types of data or cloud-services or any other type of compute resources might be expected to vary depending on the geography or demographics of an area. These differences in expected requests might also cause a different clustering to occur given the distribution of data and software and compute processor and memory availability across the group of satellites 2000.

Some requests might include requests for endpoint-to-endpoint high speed communication channels from one location to a far distance location (such as LA to London) and the topology schedule can be combined with such a request to cluster the proper set of satellites together to deliver the channel.

In one example, assume that satellite 2002 is closer to satellite 2010 than is satellite 2018. Assuming satellite 2002 has acceptable conditions (thermal, radiation, energy), it would likely be clustered together with satellite 2010 to provide compute resources to the user terminal 112. However, what if the circumstance arises where a previous workload that is running or using the computer processors 2006 and all or substantially all of its computer processors 2006 are busy as well as perhaps its computer-readable storage devices or media 2008. In this case, satellite 2002 might not be available for any workload for a period of time such as five minutes of the ten-minute time slot covered by the topology schedule from the topology service 132. In such a case, the clustering might involve a laser connection 2036 between satellite 2010 and satellite 2018. In this regard, these satellites might physically be further apart, but their workload schedule will enable them to service expected requests from the user terminal 112 or received requests that need to be scheduled.

Assume that the user terminal 112 requests a compute environment as compute resources via a communication link 2038 with the satellite 2010. This might be a certain number of computer processors and memory with a configured software package to run the workload. In this regard, the cluster of satellites 2010, 2018 can be configured through a high-speed communication link 2036 to enable a compute environment 2034 that can include some computer processors 2026 and memory 2028 from the satellite 2010 and some computer processors 2030 and memory 2032 from satellite 2018. The compute environment 2034 may be provisioned for the request for compute resources with certain software to provide a service or may already be provisioned and made available as the request would be for a platform performing particular function. In this regard, the clustering might involve simply how busy different satellites of the group of satellites 2000 are to be responsive to requests. If one satellite 2004 is too busy or not capable of responding to a request or expected requests in a geographic area, then the clustering might involve not including that satellite 2004 in a cluster.

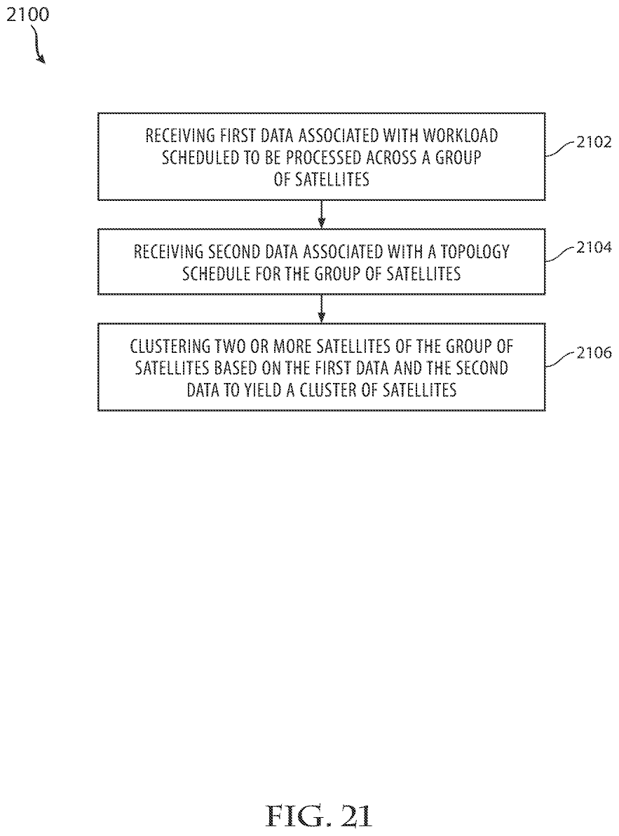

FIGS. 21-26 illustrate various methods related to clustering satellites taking at least scheduled workload or expected workload into account. FIG. 21 illustrates a method 2100 including receiving first data associated with workload scheduled to be processed across a group of satellites (2102), receiving second data associated with a topology schedule for the group of satellites (2104) and clustering two or more satellites of the group of satellites based on the first data and the second data to yield a cluster of satellites (2106). In one example, the workload scheduled can include ten minutes of scheduled workload that can overlap in whole or in part with the topology schedule which can also be for ten minutes.

The method can further include granting access to the compute resources on the cluster of satellites (2108). The clustering of the two or more satellites can be based on one or more of thermal conditions, reboot/reset conditions and energy conditions associated with each satellite of the group of satellites. The clustering can also be based exclusively on the workload scheduled or expected workload as the cluster of satellites moves over a geographic area having at least one user terminal 112. Again, the workload can include any compute resources such as bandwidth or an endpoint-to-endpoint high speed communication channel.

The method can further include receiving, from a user terminal 112, third data associated with a request for compute resources and providing the compute resources 2034 from the cluster of satellites to the user terminal 112. The clustering of the two or more satellites of the group of satellites 2000 can further be based on the third data.

Receiving the third data can occur after the clustering of the two or more satellites. For example, the clustering can occur based on existing workload or expected or predicted workload. The group of satellites might be moving from an area over the ocean to an area over a large city on the coast and have many expected requests for compute resources. The group of satellites can receive from the SatOps service 130 one or more parameters, or an instruction based on one or more parameters to cluster certain subgroups of satellites together to prepare for the requests. Other data can be utilized as well such as public events (sporting events) that might be scheduled and which would cause many user terminals 112 to request a certain streaming service, or holiday information, or new movie release information, as well as demographics or information about one or more users, which can cause or impact the clustering decision made by the SatOps service 130.

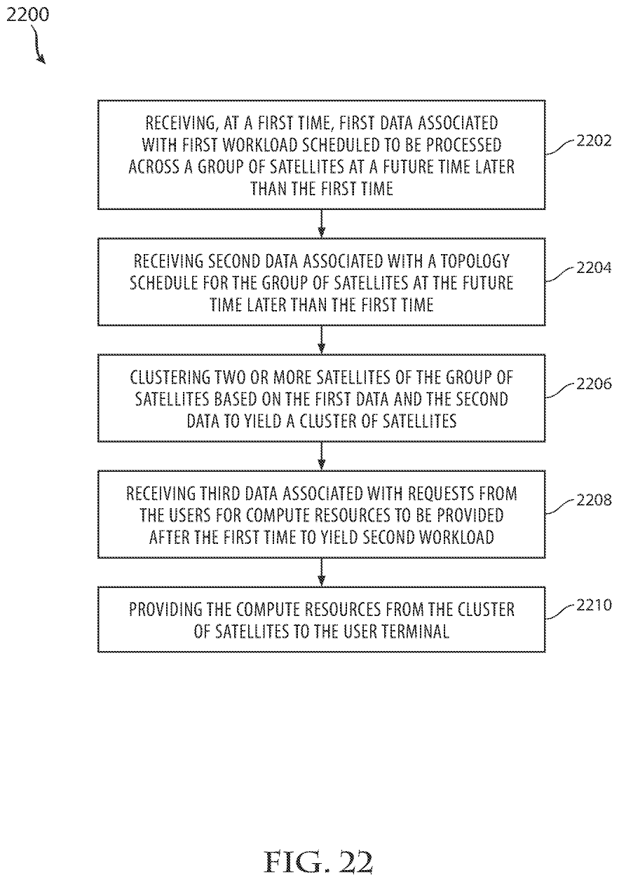

FIG. 22 illustrates a method 2200 related to a timing associated with the clustering operation. The method 2200 can include receiving, at a first time, first data associated with first workload scheduled to be processed across a group of satellites at a future time later than the first time (2202), receiving second data associated with a topology schedule for the group of satellites at the future time later than the first time (2204) and clustering two or more satellites of the group of satellites based on the first data and the second data to yield a cluster of satellites (2206). One example of this approach is to utilize one or more of the workload scheduled for a period of ten minutes and the topology schedule for ten minutes and utilize the data determine how to cluster the satellites together (link them via a laser or other communication link 2036) for providing access to compute resources for a period of time as the cluster of satellites is in view of a user terminal 112 or even beyond the direct connection as well. Using an endpoint-to-endpoint high speed communication channel will use compute resources (laser connections, bandwidth) typically beyond satellites in direct view of a requesting user terminal 112.

The method can further include receiving third data associated with requests from the users for compute resources to be provided after the first time to yield second workload (2208) and providing the compute resources from the cluster of satellites to the user terminal (2210).

In one aspect, the method can include scheduling the second workload after the first time on the cluster of satellites to yield a workload schedule and providing the compute resources to the users from the cluster of satellites according to the workload schedule.

Clustering two or more satellites of the group of satellites can further be based on the third data. Receiving the third data can occur after the clustering of the two or more satellites.

The method can further include receiving fourth data associated with one or more of a priority, a service level agreement and quality of service guarantees associated with at least one of the first workload and the second workload. The clustering of the satellites can further be based on the fourth data.

A compute environment 2034 can be provisioned for a user workload across the cluster of satellites 2010, 2018. In some cases, the provisioning needs to be done after the request and in other cases the necessary software already is provisioned and the user is requesting a service such as a trading platform or streaming video. The provisioning can be scheduled and can include the provisioning of any software or application needed to provide compute resources such as endpoint-to-endpoint communication channels.

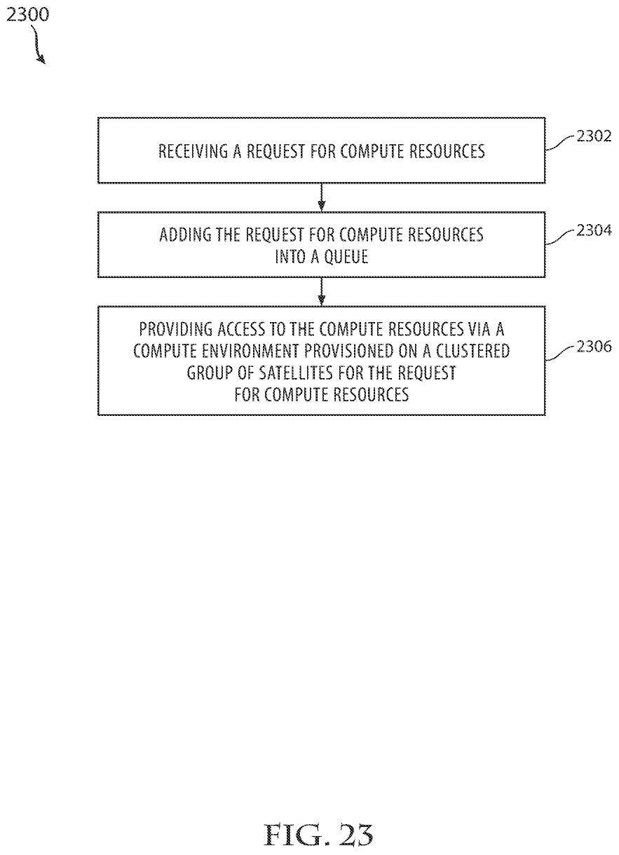

FIG. 23 illustrates a method 2300 including receiving a request for compute resources (2302), adding the request for compute resources into a queue (2304) and providing access to the compute resources via a compute environment provisioned on a clustered group of satellites for the request for compute resources (2306). The compute resources 2034 are configured across two or more satellites in the cluster of satellites 2010, 2018. The cluster of satellites 2010, 2018 can be chosen from a group of satellites 2000 and is configured based on one or more of an existing schedule of workload to be processed on a group of satellites, transient thermal conditions of the group of satellites, reboot/reset events of the group of satellites, energy conditions of the group of satellites, service level agreements for users, quality of service requirements for users, and a topology schedule for the group of satellites. The cluster of satellites can include a subset of the group of satellites.

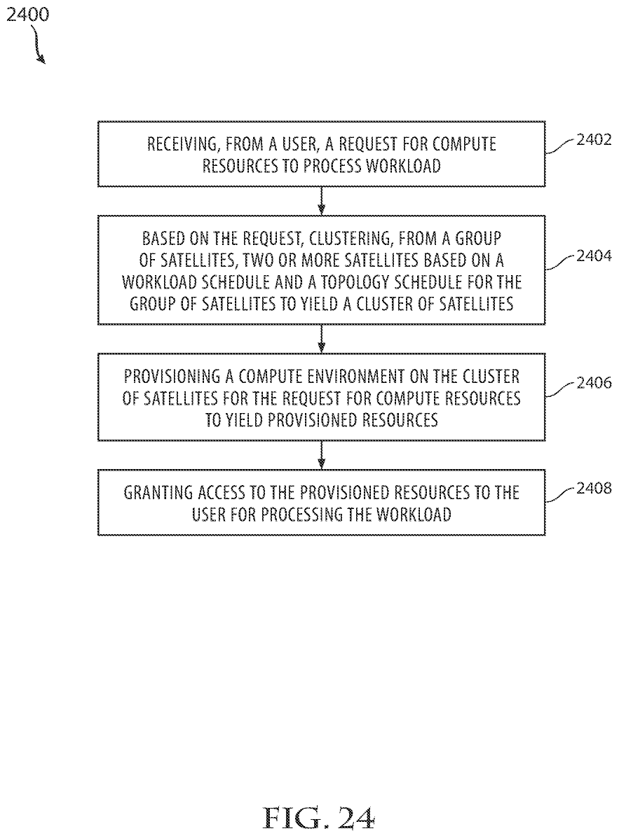

FIG. 24 illustrates a method 2400 including receiving, from a user, a request for compute resources to process workload (2402), based on the request, clustering, from a group of satellites, two or more satellites based on a workload schedule and a topology schedule for the group of satellites to yield a cluster of satellites (2404), provisioning a compute environment on the cluster of satellites for the request for compute resources to yield provisioned resources (2406) and granting access to the provisioned resources to the user for processing the workload (2608).

Clustering the two or more satellites can further be based on two or more requests for compute resources. Clustering the two or more satellites can further be based on one or more of a transient thermal condition of the group of satellites, a reboot/reset condition of the group of satellites, an energy level associated with each satellite of the group of satellites.

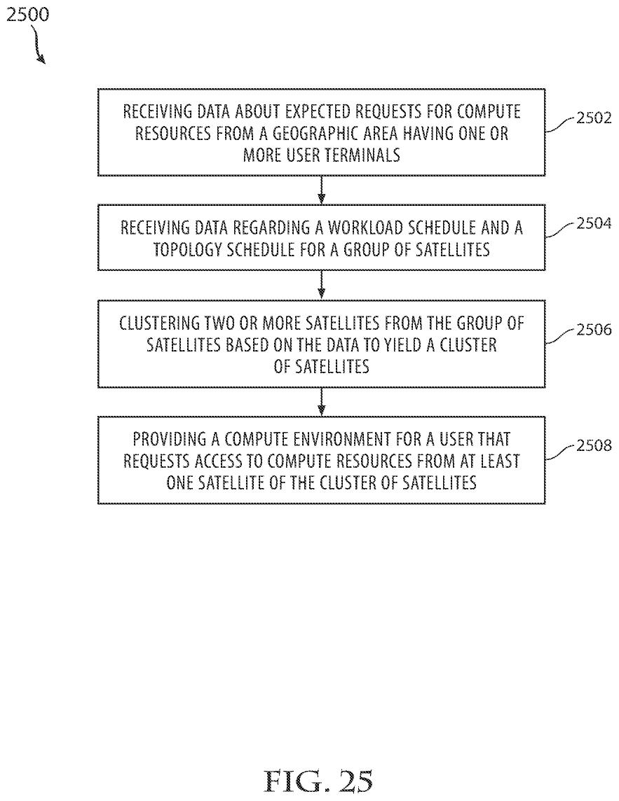

FIG. 25 illustrates a method 2500 including receiving data about expected requests for compute resources from a geographic area having one or more user terminals (2502), receiving data regarding a workload schedule and a topology schedule for a group of satellites (2504), clustering two or more satellites from the group of satellites based on the data to yield a cluster of satellites (2506) and providing a compute environment for a user that requests access to compute resources from at least one satellite of the cluster of satellites (2508).

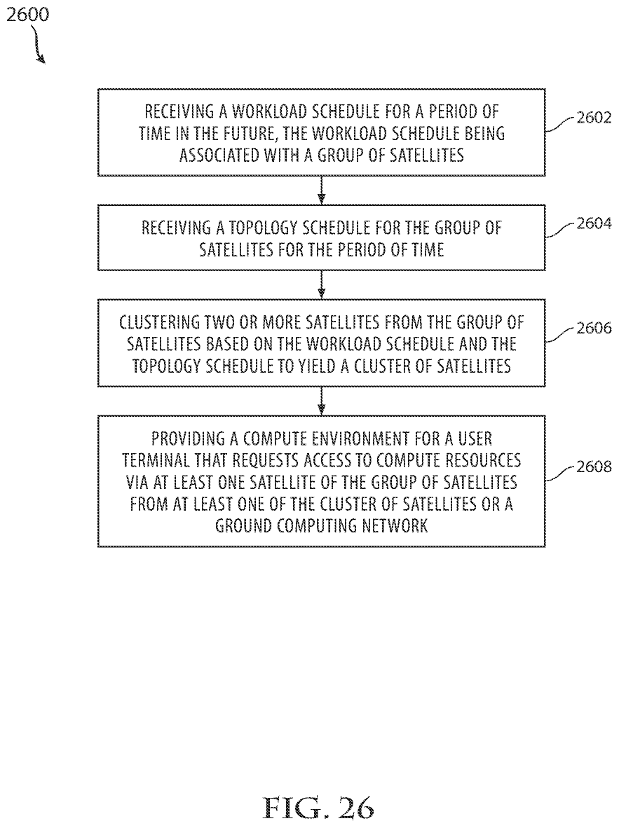

FIG. 26 illustrates another method 2600 including receiving a workload schedule for a period of time in the future, the workload schedule being associated with a group of satellites (2602), receiving a topology schedule for the group of satellites for the period of time (2604), clustering two or more satellites from the group of satellites based on the workload schedule and the topology schedule to yield a cluster of satellites (2606) and providing a compute environment for a user terminal that requests access to compute resources via at least one satellite of the group of satellites from at least one of the cluster of satellites or a ground computing network (2608).

In one example, the workload schedule can not only cause certain satellites to be clustered 2010, 2018, but in some cases the request for compute resources might be services through a communication link 2040 to a gateway 104 which connects to the Internet and other ground computer systems which can provide the compute resources. The group of satellites 2000 for example, might have a full workload scheduled for a period of time in which the group of satellites 2000 will pass over a geographic area with user terminals 112 where requests for compute resources might be received. In one aspect, where the satellites 2000 cannot service the requests or expected requests, the traditional approach can be implemented where requests are provided through the gateway 104 to traditional terrestrial cloud computing environments. In another aspect, compute environments 2034 configured on a cluster of satellites, if the circumstances warrant, could have their compute environment transitioned to a ground computing environment to continue processing the data. The time and cost of shifting the compute environment 2034 to a ground computing environment can be taken into account whether such a load balancing operation would be worthwhile.

The method can further include receiving prediction data regarding expected requests for compute resources from one or more user terminals 112 in a geographic area during at least a portion of the period of time in the future. The, the clustering of the two or more satellites from the group of satellites can further based on the prediction data.

The clustering of the two or more satellites can be static for the period of time or dynamic and changes based on one or more parameters after establishing the cluster of satellites and before a conclusion of the period of time. In this example, the cluster can be operable for five minutes of the ten-minute slot of time of the topology schedule but workload may complete, or requests may be withdrawn, or higher priority requests may be received, and thus the cluster and any compute environment 2034 associated with the cluster of satellites 2010, 2018 might be torn down and the satellites 2010, 2018 would return back to a larger group of satellites 2000 available for clustering.

The dynamic nature of the clustering can also mean that the cluster configuration can change even before a traditional topology schedule timing. The change can be based on a change in workload, a completion of workload, new requests that require additional workload, and so forth. A cluster of satellites can grow or shrink dynamically depending on the workload pressure as well as the other conditions disclosed herein. For example, if satellite 2018 is in a cluster and starts to have thermal issues where it is operating too hot, then the cluster can be adjusted to include satellite 2002 instead of satellites 2018. Backup satellites can be configured, provisioned or assigned in advance as well to accommodate a reset or reboot event or where a transient thermal condition occurs.

Any given satellite might have multiple communication links 2036 and be able to be a part of multiple clusters. In such a case, the workload manager 137 would take into account both clusters, expected workload and other factors to enable quality requirements to be met when providing compute resources.

In another example, a method can include providing data about the workload schedule from the workload manager 137 to the topology service 132 which can then be used to determine the proper topology over a period of time. The data reported from the topology service 132 might vary depending on the scheduled workload from the workload manager 137. The workload manager 137 can have access to workload requests from one or more entities that desire access to the compute resources. In one example, the topology service 132 typically will provide the topology schedule for a period of time, such as ten minutes, which relates to how long a group of satellites will be in sight of a cell of user terminals. The timing is based on the physical movement of the satellites. However, the topology service 132 can receive data from the workload manager 137. The data may indicate that a large amount of workload is scheduled for seven minutes from the current time and is scheduled to run for eight minutes. This would mean that the workload would start and run for three minutes and then the topology schedule may change in the middle of processing the workload, which may cause a reclustering of the satellites and introduce latency. Thus, the topology service 132 might adjust the timing of the topology schedule based on the scheduled workload and reset the schedule in advance of the large workload (and in advance of the normal timing for a new schedule) for a period of nine minutes to enable the workload to start and complete without a readjustment of the cluster or of the topology. Other adjustments to the topology schedule might occur as well based on the data about the scheduled workload.

As another example, the workload might involve the request for a high-speed endpoint-to-endpoint communication channel from Los Angeles to London for a particular application. The topology schedule might take into account not just the satellites over a given geographic area such as Los Angeles where data transmission might originate, but it could also take into account the larger group of satellites that would be part of the endpoint-to-endpoint communication channel all the way to London. Thus, clustering decisions can take such extended use of compute resources into account beyond a generated cluster above a certain geographic area.

In each case, where scheduled workload is mentioned herein, it can also include predicted workload due to, for example, a large amount of user terminals in a given area, based on a time of year or for other reasons that many requests for compute resources are expected in the future but not formally received.

FIG. 27 illustrates an example computer device that can be used in connection with any of the systems or components of the user terminal 502, the satellite 504, the gateway 506 or other components disclosed herein. In this example, FIG. 27 illustrates a computing system 2700 including components in electrical communication with each other using a connection 2705, such as a bus. System 2700 includes a processing unit (CPU or processor) 2710 and a system connection 2705 that couples various system components including the system memory 2715, such as read only memory (ROM) 2720 and random-access memory (RAM) 2725, to the processor 2710. The system 2700 can include a cache of high-speed memory connected directly with, in close proximity to, or integrated as part of the processor 2710. The system 2700 can copy data from the memory 2715 and/or the storage device 2730 to the cache 2712 for quick access by the processor 2710. In this way, the cache can provide a performance boost that avoids processor 2710 delays while waiting for data. These and other modules can control or be configured to control the processor 2710 to perform various actions. Other system memory 2715 may be available for use as well. The memory 2715 can include multiple different types of memory with different performance characteristics. The processor 2710 can include any general-purpose processor and a hardware or software service, such as service 1-2732, service 2-2734, and service 3-2736 stored in storage device 2730, configured to control the processor 2710 as well as a special-purpose processor where software instructions are incorporated into the actual processor design. In this regard, the services 2732, 2734, 2736 represent the instructions stored in any type of computer-readable memory that, when executed by the processor 2710, provide the respective service or compute resources. The processor 2710 may be a completely self-contained computing system, containing multiple cores or processors, a bus, memory controller, cache, etc. A multi-core processor may be symmetric or asymmetric.

In most cases, the hardware shown in FIG. 27 will be operational as part of a satellite and thus would not typically have, once deployed, a user interface such as a graphical user interface to receive user input. However, claims might be drawn to earth-based components such as the load balancing module 130, the compute resource entity computer system 138 or the third-party computer system 1232 that are used to request and receive access to compute resources across the constellation of satellites 900 disclosed herein. In such a case, an input device 2745 might be included as part of that computing device. To enable user interaction with the device 2700, an input device 2745 can represent any number of input mechanisms, such as a microphone for speech, a touch-sensitive screen for gesture or graphical input, keyboard, mouse, motion input, speech and so forth. These input technologies can be utilized by any ground-based computing system or otherwise as well to interact with a computing device which may be communicating with one of the satellites 900 in some manner or through a UT 502 or gateway 506. An output device 2735 can also be one or more of a number of output mechanisms known to those of skill in the art. In some instances, multimodal systems can enable a user to provide multiple types of input to communicate with the device 2700. The communications interface 2740 can generally govern and manage the user input and system output. There is no restriction on operating on any particular hardware arrangement and therefore the basic features here may easily be substituted for improved hardware or firmware arrangements as they are developed.

Storage device 2730 is a non-volatile memory and can be a hard disk or other types of computer readable media which can store data that are accessible by a computer, such as magnetic cassettes, flash memory cards, solid state memory devices, digital versatile disks, cartridges, volatile random-access memories (RAMs) 2725, read only memory (ROM) 2720, and/or hybrids thereof.

The storage device 2730 can include services 2732, 2734, 2736 for controlling the processor 2710. Other hardware or software modules are contemplated. The storage device 2730 can be connected to the system connection 2705. In one aspect, a hardware module that performs a particular function can include the software component stored in a computer-readable medium in connection with the necessary hardware components, such as the processor 2710, connection 2705, output device 2735, and so forth, to carry out the function.

In some examples, computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer executable instructions that are stored or otherwise available from computer readable media. Such instructions can include, for example, instructions and data which cause or otherwise configure a general-purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

Claim language reciting “at least one of” refers to at least one of a set and indicates that one member of the set or multiple members of the set satisfy the claim. For example, claim language reciting “at least one of A and B” means A, B, or A and B.

Any reference to communication with a user terminal can also be interested as a communication with a gateway or other communication device which can communicate with a satellite.

Any dependent claim even if recited below as being dependent from a single independent claim or other dependent claim can also be dependent from any other claim as well. Thus, multiple dependent claims are contemplated as within the scope of this disclosure. This includes the various examples set forth herein as well. Any example or any feature from one example disclosed herein can be combined with any other feature of any other example as well.

1. A method comprising:
receiving, at a satellite control system on a satellite, a request from a user terminal for compute resources;
requesting, from a computing environment configured on the satellite, access to the compute resources;
receiving, from the computing environment configured on the satellite, access to the compute resources; and
transmitting data associated with use of the compute resources to the user terminal.

2. The method of claim 1, wherein the computing environment configured on the satellite comprises a memory device that stores the data on the satellite.

3. The method of claim 1, wherein the computing environment configured on the satellite further comprises one or more of data storage, an application operating on at least a part of the compute resources, an access/control module, computer processors available for use as the compute resources, an endpoint-to-endpoint communication channel, and a user interface module.

4. The method of claim 1, wherein when the computing environment configured on the satellite does not store the data on the satellite, the computing environment requests the data from one of another computing environment configured on the satellite, a terrestrial source, or another satellite.

5. The method of claim 1, further comprising:
identifying the computing environment configured on the satellite as either having the compute resources or being associated with an account of a user.

6. The method of claim 1, wherein receiving, from the computing environment configured on the satellite, access to the compute resources further comprises the computing environment authorizing access to the compute resources for a user.

7. The method of claim 1, wherein the computing environment configured on the satellite comprises one of a virtual computing environment, a hardware-based computing environment or a hybrid computing environment comprising a portion of virtual compute resources and hardware compute resources.

8. The method of claim 1, wherein the computing environment configured on the satellite is one of a plurality of computing environments configured on the satellite.

9. The method of claim 8, wherein the computing environment configured on the satellite further comprises an entity computing environment and the data comprises a media presentation.

10. The method of claim 1, wherein the compute resources comprise one or more of the data, use of one or more computer processors, use of one or more components, a cloud-service, data storage, an endpoint-to-endpoint communication channel via a group of satellites, and an application.

11. The method of claim 1, wherein access to the compute resources is managed to enable the satellite and/or one or more additional satellites to provide the compute resources as managed by a load balancing module that takes into account one or more of an energy balance among a group of satellites, transient hardware temperatures associated with the group of satellites, a reboot or reset event for the group of satellites, or orbital parameters associated with the group of satellites.

12. The method of claim 11, wherein the load balancing module is configured on the satellite or a ground-based system.

13. The method of claim 1, wherein access to the compute resources is provided across a group of moving satellites in which a dynamic or static clustering of two or more satellites in the group of moving satellites provides the access to the compute resources over time.

14-17. (canceled)

18. A method comprising:
receiving, at a satellite as part of a group of satellites, data associated with the group of satellites, wherein the data is associated with movement of the group of satellites according to a respective orbit of each satellite of the group of satellites;
based on the data, clustering two or more satellites of the group of satellites that can provide cloud-computing operations to user terminals to yield a cluster of satellites;
receiving, at a satellite associated with the cluster of satellites, a request from a user terminal for compute resource to yield a requested compute resource; and
providing, from the cluster of satellites and for the user terminal, access to the compute resources based on the requested compute resource.

19. The method of claim 18, wherein the cluster of satellites comprises a dynamic cluster that adjusts over time amongst the group of satellites or a static configuration of the same subgroup or cluster of satellites as the group of satellites orbit the Earth.

20. (canceled)

21. A satellite comprising:
a satellite control system;
an antenna connected to the satellite control system;
a solar panel;
a battery;
a memory device;
a computing environment configured on the satellite; and
a plurality of compute resources as part of the computing environment, wherein, when a user terminal requests a compute resource via the satellite control system to yield a requested compute resource, the computing environment retrieves, if available, the requested compute resource from the plurality of compute resources stored in the memory device and provides data associated with the requested compute resource to the satellite control system for transmission via the antenna to the user terminal or makes the requested compute resource available to the user terminal.

22. The satellite of claim 21, wherein the computing environment further comprises an access and control module for managing user access to the plurality of compute resources.

23. The satellite of claim 22, wherein the computing environment further comprises a user interface module for providing to the satellite control system a user interface for transmission to the user terminal.

24. The satellite of claim 21, further comprising a plurality of computing environments configured on the satellite.

25. The satellite of claim 21, wherein when the user terminal requests via the satellite control system the requested compute resource, the satellite control system determines that the computing environment is a chosen computing environment from a plurality of computing environments configured on the satellite.

26. The satellite of claim 25, wherein a user account associated with the computing environment is used to determine that the computing environment is the chosen computing environment from the plurality of computing environments configured on the satellite.

27. The satellite of claim 26, wherein the satellite is part of a group of satellites configured to provide the requested compute resource to the user terminal, the requested compute resource comprising a plurality of data accessible to the user terminal.

28. The satellite of claim 22, wherein, when the requested compute resource is not available on the memory device, then the computing environment obtains the requested compute resource from one of another computing environment on the satellite, a ground-based computer system via a gateway, or another satellite.

29. The satellite of claim 21, further comprising:
a workload management component that manages a scheduling of workload across the plurality of compute resources.

30. The satellite of claim 21, wherein the computing environment is configured in one of a virtual machine, a container or on dedicated hardware on the satellite.

31. The satellite of claim 21, wherein the computing environment comprises an entity computing environment and wherein the requested compute resource comprises a media presentation.

32-43. (canceled)
